(19) United States
(12) Patent Application Publication
(10) Pub. No.: US 2010/0321579 A1
(43) Pub. Date: Dec. 23, 2010

(54) Front End Processor with Extendable Data Path

(76) Inventors: Mohammad Ahmad, Tustin, CA (US); Mohammad Usman, Mission Viejo, CA (US); Sherjil Ahmed, Irvine, CA (US)

Correspondence Address: Novel IP, 14252 CULVER DR. BOX 914, IRVINE, CA, 92604, US

(21) Appl. No.: 12/704,472

(22) Filed: Feb. 11, 2010

Related U.S. Application Data
(60) Provisional application No. 61/151,540, filed on Feb. 11, 2009.
(60) Provisional application No. 61/151,542, filed on Feb. 11, 2009.
(60) Provisional application No. 61/151,546, filed on Feb. 11, 2009.
(60) Provisional application No. 61/151,547, filed on Feb. 11, 2009.

(51) Int. Cl. H04N 5/21; G06F 15/76; G06F 9/02; H04N 7/30; H04N 5/14

(52) U.S. Cl. 348/607; 712/37; 375/240.2; 348/699; 712/E09.002; 375/E07.226; 348/E05.062; 348/E05.077

(57) ABSTRACT

The present specification discloses a processing architecture that has multiple levels of parallelism and is highly configurable, yet optimized for media processing. At the highest level, the architecture is structured to enable each processor, which is dedicated to a specific media processing function, to operate substantially in parallel. In addition to processor-level parallelism, each processing unit can operate on multiple words in parallel, rather than just a single word per clock cycle. Moreover, at the instruction level, the control data memory, data memory, and function specific dath paths can be controlled all within the same clock cycle. Additionally, the processor has multiple layers of configurability, with the extendable data path of the processor being capable of being configured to perform specific processing functions, such as entropy encoding, discrete cosine transform (DCT), inverse discrete cosine transform (IDCT), motion compensation, motion estimation, de-blocking filter, de-interlacing, de-noising, quantization, and dequantization.

### CROSS REFERENCE

The present invention relies on the following provisionals for priority U.S. Provisional Application Nos. 61/151,540, filed on Feb. 11, 2009, 61/151,542, filed on Feb. 11, 2009, 61/151,546, filed on Feb. 11, 2009, and 61/151,547 filed on Feb. 11, 2009. The present application is also related to the following U.S. patent application Ser. Nos. 11/813,519, filed on Nov. 14, 2007, 11/971,871, filed on Jan. 9, 2008, 11/971,868, filed Jan. 9, 2008, 12/101,851, filed on Apr. 11, 2008, 12/114,746, filed on May 3, 2008, 12/114,747, filed on May 3, 2008, 12/134,283, filed on Jun. 6, 2008, 11/875,592, filed on Oct. 19, 2007, and 12/263,129, filed on Oct. 31, 2008. The specifications of all of the aforementioned applications are herein incorporated by reference by their entirety.

### FIELD OF THE INVENTION

The present invention generally relates to the field of processor architectures and, more specifically, to a processing unit that comprises a template Front End Processor (FEP) with an Extendable Data Path portion for customizing the FEP in accordance with a plurality of specific functional processing needs.

### BACKGROUND OF THE INVENTION

Media processing and communication devices comprise hardware and software systems that utilize interdependent processes to enable the processing and transmission of media. Media processing comprises a plurality of processing function needs such as entropy encoding, discrete cosine transform (DCT), inverse discrete cosine transform (IDCT), motion compensation, de-blocking filter, de-interlacing, and de-noising. Typically, different functional processing units may be dedicated to each of the aforementioned different functional needs and the structure of each functional unit is specific to the coding approach or standard being used in a given processing device. However, it is desirable to not have to design the structure of each of the functional processing units from scratch and have the structure of the functional processing unit designed in such a manner, that it can be programmed for use with any coding standard or approach.

For example, integer-based transform matrices are used for transform coding of digital signals, such as for coding image/video signals. Discrete Cosine Transforms (DCTs) are widely used in block-based transform coding of image/video signals, and have been adopted in many Joint Photographic Experts Group (JPEG), Motion Picture Experts Group (MPEG), and network protocol standards, such as MPEG-1, MPEG-2, H.261, H.263 and H.264. Ideally, a DCT is a normalized orthogonal transform that uses real-value numbers. This ideal DCT is referred to as a real DCT. Conventional DCT implementations use floating-point arithmetic that requires high computational resources. To reduce the computational burden, DCT algorithms have been developed that use fix-point or large integer arithmetic to approximate the floating-point DCT.

In conventional forward DCT, image data is subdivided into small 2-dimensional segments, such as symmetrical 8×8 pixel blocks, and each of the 8×8 pixel blocks is processed through a 2-dimensional DCT. Implementing this process in hardware is resource intensive and becomes exponentially more demanding as the size of the pixel blocks to be transformed is increased. Also, prior art image processing typical uses separate hardware structures for DCT and IDCT. Additionally, prior art approaches to DCT and IDCT processing requires different hardware to support codecs with differing DCT/IDCT processing methodologies. Therefore, different hardware would be required for DCT 4×4, IDCT 4×4, DCT 8×8, and IDCT 8×8, among other configurations.

Similarly, prior art video processing systems require separate hardware structures to do quantization and de-quantization for different CODECs. Prior art motion compensation processing units also use multiple processing units (different DSPs) for handling various codecs such as H.264, MPEG 2 and 4, VC-1, AVS. However, it is desirable to have a motion compensation processing unit that is highly configurable, programmable, scalable and uses a single data path to handle a plurality of codecs at cycles less than 500 MHz. It is also desirable to have efficient processing using fewer clock cycles without excessive cost.

Additionally, DBFs are needed because they remove discontinuities between the processed blocks in a frame. Frames are processed on a block by block level. When a frame is reconstructed by placing all the blocks together, discontinuities may exist between blocks that need to be smoothened. The filtering needs to be responsive to the boundary difference. Too much filtering creates artifacts. Too little fails to remove the choppiness/blockiness of the image. Typically, deblocking is done sequentially, taking each edge of each block and working through all block edges. The blocks can be of any size: 16×16, 4×4 (if H.264), or 8×8 (if AVS or VC-1).

To perform DBF properly, the right data needs to be available, at the right time, to filter. Persons of ordinary skill in the art would appreciate that to get high orders of processing speeds (example: 30 frames per second) the DBF needs to be tailored to a specific codec, like H.264. Programmable DBFs can use a generic RISC processor, but it will not be optimized for any one codec and, therefore, high processing speeds (i.e., 30 frames per second) will not be achieved. Given that each codec has a different approach to when, and in what sequence, DBF should occur, it becomes challenging to tailor a single deblocking DSP to doing DBF.

Accordingly, there is need for a template processing structure that can be tailored to each processing unit needed for the various functional processing needs. Need further exists for combining the DCT and IDCT functions into a single processing block. And also for a unified hardware structure that can be used to do both quantization and de-quantization on 8 words in a single clock cycle.

There is yet further need in the art for a hardware processing structure that is flexible enough to implement different equations in order to support multiple CODEC standards and has the capability of computing significant coefficients on the fly with no overhead to speed up processing for entropy coding. Accordingly there is a need in the prior art to have a de-blocking filter DSP that a) can be programmed to be used for any codec, particularly H.264, AVS, MPEG-2, MPEG-4, VC-1 and derivatives or updates thereof, and b) can operate at least 30 frames per second.

Additionally, there is also need for a two dimensional register set arrangement to facilitate two dimensional processing in a single clock cycle thereby accelerating the processing function. In processors, data registers are used to upload operands for an operation and then store the output. They are typically accessible in only one dimension. FIG. 3 shows a prior art register set 300 that is accessible in one dimension in a clock cycle. However, processing power intensive tasks, such as those related to media processing, require far greater processing in a single clock cycle to accelerate functions.

There is also a need for a media processing unit that can be used to perform a given processing function for various kinds of media data, such as graphics, text, and video, and can be tailored to work with any coding standard or approach. It would further be preferred that such a processing unit provides optimal data/memory management along with a unified processing approach to enable a cost-effective and efficient processing system. More specifically, a system on chip architecture is needed that can be efficiently scaled to meet new processing requirements, while at the same time enabling high processing throughputs.

### SUMMARY OF THE INVENTION

The present specification discloses a processing architecture that has multiple levels of parallelism and is highly configurable, yet optimized for media processing. Specifically, the novel architecture has three levels of parallelism. At the highest level, the architecture is structured to enable each processor, which is dedicated to a specific media processing function, to operate substantially in parallel. For example, as shown in FIG. 19, the system architecture may comprise a plurality of processors, 1901-1910, with each processor being dedicated to a specific processing function, such as entropy encoding (1901), discrete cosine transform (DCT) (1902), inverse discrete cosine transform (IDCT) (1903), motion compensation (1904), motion estimation (1905), de-blocking filter (1906), de-interlacing (1907), de-noising (1908), quantization (1909), and dequantization (1910), and being managed by a task scheduler 1911. In addition to processor-level parallelism, each processing unit (1901-1910) can operate on multiple words in parallel, rather than just a single word per clock cycle. Finally, at the instruction level, the control data memory (shown as 125 in FIG. 1), data memory (shown as 185 in FIG. 1), and function specific dath paths (shown as 115 in FIG. 1) can be controlled all within the same clock cycle.

The processor therefore has no inherent limits on how much data can be processed. Unlike other processors, the presently disclosed processor has no limitation on the number of functional data paths or execution units that can be implemented because of the multiple data buses, namely a program data bus and two data buses, which operate in parallel and where each bus is configurable such that it can carry one or N number of operands.

In addition to this multi-layered parallelism, the processor has multiple layers of configurability. Referring to FIG. 1, the processor 110 can be configured to perform each of the specific processing functions, such as entropy encoding, discrete cosine transform (DCT), inverse discrete cosine transform (IDCT), motion compensation, motion estimation, de-blocking filter, de-interlacing, de-noising, quantization, and dequantization, by tailoring the function specific dath paths 115 to the desired functionality while keeping the rest of the processor's functional units the same. Additionally, each functionally tailored processor can be further configured to specifically support a particular video processing standard or protocol because the function specific dath paths have been designed to flexibly support a multitude of processing codecs, standards or protocols, including H.264, H.263 VC-1, MPEG-2, MPEG-4, and AVS.

In one embodiment, the present invention is directed toward a processor with a configurable functional data path, comprising: a plurality of address generator units; a program flow control unit; a plurality of data and address registers; an instruction controller; a programmable functional data path; and at least two memory data buses, wherein each of said two memory data buses are in data communication with said plurality of address generator units, program flow control unit; plurality of data and address registers; instruction controller; and programmable functional data path. Optionally, the programmable function data path comprises circuitry configured to perform entropy encoding, discrete cosine transform (DCT), inverse discrete cosine transform (IDCT), motion compensation, motion estimation, de-blocking filter, de-interlacing, de-noising, quantization, or dequantization on data input into said programmable function data path. Optionally, the circuitry configured to perform entropy encoding, discrete cosine transform (DCT), inverse discrete cosine transform (IDCT), motion compensation, motion estimation, de-blocking filter, de-interlacing, de-noising, quantization, or dequantization processing on data input into said programmable function data path can be logically programmed to perform that processing in accordance with any of the H.264, MPEG-2, MPEG-4, VC-1, or AVS protocols without modifying the physical circuitry. Optionally, the any of the aforementioned processing can be performed to enable a display of video at least 30 frames per second at a processor frequency of 500 MHz or below.

In another embodiment, the present invention is directed toward a processor, comprising: a plurality of address generator units; a program flow control unit; a plurality of data and address registers; an instruction controller; and a programmable functional data path, wherein said programmable function data path comprises circuitry configured to perform any one of the following processing functions on data input into said programmable function data path: DCT processing, IDCT processing. motion estimation, motion compensation, entropy encoding, de-interlacing, de-noising, quantization, or dequantization. Optionally, the circuitry can be logically programmed to perform said processing functions in accordance with any of the H.264, MPEG-2, MPEG-4, VC-1, or AVS protocols without modifying the physical circuitry. The processing functions can be performed to enable a display of video at least 30 frames per second at a processor frequency of 500 MHz or below.

In another embodiment, the present invention is a system on chip comprising at least five processors of claim 1 and a task scheduler wherein a first processor comprises a programmable function data path configured to perform entropy encoding on data input into said programmable function data path; a second processor comprises a programmable function data path configured to perform discrete cosine transform processing on data input into said programmable function data path; a third processor comprises a programmable function data path configured to perform motion compensation on data input into said programmable function data path; a fourth processor comprises a programmable function data path configured to perform deblocking filtration on data input into said programmable function data path; and fifth processor comprises a programmable function data path configured to perform de-interlacing on data input into said programmable function data path. Additional processors can be included directed any of the processing functions described herein.

Therefore, it is an object of the present invention to provide a media processing unit that comprises a template Front End Processor (FEP) with an Extendable Data Path portion for customizing the FEP in accordance with a plurality of specific functional processing needs.

It is another object of the present invention to provide a two dimensional register set arrangement to facilitate two dimensional processing in a single clock cycle, thereby accelerating media processing functions.

According to another objective, a processing unit of the present invention combines DCT and IDCT functions in a single unified block. A single programmable processing block allows for computationally efficient processing of 2, 4, and 4 point forward and reverse DCT.

It is also an object of the present invention to provide a processing unit that combines Quantization (QT) and De-Quantization (DQT) functions in a single unified block and is flexible enough to implement different equations in order to support multiple CODEC standards and has the capability of computing significant coefficients on the fly with no overhead to speed up processing for entropy coding. Accordingly, in one embodiment a unified processing unit is used to do both quantization and de-quantization on 8 words in a single clock cycle.

According to another object of the present invention a motion compensation processing unit uses a single data path to process multiple codecs.

It is another object of the present invention to have a de-blocking filter DSP that can be programmed to be used for any codec and can also operate at least 30 frames per second.

It is a yet another object of the present invention to have a media processing unit that can be used to perform a given processing function for various kinds of media data, such as graphics, text, and video, and can be tailored to work with any coding standard or approach. Accordingly, in one embodiment the media processing unit of the present invention provides optimal data/memory management along with a unified processing approach to enable a cost-effective and efficient processing system.

### BRIEF DESCRIPTION OF THE DRAWINGS

These and other features and advantages of the present invention will be appreciated, as they become better understood by reference to the following detailed description when considered in connection with the accompanying drawings, wherein:

FIG. 1 is a block diagram of one embodiment of the processing unit of the present invention;

FIG. 2 is a block diagram illustrating an instruction format;

FIG. 3 is a block diagram of a prior art one dimensional register set;

FIG. 4 is a block diagram illustrating a two dimensional register set arrangement of the present invention;

FIG. 5 shows a top level architecture of one embodiment of a DCT/IDCT—QT (Discrete Cosine Transform/Inverse Discrete Cosine Transform—Quantization) processor of the present invention;

FIG. 6a is a first representation of an 8 row×8 column matrix representation of an 8-point forward DCT;

FIG. 6b is a second representation of an 8 row×8 column matrix representation of an 8-point forward DCT;

FIG. 6c is a third representation of an 8 row×8 column matrix representation of an 8-point forward DCT;

FIG. 7a shows a circuit structure of an 8-point DCT system of the present invention;

FIG. 7b is a structure of an addition and subtraction circuit comprising of a pair of an adder and a subtractor implemented in the present invention;

FIG. 7c is a structure of a multiplication circuit implemented in the present invention;

FIG. 8a is a first representation of an 8 row×8 column matrix representation of an 8-point Inverse DCT;

FIG. 8b is a second representation of an 8 row×8 column matrix representation of an 8-point Inverse DCT;

FIG. 8c is a third representation of an 8 row×8 column matrix representation of an 8-point Inverse DCT;

FIG. 9a shows a circuit structure of an 8-point inverse DCT of the present invention;

FIG. 9b is a view of a structure of a multiplication circuit implemented in the present invention;

FIG. 10a is a first representation of a 4 row×4 column matrix representation of a 4-point forward DCT;

FIG. 10b is a second representation of a 4 row×4 column matrix representation of a 4-point forward DCT;

FIG. 10c is a third representation of a 4 row×4 column matrix representation of a 4-point forward DCT;

FIG. 11a shows a circuit structure of a 4-point DCT system of the present invention;

FIG. 11b is a view of a structure of an addition and subtraction circuit comprising of a pair of an adder and a subtractor;

FIG. 11c is a view of a structure of a multiplication circuit;

FIG. 12a is a first representation of a 4 row×4 column matrix representation of a 4-point Inverse DCT;

FIG. 12b is a second representation of a 4 row×4 column matrix representation of a 4-point Inverse DCT;

FIG. 12c is a third representation of a 4 row×4 column matrix representation of a 4-point Inverse DCT;

FIG. 13 shows a circuit structure of a 4-point inverse DCT of the present invention;

FIG. 14a is a first representation of a 2 row×2 column matrix representation of a 2-point forward DCT;

FIG. 14b is a second representation of a 2 row×2 column matrix representation of a 2-point forward DCT;

FIG. 14c is a third representation of a 2 row×2 column matrix representation of a 2-point forward DCT;

FIG. 15 shows a circuit structure of a 2-point forward and inverse DCT;

FIG. 16 is a block diagram describing a transformation and quantization of a set of video samples;

FIG. 17 is a block diagram of a video sequence;

FIG. 18 is a table illustrating an exemplary operation of the shadow memory.

FIG. 19 shows the processing architecture of multiple processors, dedicated to different processing functions, operating in parallel;

FIG. 20 shows one of the 8 units of the multi-layered AC/DC Quantizer/De-Quantizer hardware unit, as shown in FIG. 21;

FIG. 21 shows a top level architecture of an 8 unit Quantizer/De-Quantizer, as shown in FIG. 5;

FIG. 22 shows an embodiment of hardware structure of a motion compensation engine of the present invention;

FIG. 23 depicts an architecture for the motion compensation engine of the present invention;

FIG. 24 shows an embodiment of a portion of the scaler data path for the present invention;

FIG. 25 is a block diagram of one embodiment of an adaptive deblocking filter processor;

FIG. 26 shows a plurality of deblocking filtering data path stages;

FIG. 27 shows a plurality of data path pipelining stages;

FIG. 28 shows sequential orders of vertical and horizontal edges in H.264/AVC;

FIG. 29 shows a decision tree for boundary strength assignment (H.264/AVC);

FIG. 30 shows a decision tree for boundary strength assignment (AVS);

FIG. 31 shows sample line of 8 pixels of 2 adjacent blocks (in vertical or horizontal direction);

FIG. 32 shows an example of overlap smoothing between Intra 8×8 blocks;

FIG. 33 shows certain filtering equations;

FIG. 34 is a block diagram of an exemplary motion estimation processor of the present invention;

FIG. 35 illustrates the arrangement of the 6-tap filters in the motion estimation engine of the present invention;

FIG. 36 details the integrated circuit as per the filter design;

FIG. 37 illustrates an exemplary structure for the ME Array;

FIG. 38 is a flow chart illustrating the steps in the process of motion estimation;

FIG. 39 illustrates half pixel values vis-a-vis integer pixel values;

FIG. 40 illustrates the comparison of current integer values with computed half pixel values;

FIG. 41 is a block diagram depicting the use of shadow memory between the IMIF and EMIF;

FIG. 42 is an embodiment of an 80 bit instruction format; and

FIG. 43 is a pipeline diagram of the Front End Processor (FEP);

### DETAILED DESCRIPTION OF THE INVENTION

While the present invention may be embodied in many different forms, for the purpose of promoting an understanding of the principles of the invention, reference will now be made to the embodiments illustrated in the drawings and specific language will be used to describe the same. It will nevertheless be understood that no limitation of the scope of the invention is thereby intended. Any alterations and further modifications in the described embodiments, and any further applications of the principles of the invention as described herein are contemplated as would normally occur to one skilled in the art to which the invention relates. Where arrows are utilized in the drawings, it would be appreciated by one of ordinary skill in the art that the arrows represent the interconnection of elements and/or components via buses or any other type of communication channel.

The present invention will presently be described with reference to the aforementioned drawings. Headers will be used for purposes of clarity and are not meant to limit or otherwise restrict the disclosures made herein. Where arrows are utilized in the drawings, it would be appreciated by one of ordinary skill in the art that the arrows represent the interconnection of elements and/or components via buses or any other type of communication channel.

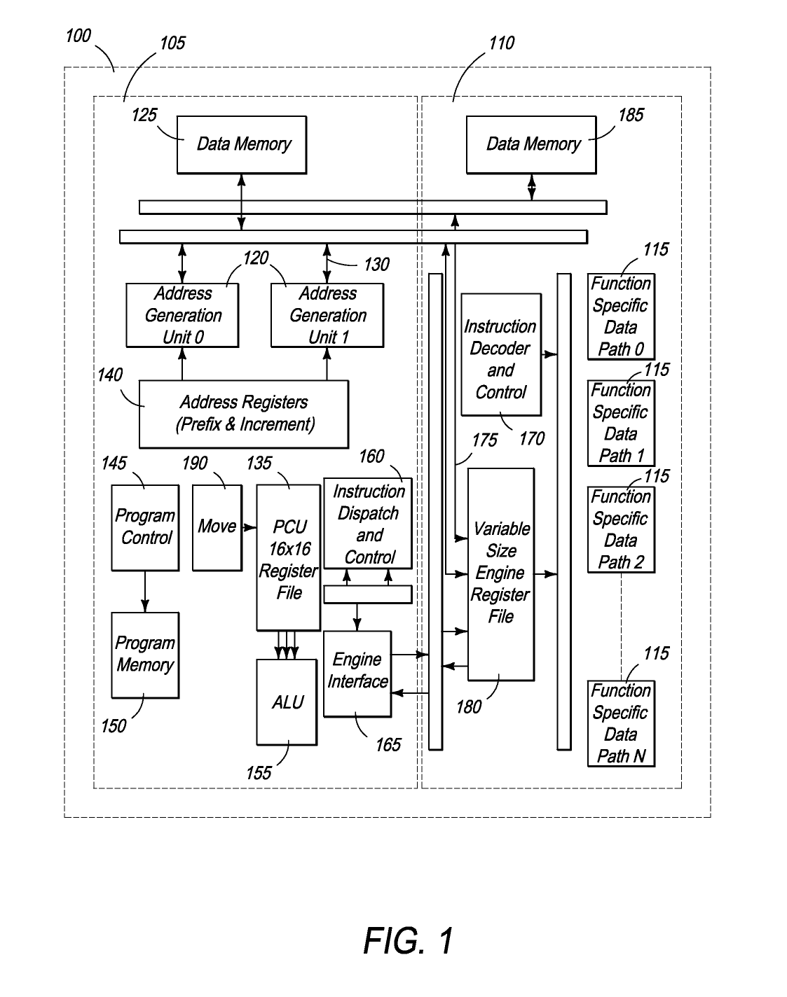

FIG. 1 shows a block diagram of a processing unit 100 of the present invention comprising a template Front End Processor (FEP) 105 with an Extendable Data Path (ETP) portion 110. The Extendable Data Path portion 110 is used to customize the processing unit 100 of the present invention for a plurality of specific functional processing needs. In one embodiment the processing unit 100 processes visual media such as text, graphics and video. A media processing unit performs specific media processing function on data, such as entropy encoding, discrete cosine transform (DCT), inverse discrete cosine transform (IDCT), motion compensation, de-blocking filter, de-interlacing, de-noising, motion estimation, quantization, dequantization, or any other function known to persons of ordinary skill in the art. The Extendable Data Path portion 110 of the processing unit 100 of the present invention comprises a plurality of Function Specific Data Paths 115 (0 to N, where N is any number) that can be customized to tailor the FEP 105 to each specific media processing function such as those described above.

It should be appreciated that this processor, when configured for a specific processing function, can be implemented in a system architecture that may comprise a plurality of processors, 1901-1910, with each processor being dedicated to a specific processing function, such as entropy encoding (1901), discrete cosine transform (DCT) (1902), inverse discrete cosine transform (IDCT) (1903), motion compensation (1904), motion estimation (1905), de-blocking filter (1906), de-interlacing (1907), de-noising (1908), quantization (1909), and dequantization (1910), and being managed by a task scheduler 1911. In addition to processor-level parallelism, each processing unit (1901-1910) can operate on multiple words in parallel, rather than just a single word per clock cycle. Finally, at the instruction level, the control data memory (shown as 125 in FIG. 1), data memory (shown as 185 in FIG. 1), and function specific dath paths (shown as 115 in FIG. 1) can be controlled all within the same clock cycle. The processor has no inherent limits on how much data can be processed. Unlike other processors, the presently disclosed processor has no limitation on the number of functional data paths or execution units that can be implemented because of the multiple data buses, namely a program data bus and two data buses, which operate in parallel and where each bus is configurable such that it can carry one or N number of operands. In addition to this multi-layered parallelism, the processor has multiple layers of configurability. Referring to FIG. 1, the processor 110 can be configured to perform each of the specific processing functions, such as entropy encoding, discrete cosine transform (DCT), inverse discrete cosine transform (IDCT), motion compensation, motion estimation, de-blocking filter, de-interlacing, de-noising, quantization, and dequantization, by tailoring the function specific dath paths 115 to the desired functionality while keeping the rest of the processor's functional units the same. Additionally, each functionally tailored processor can be further configured to specifically support a particular video processing standard or protocol because the function specific dath paths have been designed to flexibly support a multitude of processing standards and protocols, including H.264, VC-1, MPEG-2, MPEG-4, and AVS. It should further be appreciated that the processor can deliver the aforementioned benefits and features while still processing media, including high definition video (1080×1920 or higher), and enabling its display at 30 frames per second or faster with a processor rate of less than 500 MHz and, more particularly, less than 250 MHz.

The FEP 105 comprises two Address Generation Units (AGU) 120 connected to a data memory 125 via data bus 130 that in one embodiment is a 128 bit data bus. The data bus further connects PCU 16×16 register file 135, address registers 140, program control 145, program memory 150, arithmetic logic unit (ALU) 155, instruction dispatch and control register 160 and engine interface 165. Block 190 depicts a MOVE block. The FEP 105 receives and manages instructions, forwarding the data path specific instructions to the Extendable Data Path 110, and manages the registers that contain the data being processed.

In one embodiment the FEP 105 has 128 data registers that are further divided into upper 96 registers for the Extendable Data Path 110 and lower 32 registers for the FEP 105. During operation the instruction set is transmitted to Extendable Data Path 110 and the FEP 105 directs requisite data to the registers (the AGU 120 decodes instructions to know what data to put into the registers), allocating the data to be executed on by the Extendable Data Path 110 into the upper 96 registers. For example, if the instruction set is R3=R0+R1 then since this is done in the ALU 155, the data values for it are stored in the lower 32 registers. However, if another instruction is a filter instruction that needs to be executed by the Extendable Data Path 110, the required data is stored in the upper 96 registers.

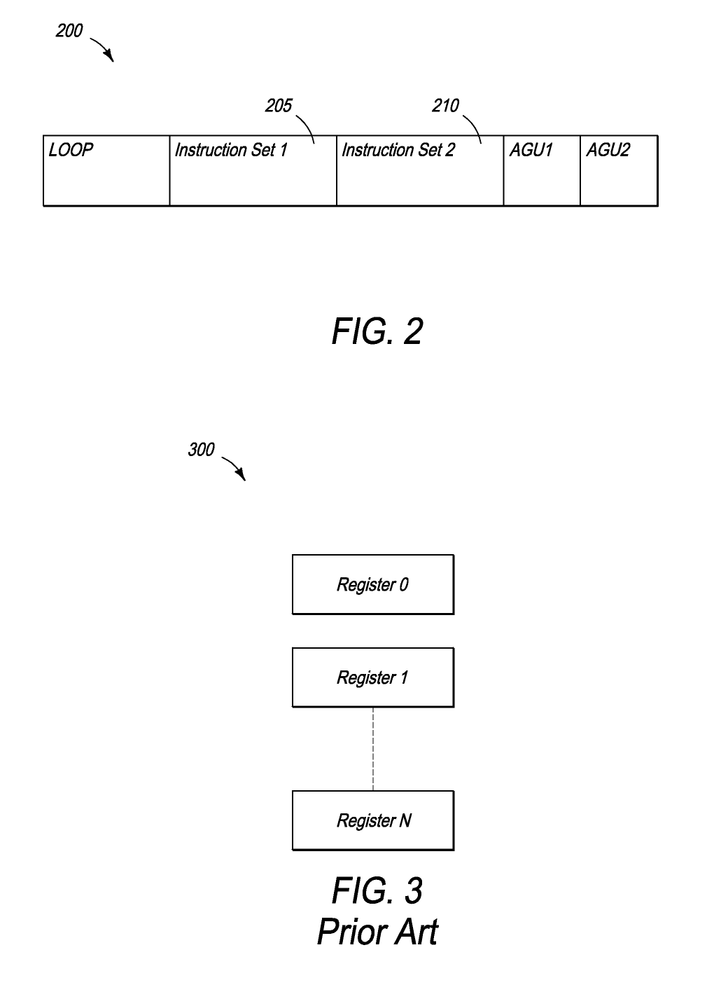

The Extendable Data Path 110 further comprises instruction decoder and controller 170 and has an independent path 175 from Variable Size Engine Register File 180 to data memory 185. This path 175 can be of any size, such as 1028 bits, 2056 bits, or other sizes, and customized to each Function Specific Data Path 115. This provides flexibility in the amount of data that can be processed in any given clock cycle. Persons of ordinary skill in the art should note that in order to make the Extendable Data Path 110 useful for its intended purpose, the processing unit 100 is flexible enough to accept a wide range of instructions. The instruction format 200 of FIG. 2 is flexible in that the first and second slots, 205 and 210, for instruction set 1 and instruction set 2 respectively, can be used as two separate instructions of 18 bit each or one instruction of 36 bits or four 9 bit instructions. This flexibility allows a plurality of instruction types to be created and therefore flexibility in the kind of processing unit can be programmed.

While each functional path specific to one or more media processing functions will be described in greater detail below, a novel system and method of enabling rapid data access, employed by one or more of such functional paths specific to one or more media processing functions, uses a two dimensional data register set.

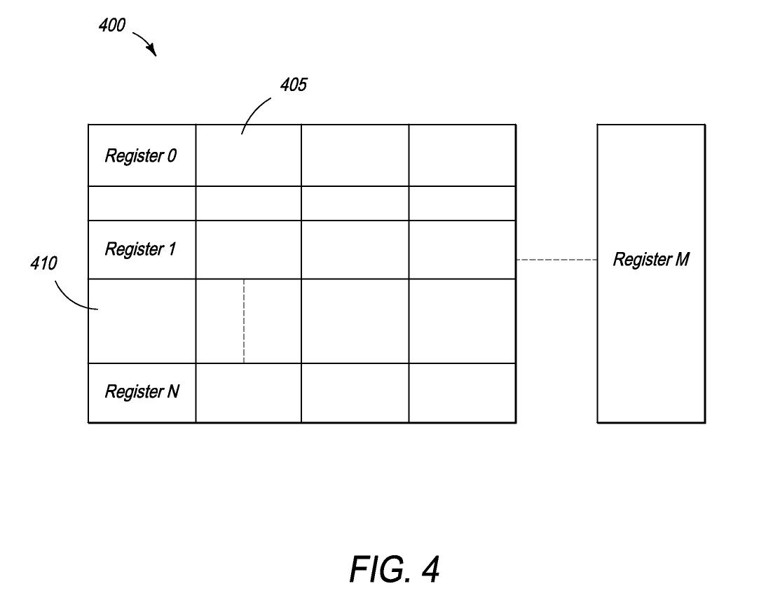

FIG. 4 shows a block diagram representation of the two dimensional data register set arrangement 400 of the present invention. The register set 400 uses physical registers that are logically divided into two dimensions, rows 405 and columns 410. During operation, the operands to an operation or the output from an operation are loaded or stored in either the horizontal direction, 405, or vertical direction, 410 in the two dimensional register set to facilitate two dimensional processing of data.

When compared with prior art one dimensional register set 300 of FIG. 3, the two dimensional register set 400 of the present invention has the same rows, Registerₒ to Register_{N}, 405, however the register set now also has columns that can be addresses—Register₀ to Register_{M}, 410. Persons of ordinary skill in the art would appreciate that these registers can be named in any manner.

Thus, during processing, when Register₀ is processed (to do a transformation such as ‘Discrete Cosine Transform’) an entire clock cycle is used in accessing only Register° in the prior art one dimensional register. However, in the two dimensional register set of the present invention a single clock cycle can be used to not only access/process Register₀ but also the column (defined as Register 0 to Register N) which is a logically different register and that occupies the same physical space as Register₀.

### Unified Discrete Cosine Transform/Inverse Discrete Cosine Transform (DCT/IDCT) Processing Unit

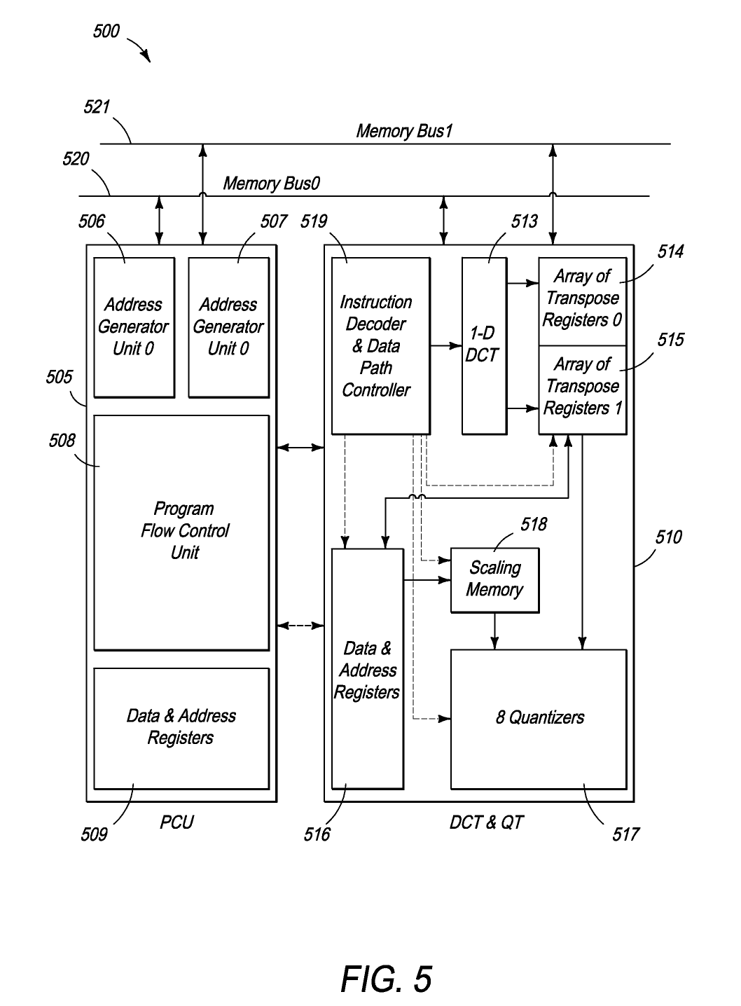

FIG. 5 shows a block diagram of the DCT/IDCT—QT (Discrete Cosine Transform/Inverse Discrete Cosine Transform—Quantization) processor 500 of the present invention comprising a standard Front End Processor (FEP) portion 505 and an Extendable Data Path (EDP) portion 510 that in the present invention is customized to perform DCT and QT (Quantization) functions for processing visual media such as text, graphics and video. The FEP 505 comprises first and second address generator units 506, 507, a program flow control unit 508 and data and address registers 509. The EDP portion 510 comprises a DCT unit 513 in communication with first and second array of transpose registers 514, 515 that in turn are in communication with data and address registers 516 and 8 quantizers 517. Scaling memory 518 is in data communication with registers 516 and quantizers 517. An instruction decoder and data path controller 519 coordinates data flow in the EDP portion 510. The FEP 505 and EDP 510 are in data connection with first and second memory buses 520, 521.

It should be appreciated that the DCT unit 513, array of transpose registers 514, 515, scaling memory 518, and 8 quantizers 517, represent elements of the function specific data path, shown as 115 in FIG. 1. These elements can be provided in one or more of the function specific data paths. As shown in both FIGS. 1 and 5, the extendable data path comprises an instruction decoder and data path controller 170, 519 and a variable size engine register file 180, 516.

Additionally, as discussed above, the same circuit structure useful for processing a DCT/IDCT function in accordance with one standard or protocol can be repurposed and configured to process a different standard or protocol. In particular, the DCT/IDCT functional data path for processing data in accordance with H.264 and be used to also process data in accordance with VC-1, MPEG-2, MPEG-4, or AVS. Accordingly, different sized blocks in an image can be DCT or IDCT processed with processor 500. For example, 16×16, 16×8, 8×16, 8×8, 8×4, 4×8, 4×4, and 2×2 macro-blocks can be transformed using horizontal and vertical transform matrices of sizes 16×16, 16×8, 8×16, 8×8, 8×4, 4×8, and 4×4.

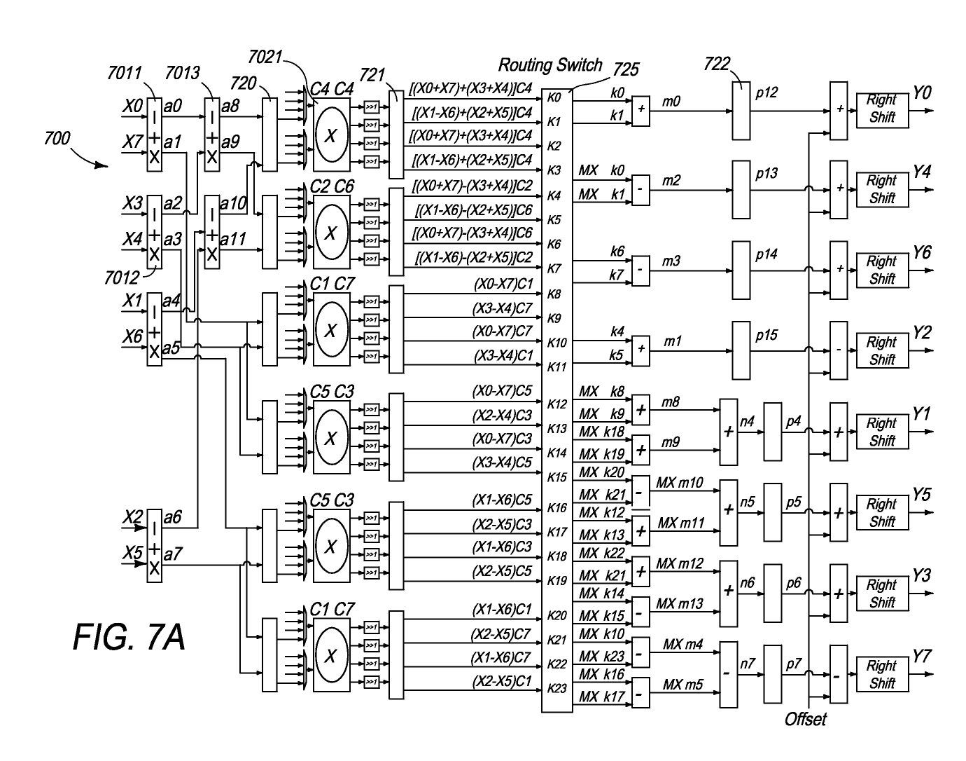

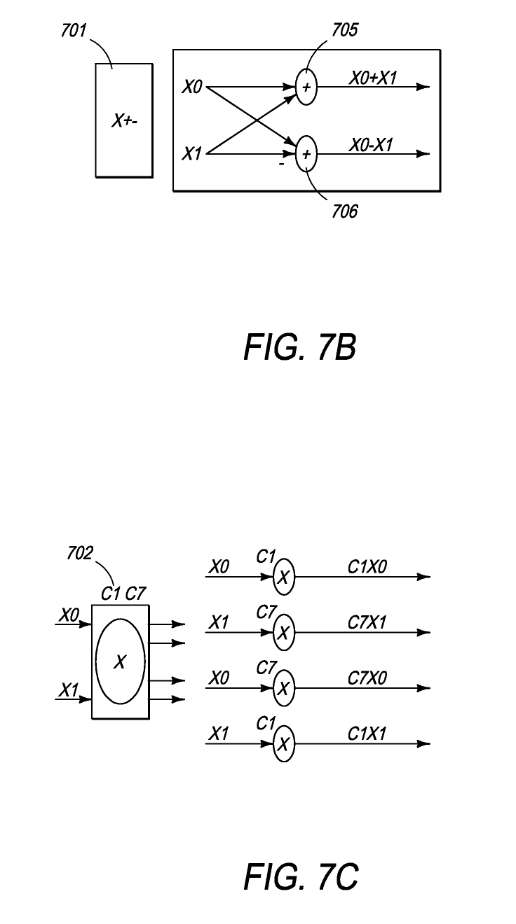

Referring to FIG. 7a, a block diagram demonstrating the DCT unit 513 which can be used to process an 8×8 macro-block. It should be appreciated that the processor 500 of FIG. 5 can be applied to the DCT or IDCT processing of macro-blocks of varying sizes. This aspect of the present invention shall be demonstrated by reviewing the DCT and IDCT processing of 8×8, 4×4 and 2×2 blocks, all of which can use the same DCT unit 513, programmatically configured for the specific processing being conducted.

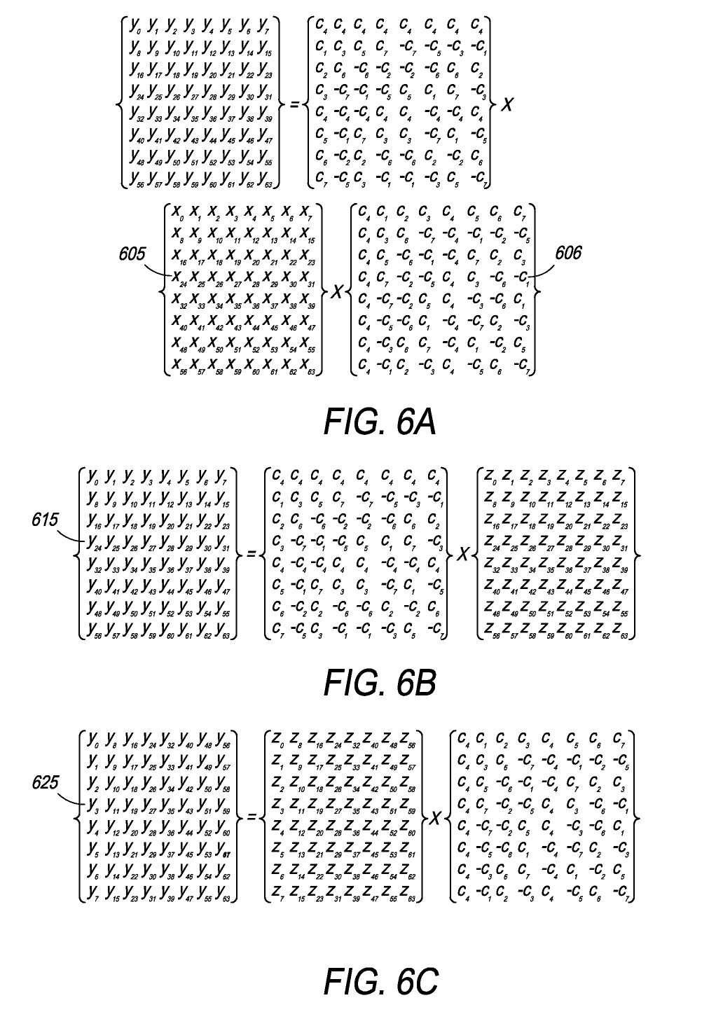

A typical forward DCT can be mathematically expressed as Y=CXC^{T} where C is a transformation matrix, X is the input matrix and Y is the output transformed coefficients. For an 8-point forward DCT, this equation can be implemented mathematically in the form of 8×8 matrices as shown in FIG. 6a. FIG. 6b shows the resultant matrix equation 615 after multiplying matrices 605 and 606. In FIG. 6b, the matrices on both sides are transposed to finally obtain the matrices 625 of FIG. 6c. For an H.264 codec, for example, the DCT 8×8 coefficients c1:c7 are {12, 8, 10, 8, 6, 4, 3}.

Thus, in an 8-point forward DCT mode, 8×8 blocks of pixel information are transformed into 8×8 matrices of corresponding frequency coefficients. To do this transformation, the present invention uses row-column approach where each row of the input matrix is transformed first using 8-point DCT, followed by transposition of the intermediate data, and then another round of column-wise transformation. Each time 8-point DCT is performed, 8 coefficients are produced from the matrix multiplication shown below:

{y1y1y2y3y4y5y6y7}={x0x1x2x3x4x5x6x7}×A

where:

$$A = \{ \begin{matrix}{c}_{4} & {c}_{1} & {c}_{2} & {c}_{3} & {c}_{4} & {c}_{5} & {c}_{6} & {c}_{7} \\ {c}_{4} & {c}_{3} & {c}_{6} & - {c}_{7} & - {c}_{4} & - {c}_{1} & - {c}_{2} & - {c}_{5} \\ {c}_{4} & {c}_{5} & - {c}_{6} & - {c}_{1} & - {c}_{4} & {c}_{7} & {c}_{2} & {c}_{3} \\ {c}_{4} & {c}_{7} & - {c}_{2} & - {c}_{5} & {c}_{4} & {c}_{3} & - {c}_{6} & - {c}_{1} \\ {c}_{4} & - {c}_{7} & - {c}_{2} & {c}_{5} & {c}_{4} & - {c}_{3} & - {c}_{6} & {c}_{1} \\ {c}_{4} & - {c}_{5} & - {c}_{6} & {c}_{1} & - {c}_{4} & - {c}_{7} & {c}_{2} & - {c}_{3} \\ {c}_{4} & - {c}_{3} & {c}_{6} & {c}_{7} & - {c}_{4} & {c}_{1} & - {c}_{2} & {c}_{5} \\ {c}_{4} & - {c}_{1} & {c}_{2} & - {c}_{3} & {c}_{4} & - {c}_{5} & {c}_{6} & - {c}_{7}\end{matrix} \} ;$$

$$y 0 = [ ( x 0 + x 7 ) + ( x 3 + x 4 ) ] * c 4 + [ ( x 1 + x 6 ) + ( x 2 + x 5 ) ] * c 4 ;$$

$$y 4 = [ ( x 0 + x 7 ) + ( x 3 + x 4 ) ] * c 4 - [ ( x 1 + x 6 ) + ( x 2 + x 5 ) ] * c 4 ;$$

$$y 2 = [ ( x 0 + x 7 ) - ( x 3 + x 4 ) ] * c 2 + [ ( x 1 + x 6 ) - ( x 2 + x 5 ) ] * c 6 ;$$

$$y 6 = [ ( x 0 + x 7 ) - ( x 3 + x 4 ) ] * c 6 - [ ( x 1 + x 6 ) - ( x 2 + x 5 ) ] * c 2 ;$$

$$y 1 = [ ( x 0 - x 7 ) * c 1 + ( x 3 - x 4 ) * c 7 ] + [ ( x 1 - x 6 ) * c 3 + ( x 2 - x 5 ) * c 5 ] ;$$

$$y 5 = [ ( x 0 - x 7 ) * c 5 + ( x 3 - x 4 ) * c 3 ] - [ ( x 1 - x 6 ) * c 1 - ( x 2 - x 5 ) * c 7 ] ;$$

$$y 3 = [ ( x 0 - x 7 ) * c 3 - ( x 3 - x 4 ) * c 5 ] - [ ( x 1 - x 6 ) * c 7 + ( x 2 - x 5 ) * c 1 ] ;$$

$$and$$

$$y 7 = [ ( x 0 - x 7 ) * c 7 - ( x 3 - x 4 ) * c 1 ] - [ ( x 1 - x 6 ) * c 5 - ( x 2 - x 5 ) * c 3 ] .$$

In one embodiment, the above mentioned equations are implemented in three pipeline stages, producing eight coefficients at a time, as shown in FIG. 7a. FIG. 7a shows the logic structure 700 of the DCT unit 513 of FIG. 5. FIG. 7b is a view of the basic logic structure of the addition and subtraction circuit 701 comprising of an adder 705 and a subtractor 706. The input data x0 and x1 are input to the adder 705 and the subtractor 706. The adder 705 outputs the result of the addition of x0 and x1 as x0+x1, while the subtractor 706 outputs the result of subtraction of x0 and x1 as x0−x1. FIG. 7c is a view of the basic logic structure of the multiplication circuit 702 that multiplies a pair of input data x0 and x1 with parameters c1 and c7 to output quadruple values c1xo, c1x1, c7x0 and c7x1.

Referring now to FIGS. 7a, 7b, and 7c the circuit structure 700 uses a plurality of addition and subtraction circuits 701 and multiplication circuits 702 to produce eight outputs yₒ to y₇. The transformation process begins with eight inputs x0 to x7 representing timing signals of an image pixel data block. In stage one, the eight inputs x0 to x7 are combined pair-wise to obtain first intermediate values a0 to a7. For example, input values x0 and x7 are combined in addition and subtraction circuit 7011 to produce first intermediate values a0=x0+x7 and a1=x0−x7. Similarly, input values x3 and x4 are combined in addition and subtraction circuit 7012 to produce first intermediate values a2=x3+x4 and a3=x3−x4. First intermediate values a0, a2, a4 and a6 are combined pair-wise to obtain second intermediate values a8 to all. For example, a0=x0+x7 and a2=x3+x4 are combined in addition and subtraction circuit 7013 to produce second intermediate values a8=a0+a2 and a9=a0−a2 and so on as is evident from FIG. 7a.

In stage two the second intermediate values a8 to all and first intermediate values a1, a3, a5, a7 are selectively paired, written to first stage intermediate value holding registers 720 from where they are output pair-wise to multiplication circuits where they are multiplied with parameters c1 to c7. For example, second intermediate values a8=a0+a2 and a10=a4+a6 are multiplied with a pair of parameters c4, c4 in multiplication circuit 7021 to obtain a quadruple of intermediate values k0=a8c4, k1=a10c4, k2=a8c4 and k3=a10c4 that are written to second stage intermediate value holding registers 721. Persons of ordinary skill in the art would appreciate that values k0, k1, k2 and k3 are equivalent to [(x0+x7)+(x3+x4)]c4, [(x1+x6)+(x2+x5)]c4, [(x0+x7)+(x3+x4)]c4, [(x1+x6)+(x2+x5)]c4 respectively. Similarly, values k4 to k23 are obtained as evident from the logic flow diagram of FIG. 7a.

In stage three, a routing switch 725 is used that outputs intermediate values k0 to k23 in selective pairs for further adding or subtraction. For example, values k0 and k1 are added to obtain intermediate value m0=k0+k1 while values k6 and k7 are subtracted to obtain intermediate value m3=k6−k7 and so on as shown in FIG. 7a. Values m0, m1, m2 and m3 are written to stage three intermediate value holding registers 722 as p12, p15, p13, p14 respectively. However, values m4, m5 and m8 to m13 are paired and added or subtracted appropriately to obtain values n4 to n7 that are written to stage three intermediate value holding registers 722 as p4 to p7 respectively. The values of third stage intermediate value holding registers p4 to p7 and p12 to p15 are added or subtracted appropriately with an offset signal to obtain eight output coefficients y0 to y7 via shift registers.

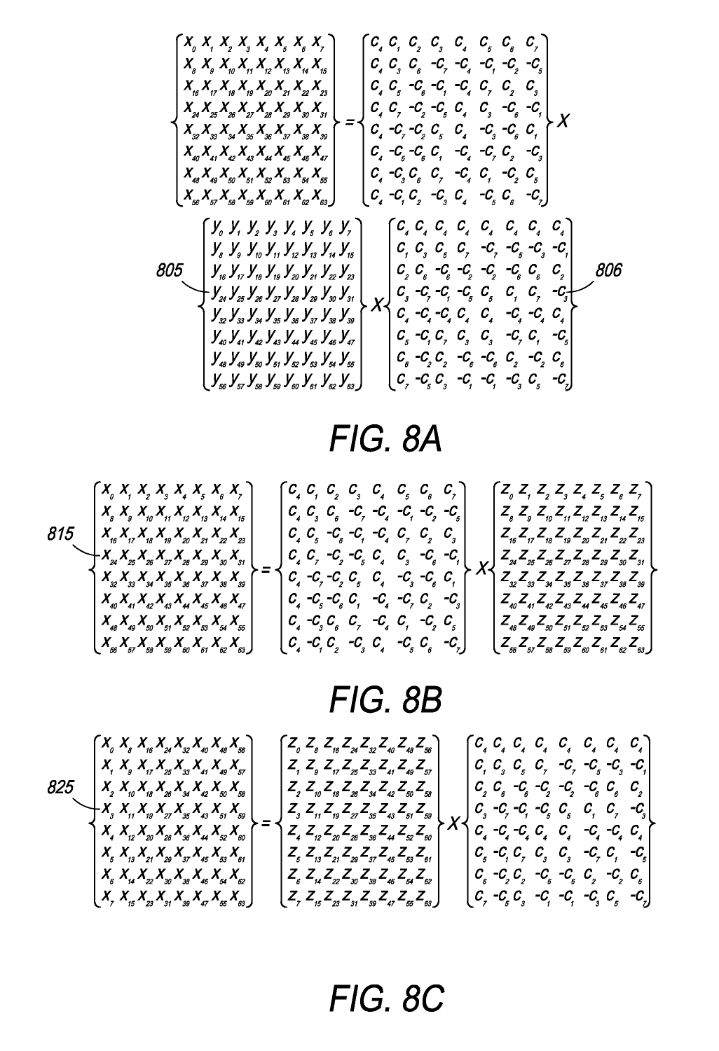

Since the inverse and forward DCT are orthogonal, the inverse DCT is given as X=C^{T}YC, where C is the transformation matrix, Y is the input transformed coefficients and X is the output inverse transformed samples. For an 8-point inverse DCT, this equation can be implemented mathematically in the form of 8×8 matrices as shown in FIG. 8a. FIG. 8b shows the resultant matrix equation 815 after multiplying matrices 805 and 806. In the equation of FIG. 8b the matrices on both sides are transposed to finally obtain the equation 825 of FIG. 8c. For an H.264 codec the IDCT 8×8 coefficients c1:c7 are {12, 8, 10, 8, 6, 4, 3}.

For H.264 codec:

a0=y0+y4;

a4=y0−y4;

a2=(y2>>1)−y6;

a6=y2+(y6>>1);

a1=−y3+y5−y7−(y7>>1);

a3=y1+y7−y3−(y3>>1);

a5=−y1+y7+y5+(y5>>1); and

a7=y3+y5+y1+(y1>>1).

### Further:

b0=a0+a6;

b2=a4+a2;

b4=a4−a2;

b6=a0−a6;

b1=a1+a7>>2;

b7=−a1>>2+a7;

b3=a3+a5>>2; and

b5=a3>>2−a5.

Yet further:

m0=b0+b7;

m1=b2+b5;

m2=b4+b3;

m3=b6+b1;

m4=b6−b1;

m5=b4−b3;

m6=b2−b5; and

m7=b0−b7.

8-point Inverse DCT can be viewed as matrix multiplication as shown below:

{x0x1x2x3x4x5x6x7}={y0y1y2y3y4y5y6y7}×B

where:

$$B = \{ \begin{matrix}{c}_{4} & {c}_{4} & {c}_{4} & {c}_{4} & {c}_{4} & {c}_{4} & {c}_{4} & {c}_{4} \\ {c}_{1} & {c}_{3} & {c}_{5} & {c}_{7} & - {c}_{7} & - {c}_{5} & - {c}_{3} & - {c}_{1} \\ {c}_{2} & {c}_{6} & - {c}_{6} & - {c}_{2} & - {c}_{2} & - {c}_{6} & {c}_{6} & {c}_{2} \\ {c}_{3} & - {c}_{7} & - {c}_{1} & - {c}_{5} & {c}_{5} & {c}_{1} & {c}_{7} & - {c}_{3} \\ {c}_{4} & - {c}_{4} & - {c}_{4} & {c}_{4} & {c}_{4} & - {c}_{4} & - {c}_{4} & {c}_{4} \\ {c}_{5} & - {c}_{1} & {c}_{7} & {c}_{3} & - {c}_{3} & - {c}_{7} & {c}_{1} & - {c}_{5} \\ {c}_{6} & - {c}_{2} & {c}_{2} & - {c}_{6} & - {c}_{6} & {c}_{2} & - {c}_{2} & {c}_{6} \\ {c}_{7} & - {c}_{5} & {c}_{3} & - {c}_{1} & {c}_{1} & - {c}_{3} & {c}_{5} & - {c}_{7}\end{matrix} \}$$

$$x 0 = [ c 4 x 0 + c 2 x 2 + c 4 x 4 + c 6 x 6 ] + [ c 1 x 1 + c 3 x 3 + c 5 x 5 + c 7 x 7 ] ;$$

$$x 1 = [ c 4 x 0 + c 6 x 2 - c 4 x 4 - c 2 x 6 ] + [ c 3 x 1 - c 7 x 3 - c 1 x 5 - c 5 x 7 ] ;$$

$$x 2 = [ c 4 x 0 - c 6 x 2 - c 4 x 4 + c 2 x 6 ] + [ c 5 x 1 - c 1 x 3 + c 7 x 5 + c 3 x 7 ] ;$$

$$x 3 = [ c 4 x 0 - c 2 x 2 + c 4 x 4 - c 6 x 6 ] + [ c 7 x 1 - c 5 x 3 + c 3 x 5 - c 1 x 7 ] ;$$

$$x 7 = [ c 4 x 0 + c 2 x 2 + c 4 x 4 + c 6 x 6 ] - [ c 1 x 1 + c 3 x 3 + c 5 x 5 + c 7 x 7 ] ;$$

$$x 6 = [ c 4 x 0 + c 6 x 2 - c 4 x 4 - c 2 x 6 ] - [ c 3 x 1 - c 7 x 3 - c 1 x 5 - c 5 x 7 ] ;$$

$$x 5 = [ c 4 x 0 - c 6 x 2 - c 4 x 4 + c 2 x 6 ] - [ c 5 x 1 - c 1 x 3 + c 7 x 5 + c 3 x 7 ] ;$$

$$and$$

$$x 4 = [ c 4 x 0 - c 2 x 2 + c 4 x 4 - c 6 x 6 ] - [ c 7 x 1 - c 5 x 3 + c 3 x 5 - c 1 x 7 ] .$$

For H.264 codec:

a0=y0+y4=k0+k1=m0=m6;

a4=y0−y4=k0−k1=m2=m4;

a2=(y2>>1)−y6=k6−k7=m3=m5;

a6=y2+(y6>>1)=k4+k5=m1=m7;

a1=−y3+y5−y7−(y7>>1)=(y5)−(y3+y7+y7>>1)=(k10+k13)−(k16+k23)=m14−m15=p7;

a3=y1+y7−y3−(y3>>1)=(y1)−(y3+y3>>1−y7)=(k12+k9)−(k20−k17)=m12−m13=p6;

a5=−y1+y7+y5+(y5>>1)=−((y1−(y5+y5>>1))−y7)=−((k14−k11)−(k22+k19))=−(m10−m11)=−p5; and

a7=y3+y5+y1+(y1>>1)=((y1+y1>>1)+y5)+(y3)=(k8+k15)+(k18+k21)=m8+m9=p4.

### Further:

b0=a0+a6=m0+m1=p0;

b2=a4+a2=m2+m3=p1;

b4=a4−a2=m4−m5=p2;

b6=a0−a6=m6−m7=p3;

b1=a1+a7>>2=p7+p4>>2=q4;

b3=a3+a5>>2=p6+(−(−p5>>2))=q5;

b5=a3>>2−a5=p6>>2+(−p5)=q6; and

b7=−a1>>2+a7=−p7>>2+p4=q7.

Yet further:

m0=b0+b7=p0+q7=x0;

m1=b2+b5=p1+q6=x1;

m2=b4+b3=p2+q5=x2;

m3=b6+b1=p3+q4=x3;

m4=b6−b1=p3−q4=x4;

m5=b4−b3=p2−q5=x5;

m6=b2−b5=p1−q6=x6; and

m7=b0−b7=p0−q7=x7.

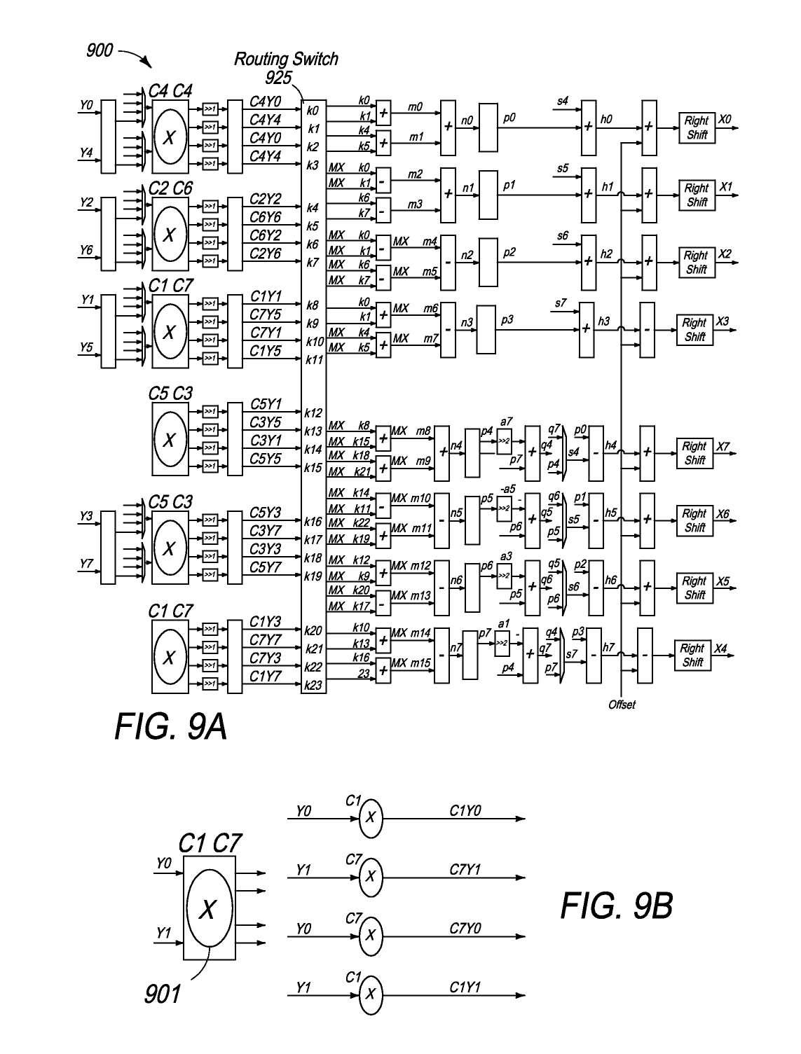

These equations are implemented in pipeline stages, producing eight output inverse transforms at a time, as shown in FIG. 9a. FIG. 9a shows the logic structure 900 of DCT unit 513, as shown in FIG. 5, configured to perform an 8-point inverse DCT of the present invention. It should be noted, therefore that the logic structure 900 of FIG. 9a and logic structure 700 of FIG. 7a are implemented in a unified/single piece of hardware that arranges functions and connects them through a routing switch to be used by both forward and inverse DCT. Therefore, using only changes in programmatic configurations (not in hardware or circuitry), different DCT/IDCT functions can be programmed. FIG. 9b is a view of the basic structure of the multiplication circuit 901 that multiplies a pair of input transformed coefficients y0 and y1 with parameters c1 and c7 to output quadruple values c1yo, c1y1, c7y0 and c7y1.

As illustrated in FIG. 9a, the inverse transformation process begins with eight inputs y0 to y7 representing transformation coefficients that are selectively paired for multiplication with parameters c1 to c7 in multiplication circuits to produce intermediate values k0 to k23. These intermediate values k0 to k23 are selectively routed by routing switch 925 to various addition and subtraction intermediate units to finally obtain eight output inverse transformed values x0 to x7.

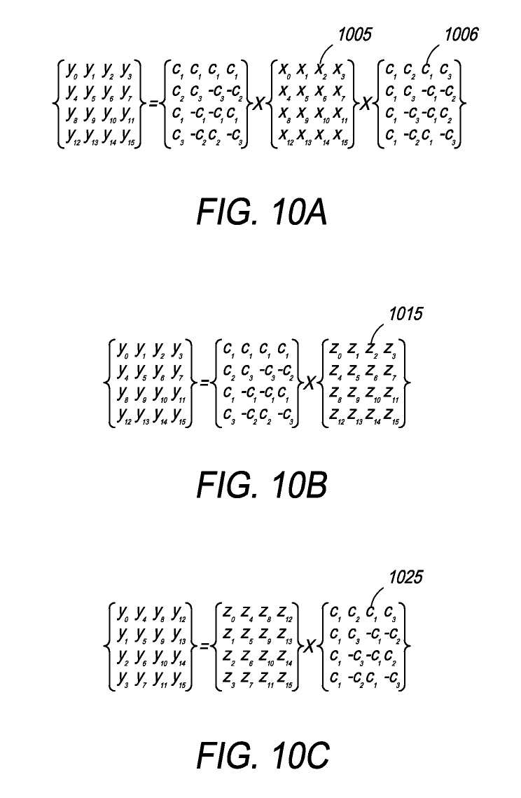

For a 4-point forward DCT, the transformation can be implemented mathematically in the form of 4×4 matrices as shown in FIG. 10a. FIG. 10b shows the resultant matrix equation 1015 after multiplying matrices 1005 and 1006. In the equation of FIG. 10b, the matrices on both sides are transposed to finally obtain the equation 1025 of FIG. 10c. For an H.264 codec, the DCT 4×4 coefficients c1:c3 are {1, 2, 1} and the Hadamard 4×4 coefficients c1:c3 are {1, 1, 1}.

Each time 4-point DCT is used, 4 coefficients are produced from matrix multiplication as shown below:

$$\{ \begin{matrix}y 0 & y 1 & y 2 & y 3\end{matrix} \} = \{ \begin{matrix}x 0 & x 1 & x 2 & x 3\end{matrix} \} \times \{ \begin{matrix}{c}_{1} & {c}_{2} & {c}_{1} & {c}_{3} \\ {c}_{1} & {c}_{3} & - {c}_{1} & - {c}_{2} \\ {c}_{1} & - {c}_{3} & - {c}_{1} & {c}_{2} \\ {c}_{1} & - {c}_{2} & {c}_{1} & - {c}_{3}\end{matrix} \}$$

$$y 0 = ( x 0 + x 3 ) * c 1 + ( x 1 + x 2 ) * c 1 ;$$

$$y 1 = ( x 0 - x 3 ) * c 2 + ( x 1 - x 2 ) * c 3 ;$$

$$y 2 = ( x 0 + x 3 ) * c 1 - ( x 1 + x 2 ) * c 1 ;$$

$$and$$

$$y 3 = ( x 0 - x 3 ) * c 3 - ( x 1 - x 2 ) * c 2.$$

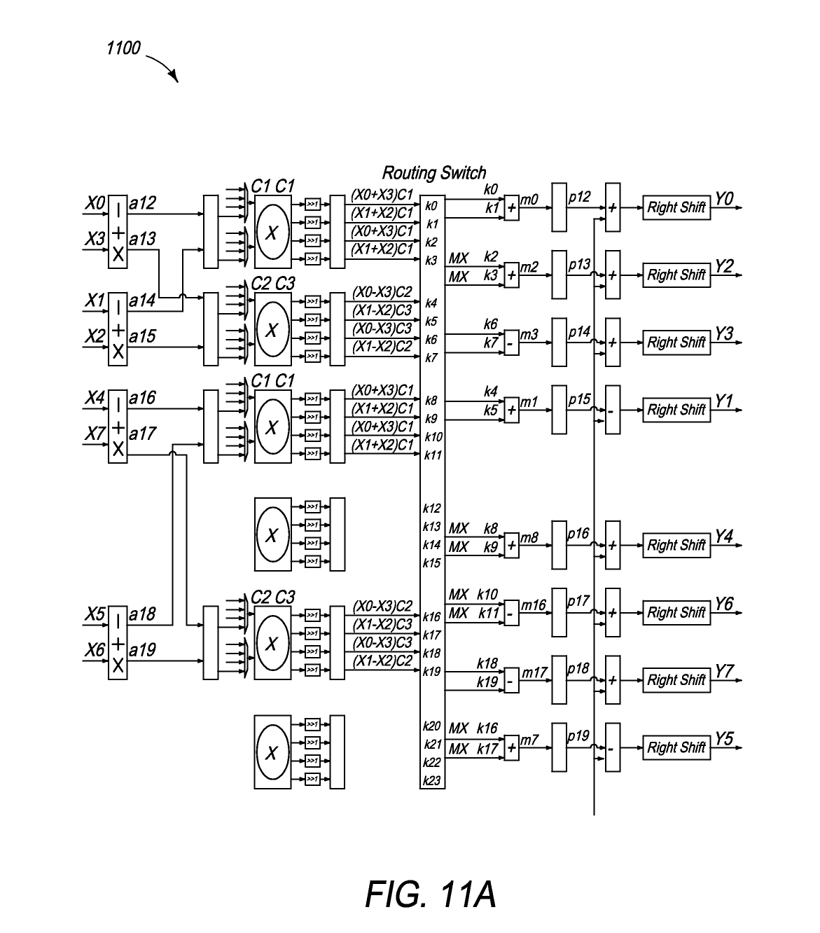

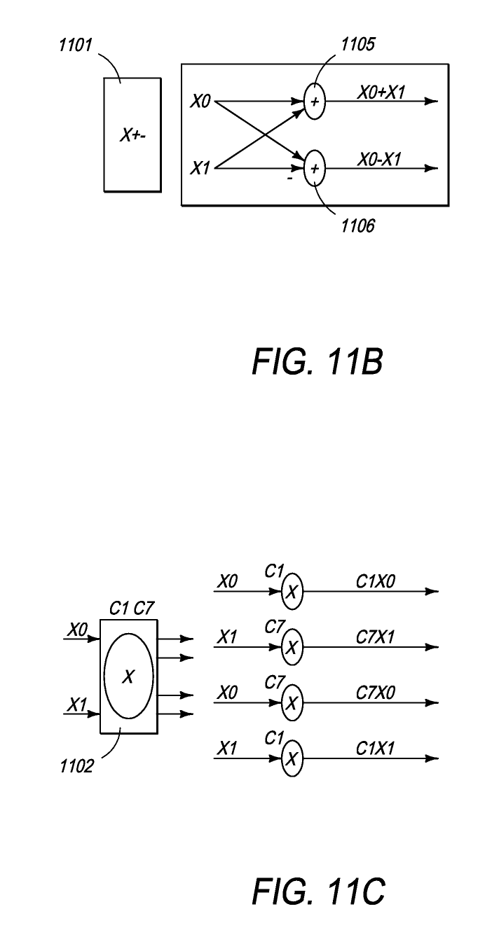

Again, the logic structure 700 of FIG. 7a is re-used to perform 4-point DCT processing. Since the resources are enough, two rows or two columns simultaneously are processed for 4-point DCT as shown in FIG. 11a, the basic function of which has been described above.

FIG. 11b is a view of the basic structure of the addition and subtraction circuit 1101 comprising of a pair of an adder 1105 and a subtractor 1106. The input data x0 and x1 are input to the adder 1105 and the subtractor 1106. The adder 1105 outputs the result of the addition of x0 and x1 as x0+x1, while the subtractor 1106 outputs the result of subtraction of x0 and x1 as x0−x1. FIG. 11c is a view of the basic structure of the multiplication circuit 1102 that multiplies a pair of input data x0 and x1 with parameters c1 and c7 to output quadruple values c1xo, c1x1, c7x0 and c7x1. As illustrated in FIG. 11a, the transformation process begins with eight inputs x0 to x7 representing two rows of the timing signals of a 4×4 image pixel data block. In other words, two rows are simultaneously processed resulting in the output of eight coefficients y0 to y7. Again the logical circuit 1100 in FIG. 11a uses the same underlying hardware as the logical circuits 700 of FIGS. 7a and 900 of FIG. 9a.

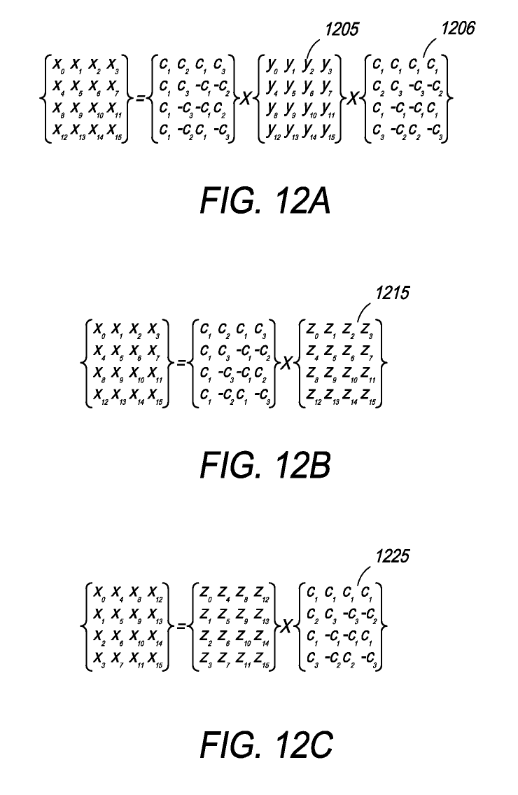

For a 4-point inverse DCT, the transformation can be implemented mathematically in the form of 4×4 matrices as shown in FIG. 12a. FIG. 12b shows the resultant matrix equation 1215 after multiplying matrices 1205 and 1206. In the equation of FIG. 12b, the matrices on both sides are transposed to finally obtain the equation 1225 of FIG. 12c. For H.264 codec, the IDCT 4×4 coefficients c1:c3 are {2, 2, 1} and the iHadamard 4×4 coefficients c1:c3 are {1, 1, 1}.

4-point Inverse DCT can be implemented by matrix multiplication as shown below:

$$\{ \begin{matrix}x 0 & x 1 & x 2 & x 3\end{matrix} \} = \{ \begin{matrix}y 0 & y 1 & y 2 & y 3\end{matrix} \} * \{ \begin{matrix}{c}_{1} & {c}_{1} & {c}_{1} & {c}_{1} \\ {c}_{2} & {c}_{3} & - {c}_{3} & - {c}_{2} \\ {c}_{1} & - {c}_{1} & - {c}_{1} & {c}_{1} \\ {c}_{3} & - {c}_{2} & {c}_{2} & - {c}_{3}\end{matrix} \}$$

$$x 0 = ( x 0 c 1 + x 2 c 1 ) + ( x 1 c 2 + x 3 c 3 ) ;$$

$$x 1 = ( x 0 c 1 - x 2 c 1 ) + ( x 1 c 3 - x 3 c 2 ) ;$$

$$x 2 = ( x 0 c 1 - x 2 c 1 ) - ( x 1 c 3 - x 3 c 2 ) ;$$

$$and$$

$$x 3 = ( x 0 c 1 + x 2 c 1 ) - ( x 1 c 2 + x 3 c 3 ) .$$

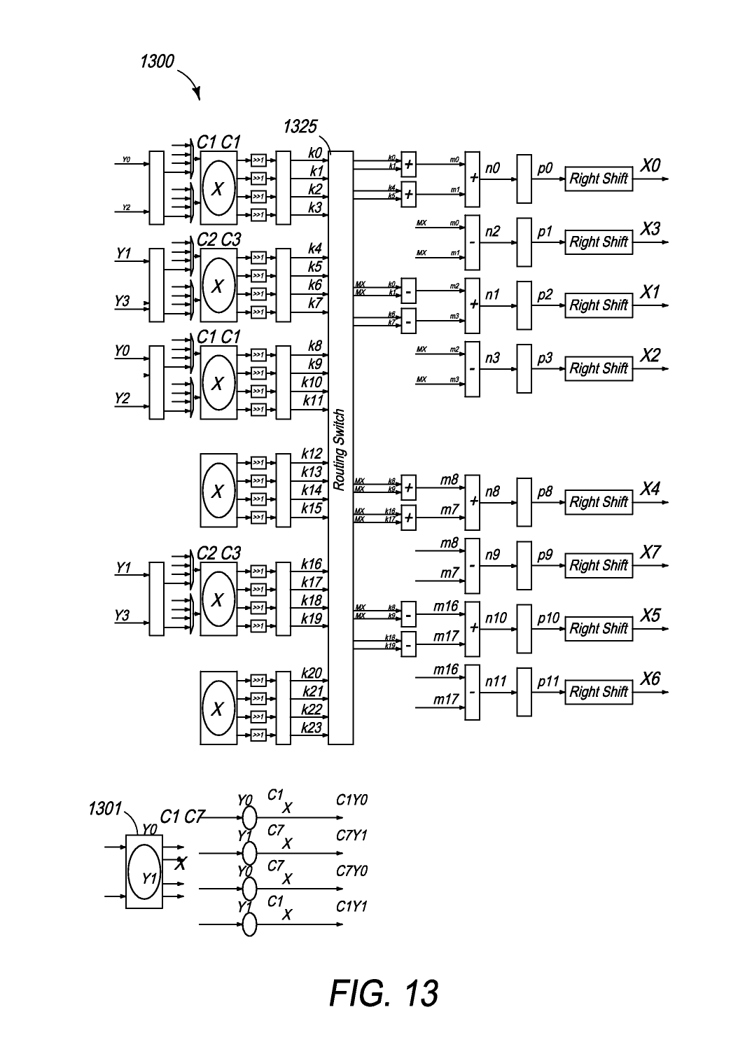

These equations are implemented in pipeline stages, producing eight output inverse transforms at a time, as shown in FIG. 13 and similarly described above. As illustrated in FIG. 13, the inverse transformation process begins with eight inputs y0 to y7 representing two rows of 4×4 transformation coefficients that are selectively paired for multiplication with parameters c1 to c7 in multiplication circuits 1301 to produce intermediate values k0 to k23. These intermediate values k0 to k23 are selectively routed by routing switch 1325 to various addition and subtraction intermediate units to finally obtain eight output inverse transformed values x0 to x7. As discussed above, the logical circuit 1300 in FIG. 13a uses the same underlying hardware as the logical circuits 1100 of FIG. 11a, 700 of FIGS. 7a and 900 of FIG. 9a.

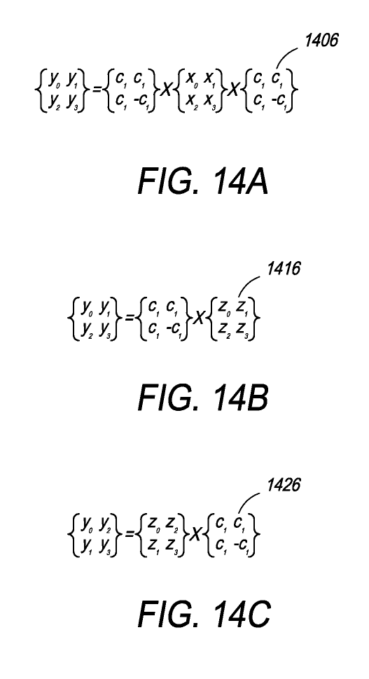

For a 2-point forward DCT, the transformation can be implemented mathematically in the form of 2×2 matrices as shown in FIG. 14a. FIG. 14b shows the resultant matrix equation 1416 after multiplying matrices 1405 and 1406. In the equation of FIG. 14b, the matrices on both sides are transposed to finally obtain the equation 1426 of FIG. 14c. For H.264 codec, the Hadamard2×2 coefficient c1 is 1.

Each time 2-point DCT is used, 2 coefficients are produced from 2×1 by 2×2 matrix multiplication as shown below:

$$\{ \begin{matrix}y 0 & y 1\end{matrix} \} = \{ \begin{matrix}x 0 & x 1\end{matrix} \} * \{ \begin{matrix}{c}_{1} & {c}_{1} \\ {c}_{1} & - {c}_{1}\end{matrix} \}$$

$$y 0 = ( x 0 + x 1 ) * c 1$$

$$y 1 = ( x 0 - x 1 ) * c 1$$

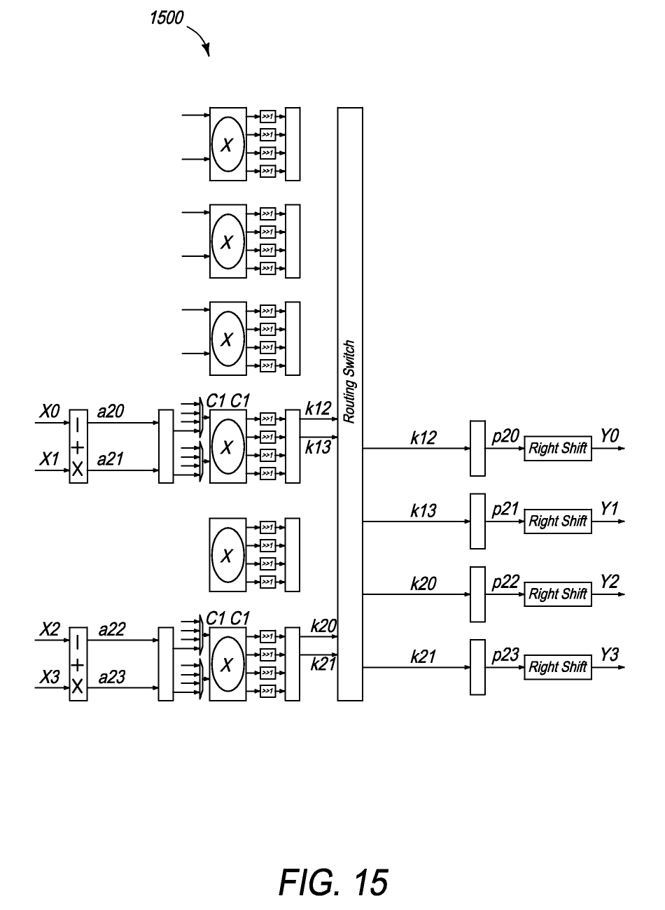

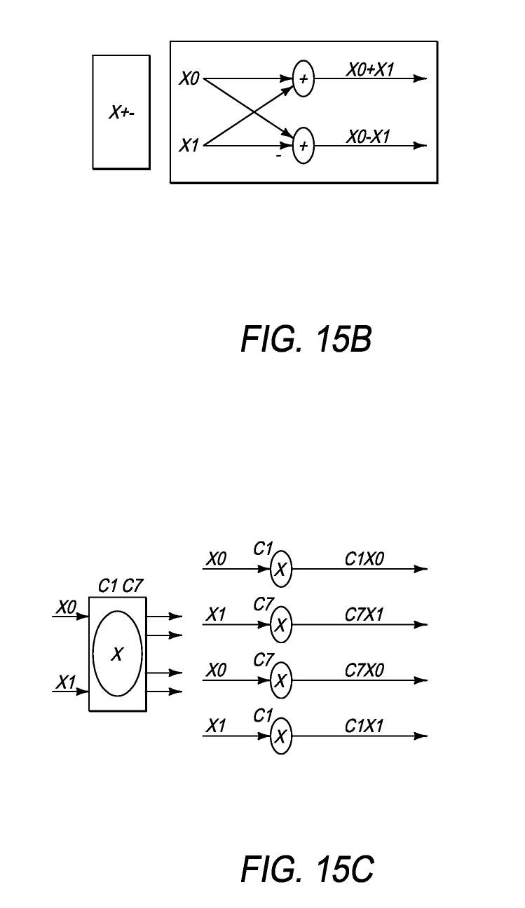

As discussed above, the logical circuit 1500 in FIG. 15a used to implement the 2-point forward DCT relies on the same underlying hardware as the logical circuits 1100 of FIG. 11a, 1300 in FIG. 13a, 700 of FIGS. 7a and 900 of FIG. 9a. Since the resources are enough, two rows or two columns simultaneously are processed for 2-point forward and inverse DCT as shown in FIG. 15.

Referring back to FIG. 5, the DCT unit 513 can be used to implement DCT/IDCT processing in accordance with various standards, including H.264, VC-1, MPEG-2, MPEG-4, or AVS, in a forward or reverse manner, and for any size macro block, including 16×16, 16×8, 8×16, 8×8, 8×4, 4×8, 4×4, and 2×2 blocks. The structure of the 8 quantizer unit 517 will now be described.

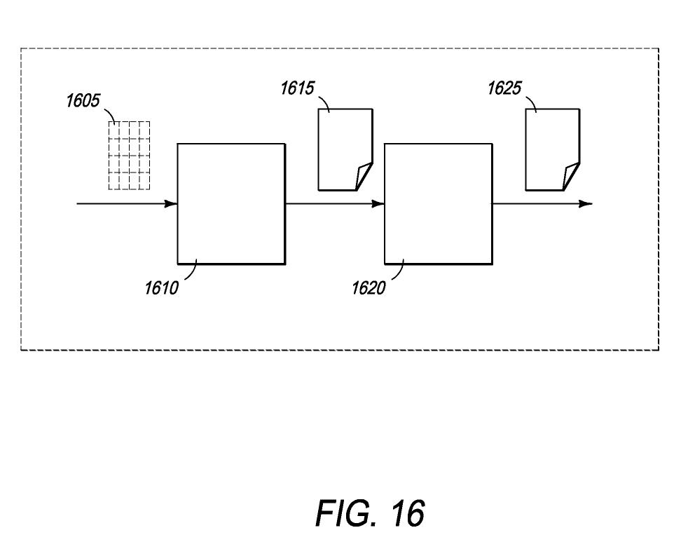

FIG. 16 is a block diagram describing a transformation and quantization of a set of video samples 1605. The transformer 1610 transforms partitions of the video samples 1605 into the frequency domain, thereby resulting in a corresponding set of frequency coefficients 1615. The frequency coefficients 1615 are then passed to a quantizer 1620, resulting in set of quantized frequency coefficients 1625. A quantizer maps a signal with a range of values X to a quantized signal with a reduced range of values Y. The scalar quantizer maps each input signal to one output quantized signal.

The amount of quantization is controlled by a step value referred to as Quantization Parameter (QP). QP determines the scaling value with which each element of the block is quantized or scaled. These scaling values are stored in lookup tables, such as within a scaling memory, at the time of initialization, and are retrieved later during the quantization operation. The QP computes the pointer to this table. Thus, the quantizer is programmed with a quantization level or step size.

According to an important aspect of the present invention the quantization and de-quantization occur in the same pipeline stage and therefore the operations are performed in sequence one after the other using the same hardware structure. In other words, according to a novel aspect the hardware structure of the present invention is configurable and generic to support different type of equations (depending upon different types of video encoding standards or CODECs). This is accomplished by breaking down the hardware into simpler functions and then controlling them through instructions to perform different types of equations different types of video encoding standards or CODECs.

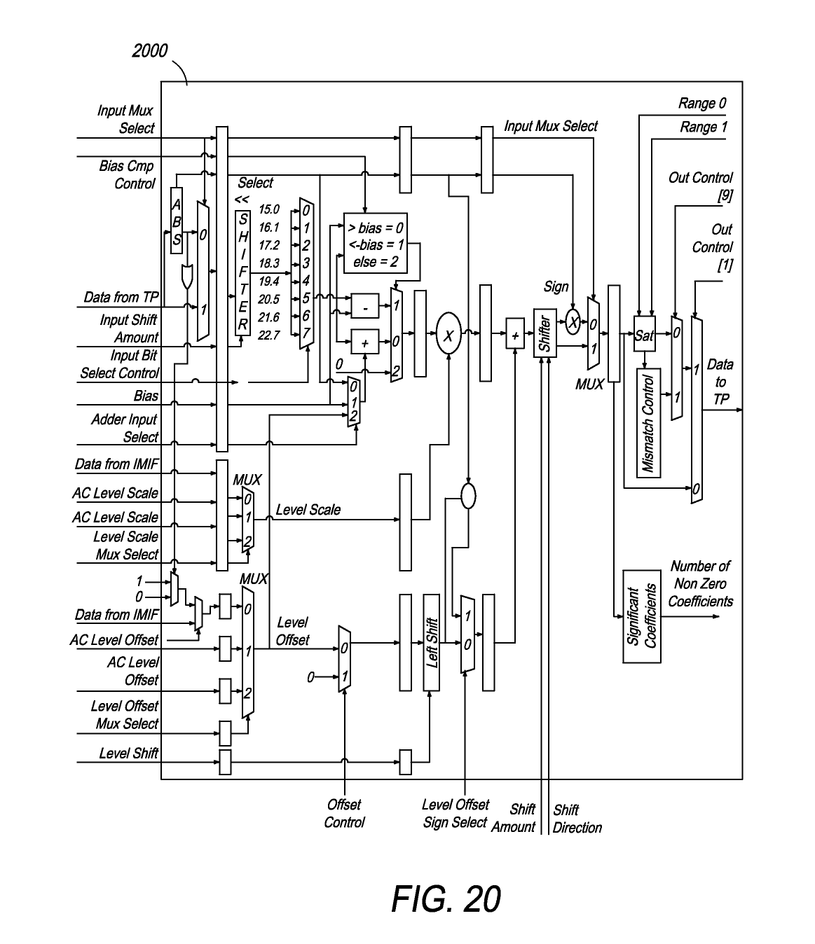

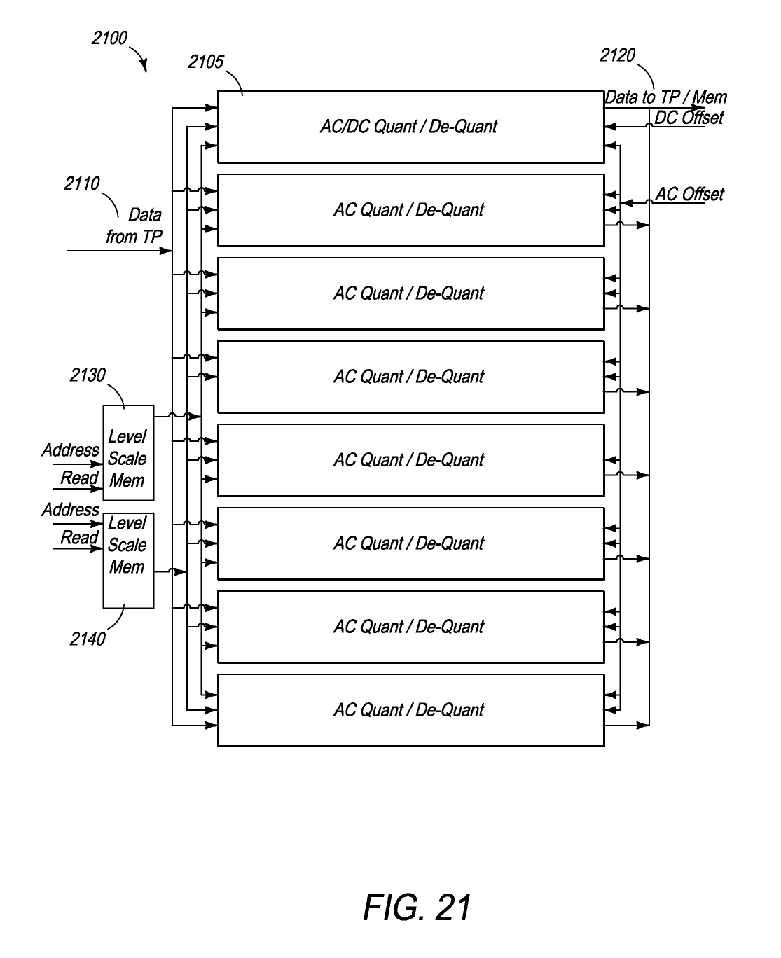

Referring to FIG. 5, the quantizer unit 517 has eight layers, shown in greater detail in FIG. 21. FIG. 21 shows a top level architecture of Quantizer/De-Quantizer 2100 of the present invention comprising 8 layers 2105, which each layer 2000 being shown in greater detail in FIG. 20. Data from the transpose registers 2110 enters the various layers 2105 in parallel and then exits to the transpose registers 2120 in parallel. It should be appreciated that any number of layers can be used. It should further be appreciated that each layer, using the same physical circuitry or hardware, can be used to process data in accordance with one of several standards or protocols (such as H.264, VC-1, MPEG-2, MPEG-4, or AVS). In one embodiment, different layers 2105 process data in accordance with a different protocol (such as H.264, VC-1, MPEG-2, MPEG-4, or AVS). FIG. 20 shows the physical circuitry 2000 of each layer of the Quantizer/De-Quantizer hardware unit. It should be appreciated that the same physical circuit 2000 can be programmatically configured to process data in accordance with several different standards or protocols (such as H.264, VC-1, MPEG-2, MPEG-4, or AVS), without changing the physical circuit.

As mentioned earlier the quantization techniques used depend on the encoding standard. For example, the ITU-T Video Coding Experts Group (VCEG) and the ISO/IEC Moving Picture Experts Group (MPEG) drafted a video coding standard titled ITU-T Recommendation H.264 and ISO/IEC MPEG-4 Advanced Video Coding, which is incorporated herein by reference. In the H.264 standard, video is encoded on a macroblock-by-macroblock basis.

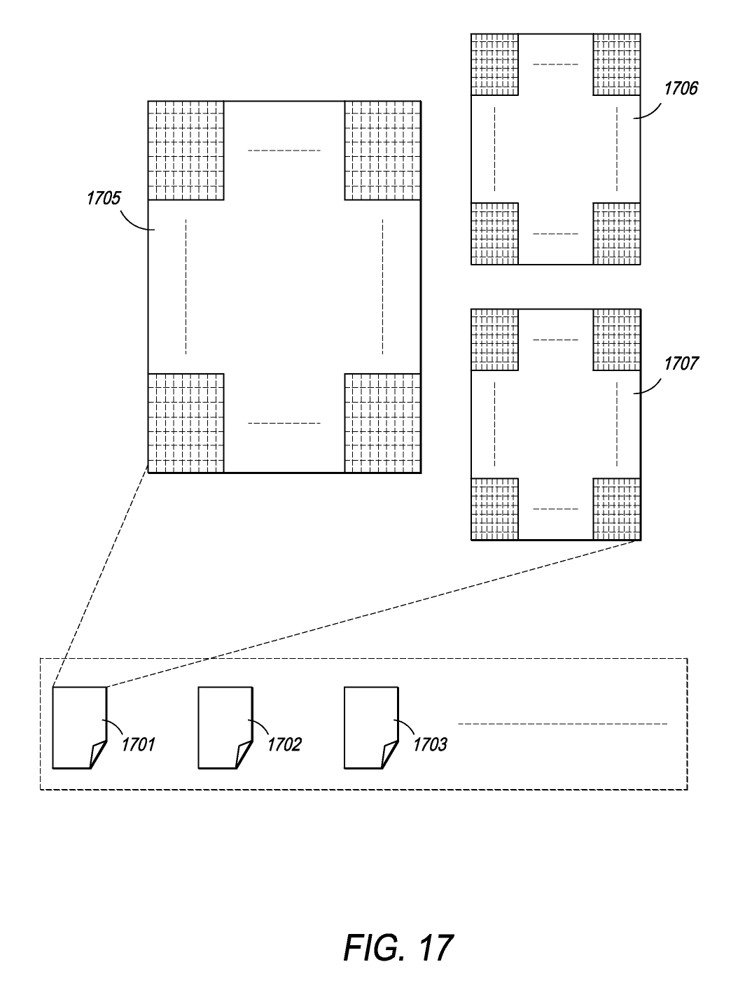

FIG. 17 is a block diagram of a video sequence formed of successive pictures 1701 through 1703. The picture 1701 comprises two-dimensional grid(s) of pixels. For color video, each color component is associated with a unique two-dimensional grid of pixels. Persons of ordinary skill in the art would appreciate that a picture can include luma (Y), chroma red (Cr), and chroma blue (Cb) components. Accordingly, these components are associated with a luma grid 1705, a chroma red grid 1706, and a chroma blue grid 1707. When the grids 1705, 1706 and 1707 are overlayed on a display device, the result is a picture of the field of view at the duration that the picture was captured.

Generally, the human eye is more perceptive to the luma characteristics of video, compared to the chroma red and chroma blue characteristics. Accordingly, there are more pixels in the luma grid 1705 compared to the chroma red grid 1706 and the chroma blue grid 1707. In the H.264 standard, the chroma red grid 1706 and the chroma blue grid 1707 have half as many pixels as the luma grid 1705 in each direction. Therefore, the chroma red grid 1706 and the chroma blue grid 1707 each have one quarter as many total pixels as the luma grid 1705. Also, H.264 uses a non-linear scalar, where each component in the block is quantized using a different step value.

In one embodiment there are two lookup tables namely LevelScale 2130 and LevelOffset 2140, shown as inputs into the quantization layers 2105 in FIG. 21. During the quantization process, values from these tables are read and used in the equations (provided below) using index pointers that are computed using QP. Variables that change dynamically during a frame are saved in these lookup tables and the ones that need to be set only at the beginning of a session are stored in registers.

### H.264 Coding Standard

LevelScale=LevelScale4×4Luma[1][luma_qp_rem]
LevelOffset=LevelOffset4×4Luma [1][luma_qp_per]

### Luma—Residual 4×4 in 16×16 Intra Mode

### DC Values

$$level = [ \begin{matrix}( abs ( input ) * LevelSacle [ indxPtr ] ) + \\ ( LevelOffset [ indxPtr ] << 1 )\end{matrix} ] >> ( qbits + 1 )$$

$$ouput = level * sign ( input )$$

### AC Values

$$level = [ \begin{matrix}( abs ( input ) * LevelSacle [ indxPtr ] ) + \\ ( LevelOffset [ indxPtr ] )\end{matrix} ] >> ( qbits )$$

$$ouput = level * sign ( input )$$

### Luma—Other Residual Blocks

### DC/AC Values

level=[(abs(input)*LevelSacle[indxPtr])+(LevelOffset[indxPtr])]>>(qbits)

ouput=level*sign(input)

### Chroma (Both Cr and Cb)

LevelScale=LevelScale4×4Chroma [CrCb][Intra][cr_qp_rem or cb_qp_rem]
LevelOffset=LevelOffset4×4Chroma [CrCb][Intra][cr_qp_per or cb_qp_per]

### CrCb=0 for Cr

### CrCb=1 for Cb

### DC Values

$$level = [ \begin{matrix}( abs ( input ) * LevelSacle [ indxPtr ] ) + \\ ( LevelOffset [ indxPtr ] << 1 )\end{matrix} ] >> ( qbits + 1 )$$

$$ouput = level * sign ( input )$$

### AC Values

$$level = [ \begin{matrix}( abs ( input ) * LevelSacle [ indxPtr ] ) + \\ ( LevelOffset [ indxPtr ] )\end{matrix} ] >> ( qbits )$$

$$ouput = level * sign ( input )$$

### VC-1 Coding Standard

VC-1 is a standard promulgated by the SMPTE, and by Microsoft Corporation (as Windows Media 9 or WM9).

### DC Values

### MQUANT=1˜31

### DCStepSize=1˜63

Output=[(input)*DQScaleTable [DCStepSize])+(1<<17)]>>18

### AC Values

$$if ( input > MQUANT )$$

$$Output = [ ( \begin{matrix}( input - MQUANT ) * \\ DQScaleTable\end{matrix} [ \begin{matrix}2 * \\ MQUANT + \\ HalfStep\end{matrix} ] ) + ( 1 << 17 ) ] >> 18$$

$$elseif ( input < - MQUANT )$$

$$Output = [ ( \begin{matrix}( input + MQUANT ) * \\ DQScaleTable\end{matrix} [ \begin{matrix}2 * \\ MQUANT + \\ HalfStep\end{matrix} ] ) + ( 1 << 17 ) ] >> 18$$

$$else$$

$$Output = 0$$

### AVS Coding Standard

```
AC/DC Values
ScaleM[4][4]
Q_TAB[64]
QP = 0 ~ 63
if(intra)
    qp_cons tan t = (1<<15) *10/31
else
    qp_cons tan t = (1<<15) *10/62
for ( yy=0; yy<8; yy++ )
    for ( xx=0; xx<8; xx++ )
temp = absm(input)
output = sign( (((temp * ScaleM[yy & 3][xx & 3] + (1<<18))>>19)*
Q_TAB[QP] + qp_cons tan t)>>15)
```

De-Quantization is the inverse of quantization, where the quantized coefficients are scaled up to their normal range before transforming back to the spatial domain. Similar to quantization, there are equations (provided below) for the de-quantization.

### H.264 Coding Standard

### Luma

One embodiment uses a single lookup table—InvLevelScale. During de-quantization process, values from these tables are read and used in the equations (provided below) using index pointers that are computed using QP.

InvLevelScale=InvLevelScale4×4Luma[1][luma_qp_rem]

### Luma—Residual 4×4 in 16×16 Intra Mode

### DC Values

```
If (qp_per < 6)
    output = [(input * InvLevelScale [indxPtr]) +
    (1<<(5 − qp_per))] >> (6 − qp_per)
else
    output = [(input * InvLevelScale [indxPtr] ) + (0)]
    << (qp_per − 6)
```

### AC Values

$$If ( qp\_per < 4 ) \\ output = [ \begin{matrix}( input * InvLevelScale [ indxPtr ] ) + \\ ( 1 << (3 - qp\_per ) )\end{matrix} ] >> ( 4 - qp\_per ) \\ else \\ output = [ \begin{matrix}( input * InvLevelScale [ indxPtr ] ) + \\ ( 0 )\end{matrix} ] << (qp\_per - 4 )$$

### Luma—Other Residual Blocks

### AC/DC Values

$$If ( qp\_per < 4 ) \\ output = [ \begin{matrix}( input * InvLevelScale [ indxPtr ] ) + \\ ( 1 << (3 - qp\_per ) )\end{matrix} ] >> ( 4 - qp\_per ) \\ else \\ output = [ \begin{matrix}( input * InvLevelScale [ indxPtr ] ) + \\ ( 0 )\end{matrix} ] << (qp\_per - 4 )$$

### Chroma (Both Cr and Cb)

InvLevelScale=InvLevelScale4×4Chroma [CrCb][Intra][cr_qp_rem or cb_qp_rem]

### CrCb=0 for Cr

### CrCb=1 for Cb

### DC Values

```
If (qp_per < 5)
    output = [(input * InvLevelSacle[indxPtr]) + (0)] >>
    (5 − qp_per)
else
    output = [(input * InvLevelSacle[indxPtr]) + (0)] <<
    (qp_per − 5)
```

### AC Values

$$If ( qp\_per < 4 ) \\ output = [ \begin{matrix}( input * InvLevelSacle [ indxPtr ] ) + \\ ( 1 << (3 - qp\_per ) )\end{matrix} ] >> ( 4 - qp\_per ) \\ else \\ output = [ \begin{matrix}( input * InvLevelScale [ indxPtr ] ) + \\ ( 0 )\end{matrix} ] << (qp\_per - 4 )$$

### VC-1 Coding Standard

### DC Values

```
MQUANT = 1 ~ 31
DCStepSize = 1 ~ 63
If (MQUANT equal 1 or 2)
    DCStepSize = 2 * MQUANT
elseif (MQUANT equal 3 or 4)
    DCStepSize = 8
elseif (MQUANT >5)
    DCStepSize = MQUANT / 2 + 6
Output = input * DCStepSize
```

### AC Values

```
If (Uniform Quantizer)
    output = [input * (2 * MQUANT + HALFQP)]
else if(Non-uniform Quantizer)
    output = [(input * (2 * MQUANT + HALFQP)] +
    sign(input) * MQUANT
```

### AVS Coding Standard

### AC/DC Values

DequantTable[QP]
ShiftTable[QP
QP = 0 ~ 63
output = input * DequantTable[QP] + 2^{ShiftTable[QP]-1}) >> ShiftTable[QP]

In one embodiment, assuming 16-bits for Level Scale, Inverse Level Scale & Level Offset, the total memory required for Level Scale is 1344 Bytes, and for Level Offset & Inverse Level Scale together is 1728 Bytes. With 128-bit wide memory, one instance of 84 & one instance of 108 deep memories are needed, in one embodiment.

### Motion Compensation Engine Using Single Data Path for Multiple Codecs

Standards such as MPEG, AVS, VC-1, ITU-T H.263 and ITU-T H.264 support video coding techniques that utilize similarities between successive video frames, referred to as temporal or inter-frame correlation, to provide inter-frame compression. The inter-frame compression techniques exploit data redundancy across frames by converting pixel-based representations of video frames to motion representations. In addition, some video coding techniques may utilize similarities within frames, referred to as spatial or intra-frame correlation, to further compress the video frames. The video frames are often divided into smaller video blocks, and the inter-frame or intra-frame correlation is applied at the video block level.

In order to achieve video frame compression, a digital video device typically includes an encoder for compressing digital video sequences, and a decoder for decompressing the digital video sequences. In many cases, the encoder and decoder form an integrated “codec” that operates on blocks of pixels within frames that define the video sequence. For each video block in the video frame, a codec searches similarly sized video blocks of one or more immediately preceding video frames (or subsequent frames) to identify the most similar video block, referred to as the “best prediction.” The process of comparing a current video block to video blocks of other frames is generally referred to as motion estimation. Once a “best prediction” is identified for a current video block during motion estimation, the codec can code the differences between the current video block and the best prediction.

This process of coding the differences between the current video block and the best prediction includes a process referred to as motion compensation. Motion compensation comprises a process of creating a difference block indicative of the differences between the current video block to be coded and the best prediction. In particular, motion compensation usually refers to the act of fetching the best prediction block using a motion vector, and then subtracting the best prediction from an input block to generate a difference block. The difference block typically includes substantially less data than the original video block represented by the difference block.

The present invention provides a motion compensation processor that is a highly configurable, programmable, scalable processing unit that handles a plurality of codecs. In one embodiment the motion compensation processor comprises the front end processor with an extendable data path, and more specifically, functional data path configured to provide motion compensation processing. In one embodiment, this processor runs at or below 500 MHz, more preferably 250 MHz. In another embodiment, the physical circuit structure of this processor can be logically programmed to process high definition content using multiple different codecs, protocols, or standards, including H.264, AVS, H.263, VC-1, or MPEG (any generation), while running at or below 250 MHz

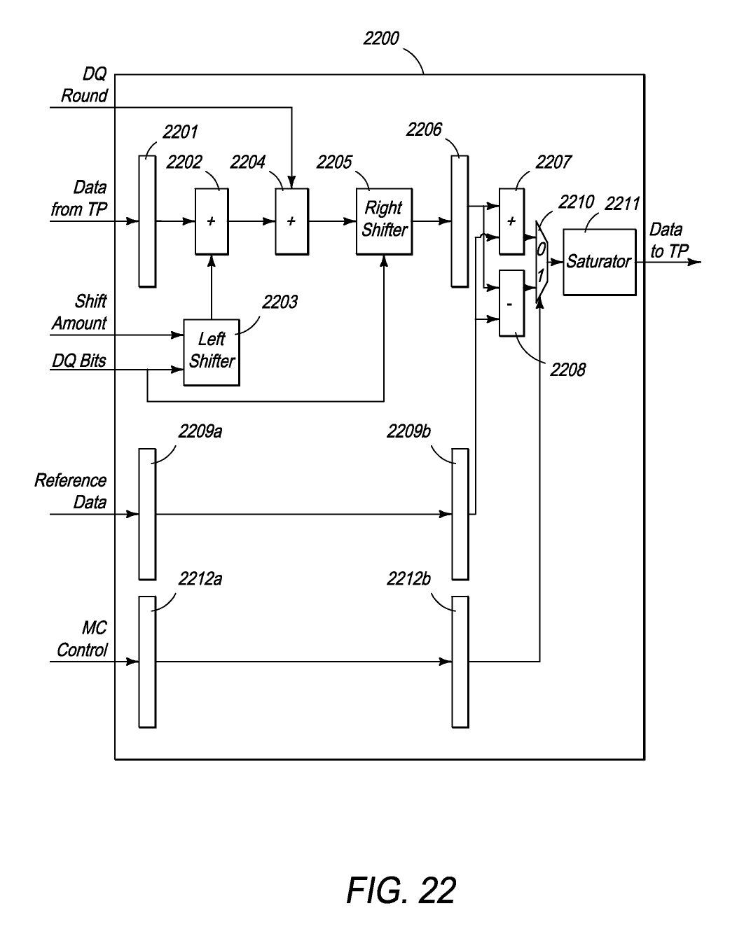

FIG. 22 shows an embodiment of hardware structure of a motion compensation engine 2200, implemented as a functional data path 115 of FIG. 1, of the present invention. Data is written to register 2201 which is read into adder 2202 that also receives shift amount and DQ bits from left shifter 2203. Data from adder 2202 is received in adder 2204 along with DQ round data. The output from adder 2204 is received in right shifter 2205 along with DQ bits. The right shifted data is written to register 2206 from where it is read into adder 2207 and subtracter 2208. As shown is FIG. 22, adder 2207 receives data from register 2206 and reference data from registers 2209a, 2209b. Similarly, subtracter 2208 receives data from register 2206 and reference data from registers 2209a, 2209b. Outputs from adder 2207 and subtracter 2208 are inputted into multiplexer 2210 that outputs data to saturator 2211 for onwards data communication to TP. Motion Compensation control data is fed to multiplexer 2210 from registers 2212a, 2212b. In one embodiment, the motion compensation engine of the present invention provides two levels of control: first, selecting the right values based on instructions that are codec dependent and second, knowing how many/which bits to keep after filtering.

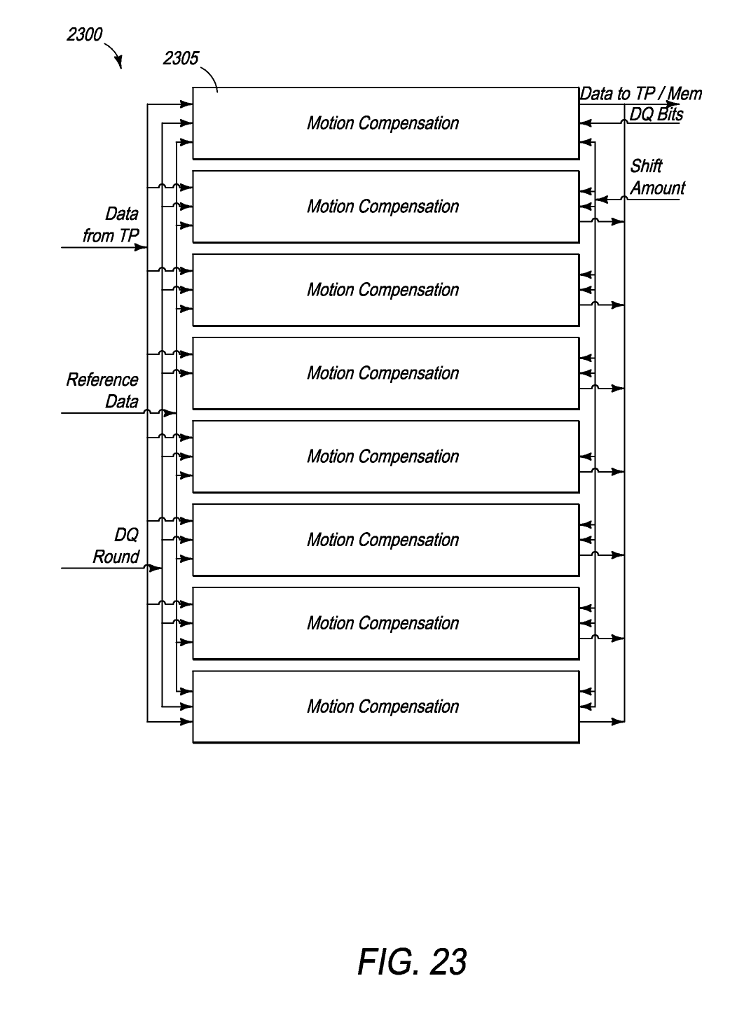

FIG. 23 shows a top level motion compensation engine architecture 2300 that comprises eight motion compensation units 2305, each of which comprising motion compensation circuitry 2200 as shown in FIG. 22. It should be appreciated that this motion compensation engine 2300 could be implemented as a functional data path (115 of FIG. 1) using any number of units 2305.

### Scaler

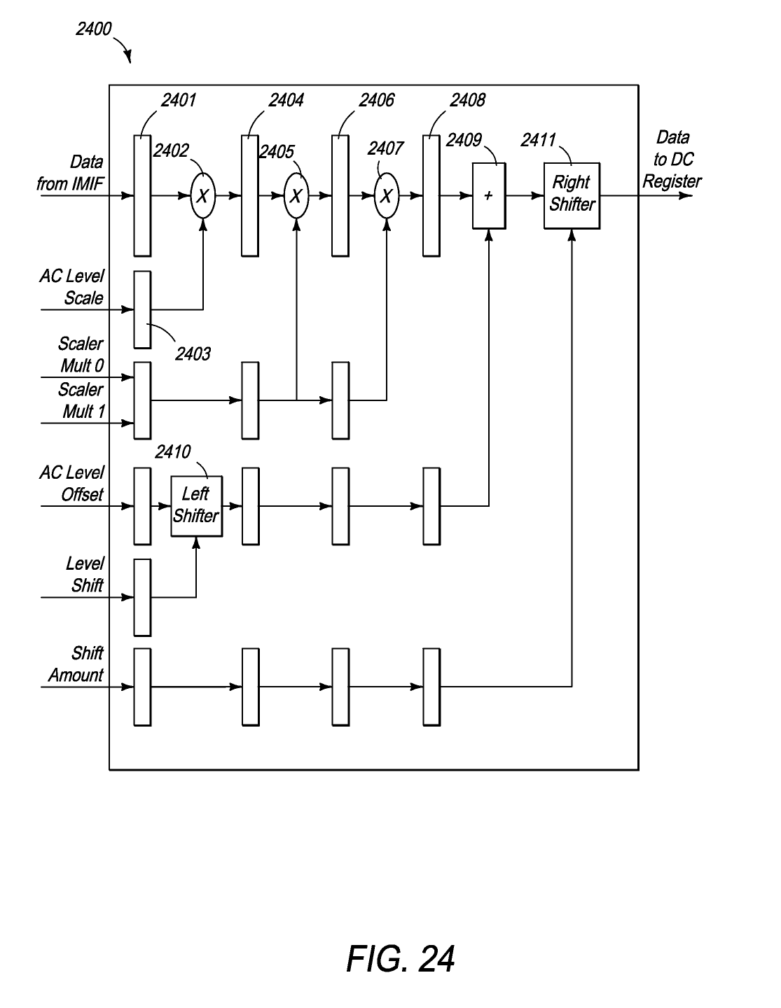

FIG. 24 shows an embodiment of a hardware structure of coefficients scaler 2400 of the present invention. As discussed above with respect to motion compensation, quantization, and DCT/IDCT processing, this hardware structure can be logically programmed to process any number of codecs, standards, or protocols, including H.264, H.263, AVS, VC-1, and/or MPEG, without changing the underlying physical circuitry. Furthermore, this hardware structure is implemented as a functional data path, 115 of FIG. 1.

Referring to FIG. 24, data from internal memory interface (IMIF) is written to register 2401 which is read into first multiplier 2402 that also receives AC level scale data from register 2403. Output of multiplier 2402 is written to register 2404 which is read into second multiplier 2405 that also receives scaler multipliers. Output of multiplier 2405 is written to register 2406 which is read into third multiplier 2407. Scaler multipliers are also input to multiplier 2407. Output from multiplier 2407 is written to register 2408 which is read into adder 2409. Adder 2409 receives AC level offset data that is left shifted by left shifter 2410 by a level shift data. Finally, data from adder 2409 is right shifted by right shifter 2411 by a shift amount for onward communication to DC register.

### Adaptive Deblocking Filter

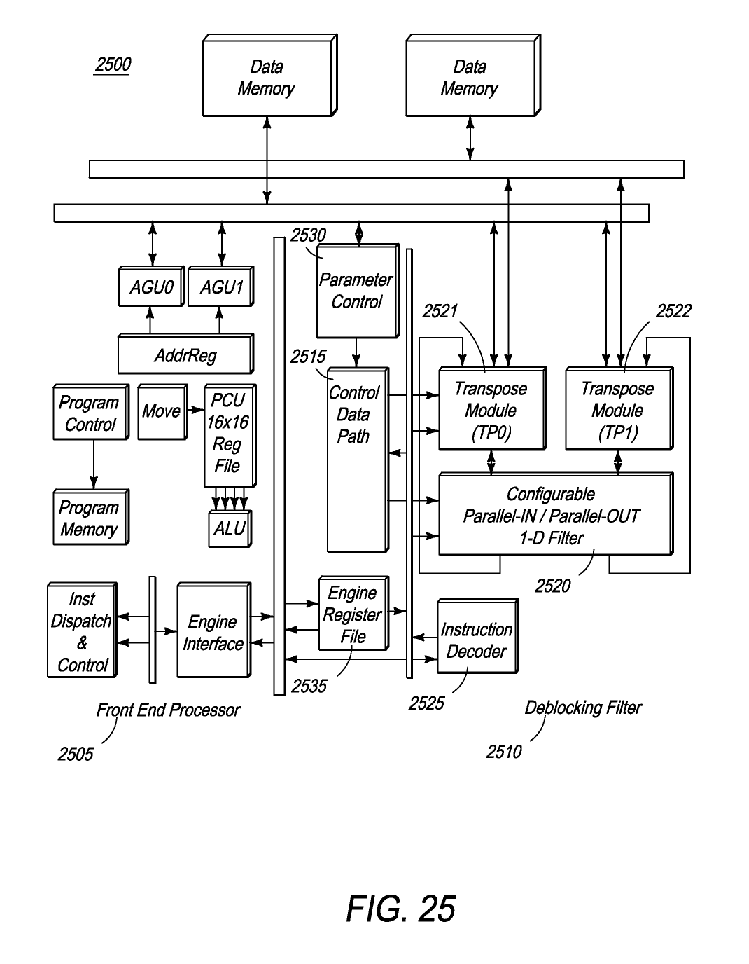

FIG. 25 shows an embodiment of a hardware structure of a deblocking processor 2500 of the present invention. As discussed above with respect to motion compensation, quantization, scaler and DCT/IDCT processing, the hardware structure can be logically programmed to process any number of codecs, standards, or protocols, including H.264, H.263, AVS, VC-1, and/or MPEG, without changing the underlying physical circuitry. Here, the entire front end processor with extendable data path is shown and, in particular, the functional data path is represented by transpose modules 2521, 2522, instruction decoder 2525, and configurable parallel in/out filter 2520.

More specifically, the adaptive Deblocking Filter (hereinafter referred to as DBF) of the present invention comprises Front-End Processor (FEP) 2505 and extendable data path DBF 2510. The extendable data path DBF 2510 uses the Extended Data Path (EDP) of FEP 2505 acting as a co-processor, decoding instructions forwarded by FEP 2505 and executing them in Control Data Path (CDP) 2515 and configurable 1-D filter 2520. The FEP 2505 provides unified programming interface for DBF 2510. The extendable data path DBF 2510 comprises a first Transpose module (T0) 2521 and a second Transpose module (T1) 2522, Control Data Path (CDP) 2515, Configurable Parallel-In/Parallel-Out 1-D Filter 2520, Instruction Decoder 2525, Parameters Register File (PRF) 2530, and Engine Register File (DBFRF) 2535.

In one embodiment, the transpose modules 2521, 2522 are each 8×4 pixel arrays that are used to store and process two adjacent 4×4 blocks, row by row. Modules 2521, 2522 use transpose functions when performing vertical filtering on H-boundaries (horizontal boundaries) and regular functions when performing horizontal filtering on V-boundaries. The two modules are used as ping-pong arrays to speed up the filtering process.

CDP 2515 is used to compute the conditions needed to decide the filtering, and in one embodiment implements H.264/AVC, VC-1, and AVS codecs. It also contains three look-up tables needed to compute different thresholds. 1-D 2520 filter is a two-stage pipelined filter comprising of adders and shifters. Parameter control 2530 comprises all information/parameters related to the current macro block that the DBF 2505 is processing. The information/parameters are provided by content manager (CM). The parameters are used in CDP 2515 for making decision for filtering. Engine Register File 2535 comprises information used from the extended function specific instructions inside DBF 2505.

Table 1 below shows the comparison of the main properties of DBF 2505 for different codecs covered in one embodiment. A preferred picture resolution targeted herein is at least 1080i/p (1080x 1920@30 Hz) High Definition.

TABLE 1
Deblocking filter comparison - H.264/AVC, VC-1, AVS

| | | VC-1 | |
|---|---|---|---|
| | H.264/AVC | Main Profile, Level | AVS |
| Property | Main Profile, Level 4.0 | High | Part 2 |
| Filtering order | V-boundaries followed | H-boundaries followed | V-boundaries followed |
| | by H-boundaries | by V-boundaries | by H-boundaries |
| | Luma then Chroma | Luma then Chroma | Luma then Chroma |
| Filtering edges | no filtering on frame | no filtering on frame | no filtering on frame |
| | boundaries | boundaries | boundaries |
| | 4 × 4, 8 × 8 | 4 × 4, 4 × 8, 8 × 4, 8 × 8 | 8 × 8 |
| Filter Strength | bS = 0, 1, 2, 3, 4 | N/A | bS = 0, 1, 2 |
| Filtering | bS (boundary strength | based on pixels | bS (boundary strength) |
| Parameters | α, β, tCO (thresholds) | information | α, β, C (thresholds) |
| Filtering pixels | up to 6 pixels (3 | up to 2 pixels (1 | up to 4 pixels (2 |
| | left/right) | left/right) | left/right) |
| Filter | fixed by standard - shift | fixed by standard - shift | fixed by standard - shift |
| implementation | & add operations | & add operations | & add operations |
| Filter type | conditional | conditional, based on | conditional |
| | | 3rd pixel | |

The architecture of the adaptive DBF of the present invention can take any block size and transpose as necessary in order to abide by the filtering requirements of a specific codec. To achieve this, the architecture first organizes the memory in a manner that can support any of the various codecs' approaches to doing DBF. Specifically, the memory organization ensures that whatever data is needed from neighbor blocks (or as a result of processing that was just completed) is readily available. Persons of ordinary skill in the art would appreciate that the actual filtering algorithm is defined by the codec being used, the use of the transpose function is defined by the codec being used and the size/number of blocks is defined by the codec being used.

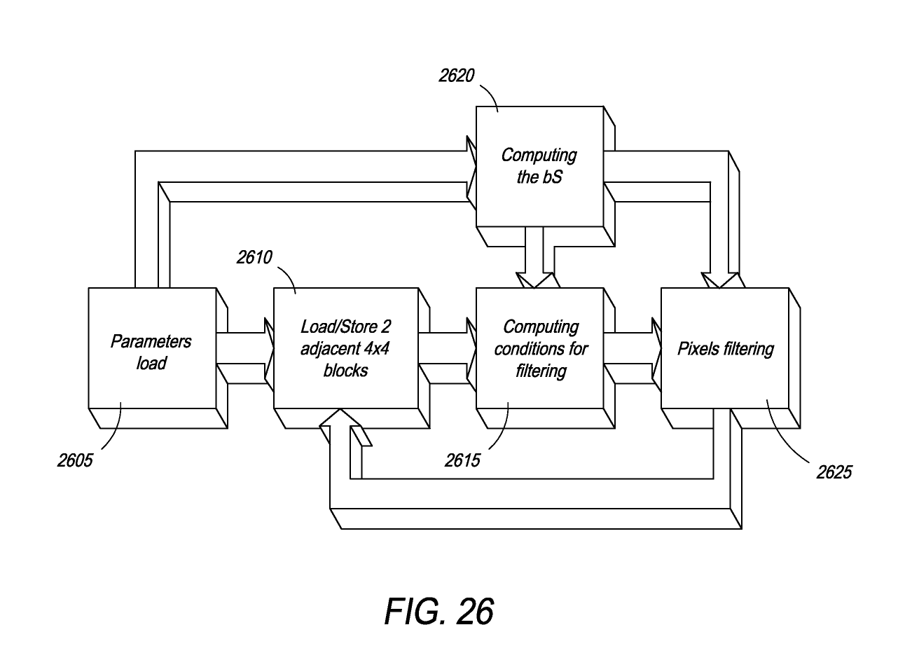

FIG. 26 shows the data path stages of the DBF in accordance with one embodiment of the present invention. In the first stage, all parameters related to a currently processed macro block (MB) and the neighboring macro blocks (MB) are preloaded 2605 in registers. The second stage is Load/Store process 2610. Since one embodiment uses 2 ping-pong transpose modules and there are two IMIF channels, the next 4×4 blocks can be loaded and the already filtered 4×4 blocks are stored. The third stage is the control data path (CDP) 2615. In this phase, the computing and pipelining of all the control signals needed for making decision whether to filter or not the block level pixels is performed. The CDP pipelines have to be synchronized with the filter data path. Therefore before this stage the boundary strength (bS) related to each 4×4 sub-block for certain codecs, such as H.264, is computed as depicted in box 2620. The fourth stage is the actual pixels filtering 2625. In this stage 1-D Parallel-In/Parallel-Out filter are used with two pipeline stages. The filter input/output data are the two transpose modules (2521, 2522 of FIG. 25), which allow filtering of 2 8×4 pixel blocks (or total 64 pixels) in just 10 cycles.

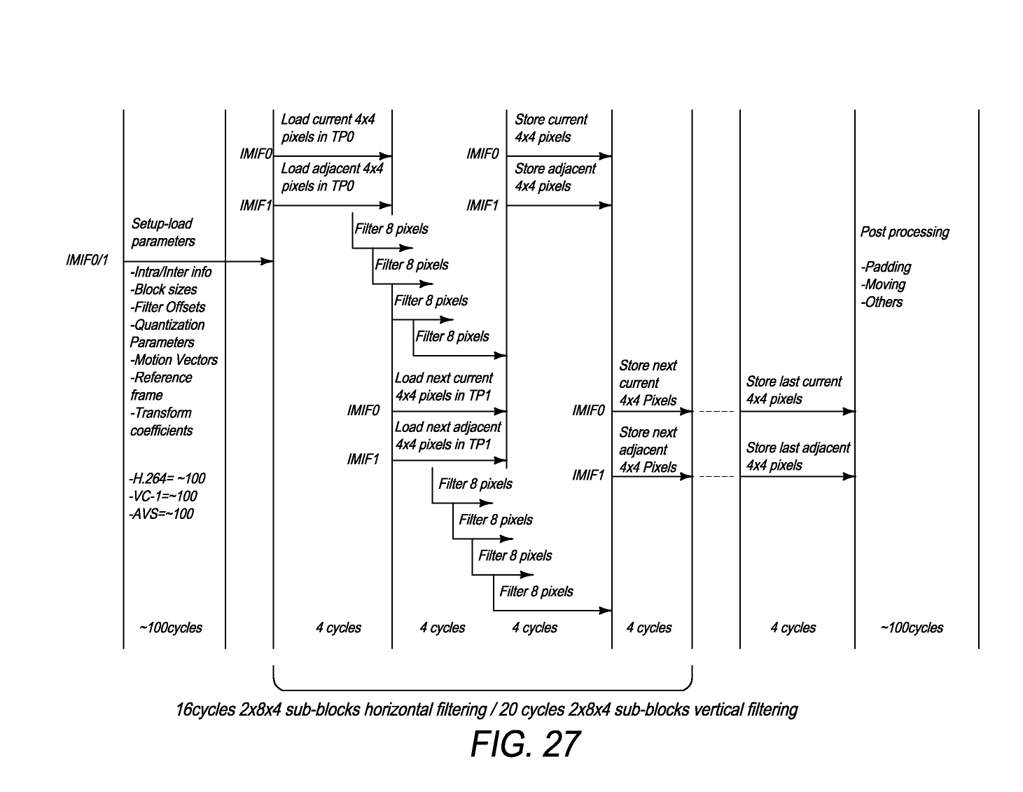

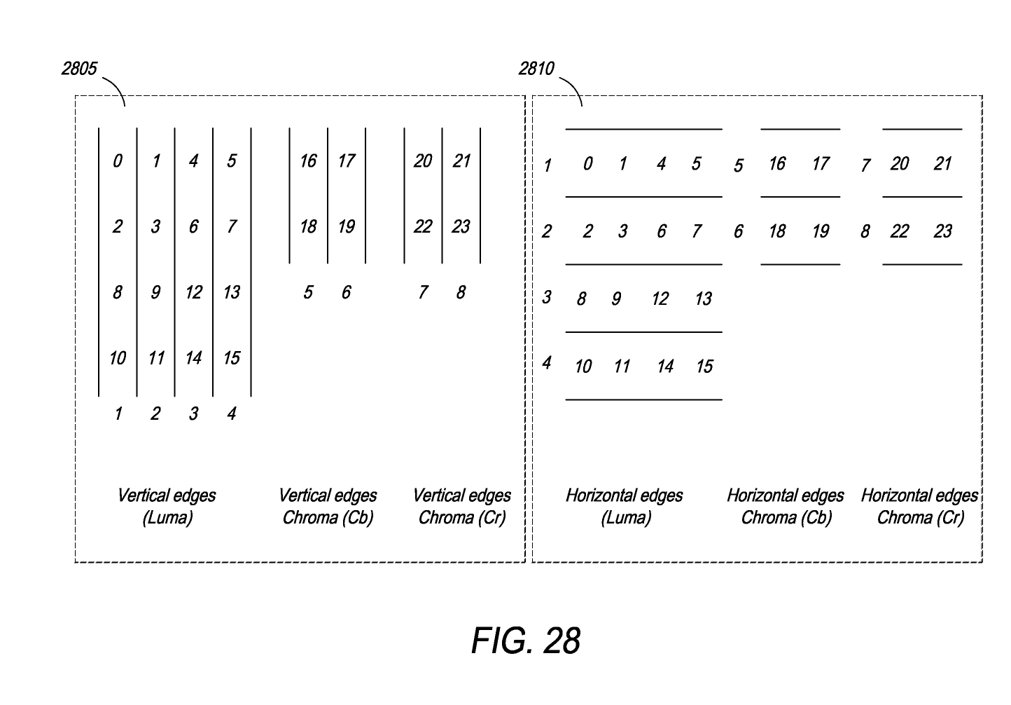

The data path pipeline stages are shown in FIG. 27. In one embodiment, the requirement of the performance of the DBF is given as:

Max Requirement

1080i/p @ 30 Hz(30 frames/sec),

[symbol]

((1080+offset)*1920)/(16*16)=(1088*1920)/256=8160 MB/frame

[symbol]

1/(30*8160)=4.085*1E−6=4085 ns/frame

[symbol]

4085 ns/(1/235 MHz)=4085 ns/4.26 ns=958.92 clock cycles≈956 clock cycles

Based on FIG. 27, an actual performance of the DBF in clock cycles can be calculated as follows:

Actual Performance

100 cycles+16(HLuma)*8 cycles+4(HCb)*8 cycles+4(HCr)*8 cycles 24+16(VLuma)*10 cycles+4(VCb)*10 cycles+4(VCr)*10 cycles+100 cycles+200cyckles=832 cycles

The calculations above show that one should fit within the target performance requirements to process one macro block (MB).

The deblocking filtering is done on a macro block basis, with macro blocks being processed in raster-scan order throughout the picture frame. Each MB contains 16×16 pixels and the block size for motion compensation can be further partitioned to 4×4 (the smallest block size for inter prediction). H.264/AVC and VC-1 can have 4×4, 8×4, 4×8, and 8×8 block sizes, and AVS can have only 8×8 block size. Persons of ordinary skill in the art would realize that mixed block sizes within the MB boundary can also be had.

In order to ensure a match in the filtering process between decoder and encoder, the filtering preferably follows a pre-defined order. One embodiment of the filtering order for H.264/AVC is shown in FIG. 28. As shown in blocks 2805, for each luma, the left-most edge is filtered first, followed from left to right by the next vertical edges that are internal to the macro block. The same order then applies for both chroma (Cb and Cr). This is called horizontal filtering on vertical boundaries (V-boundaries). Next step is vertical filtering on horizontal boundaries (H-boundaries) as shown in blocks 2810. For luma, the top-most edge is filtered first, followed from top to bottom by the next horizontal edges that are internal to the macro block. The same order then applies for both chroma.

The filtering process also affects the boundaries of the already reconstructed macro blocks above and to the left of the current macro block. In one embodiment, frame boundaries are not filtered.

Similarly the same order applies for macro blocks in AVS but on the 8×8 boundary. The order of the internal filtered edges is the same as in H.264. In VC-1 the filtering ordering is different. For I, B, and BI pictures filtering is performed on all 8×8 boundaries, where for P pictures filtering could be performed on 4×4, 4×8, 8×4, and 8×8 boundaries. For P picture this is the filtering order. First all blocks or sub-blocks that have horizontal boundaries along the 8th, 16th, 24th, etc. horizontal lines are filtered. Next all sub-blocks that have horizontal boundaries along the 4th, 12th, 20th, etc. horizontal lines are filtered. Next all sub-blocks that have vertical boundaries along the 8th, 16th, 24th, etc. vertical lines are filtered. Last, all sub-blocks that have vertical boundaries along the 4th, 12th, 20th, etc. vertical lines are filtered.

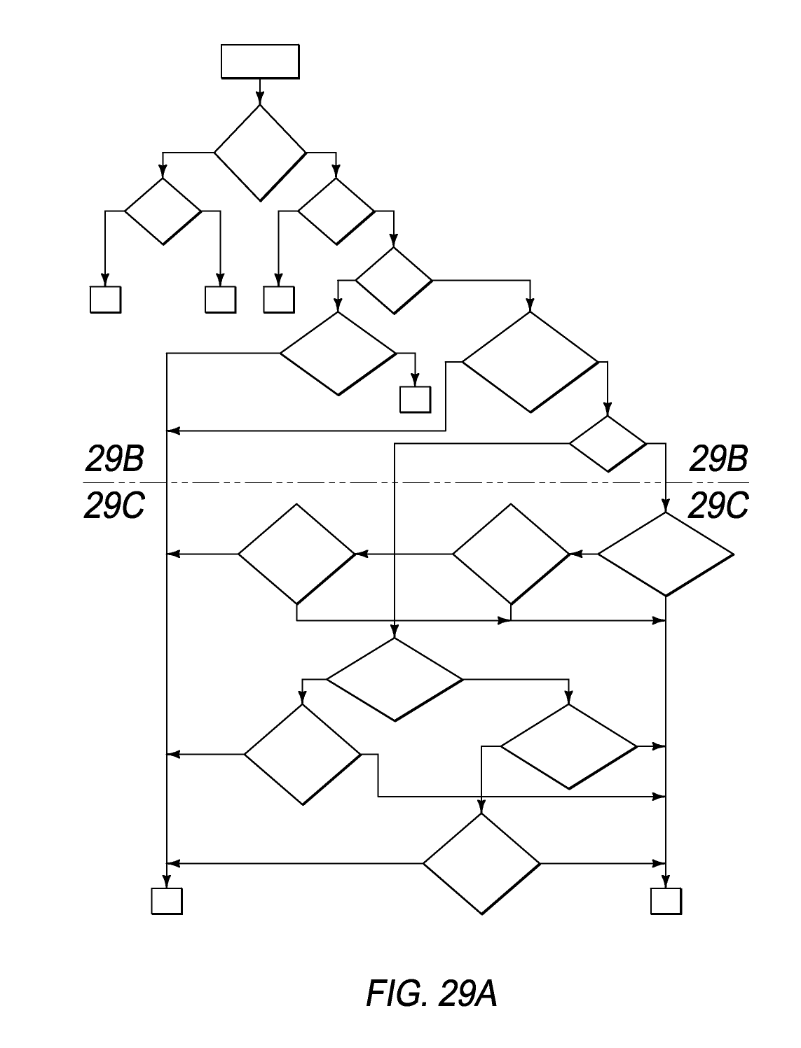

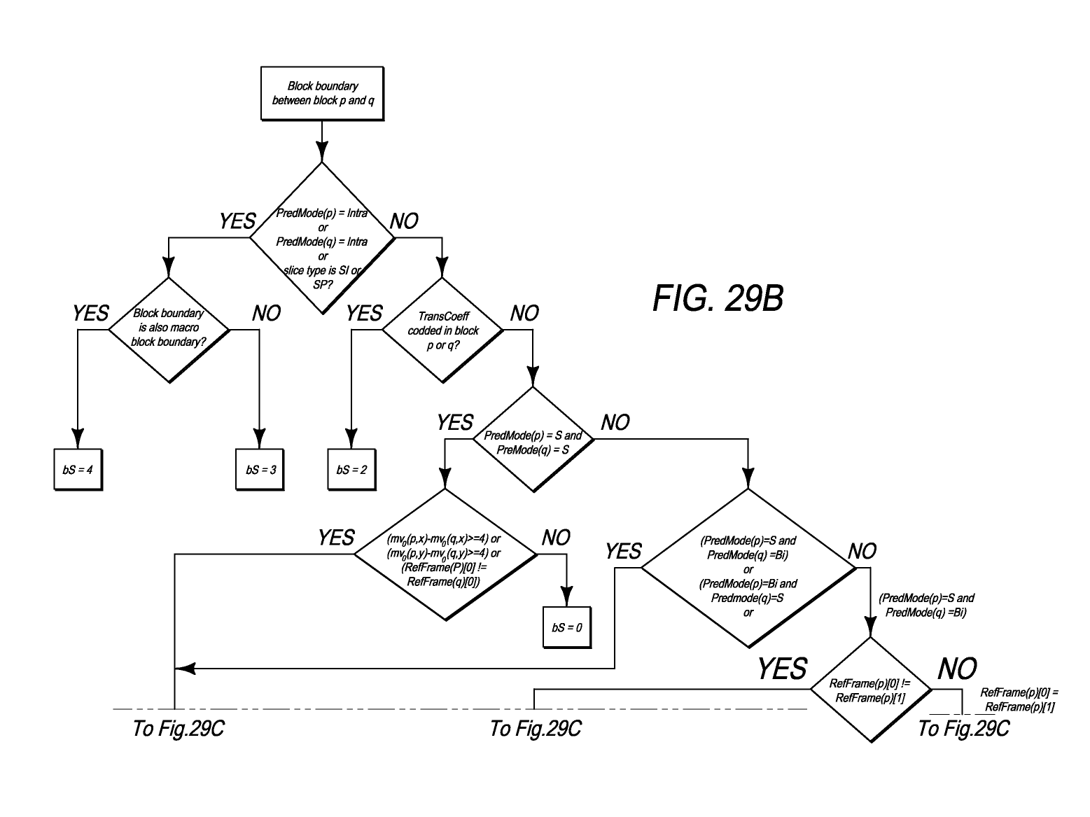

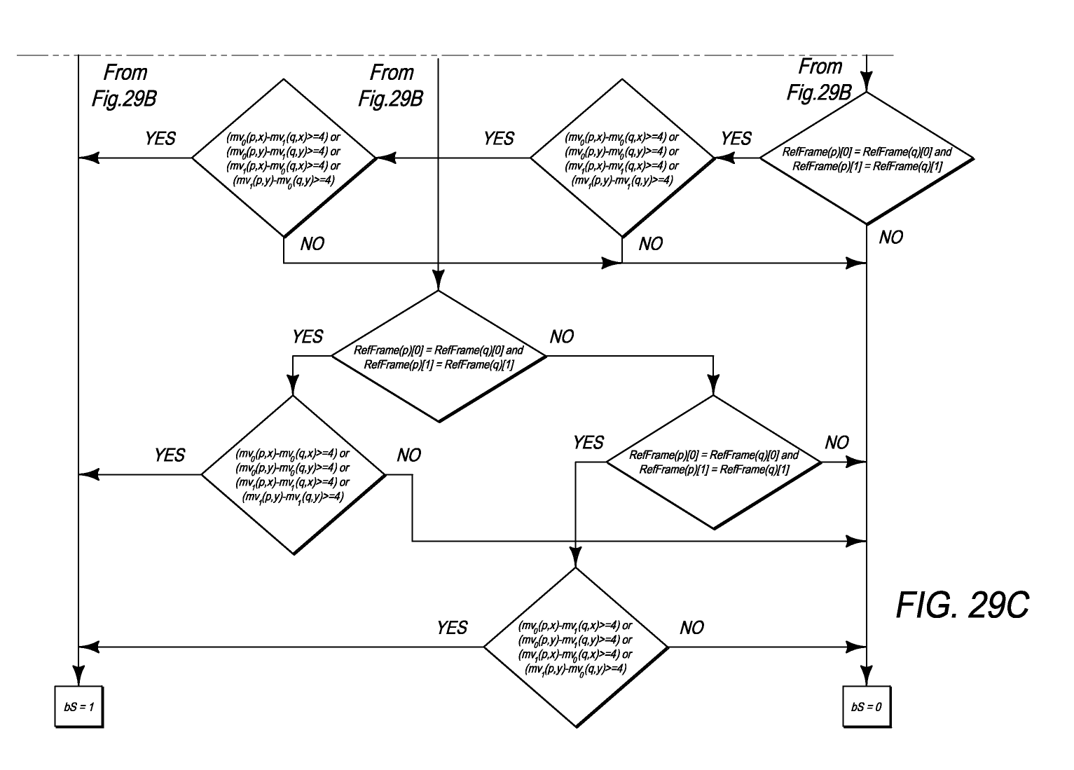

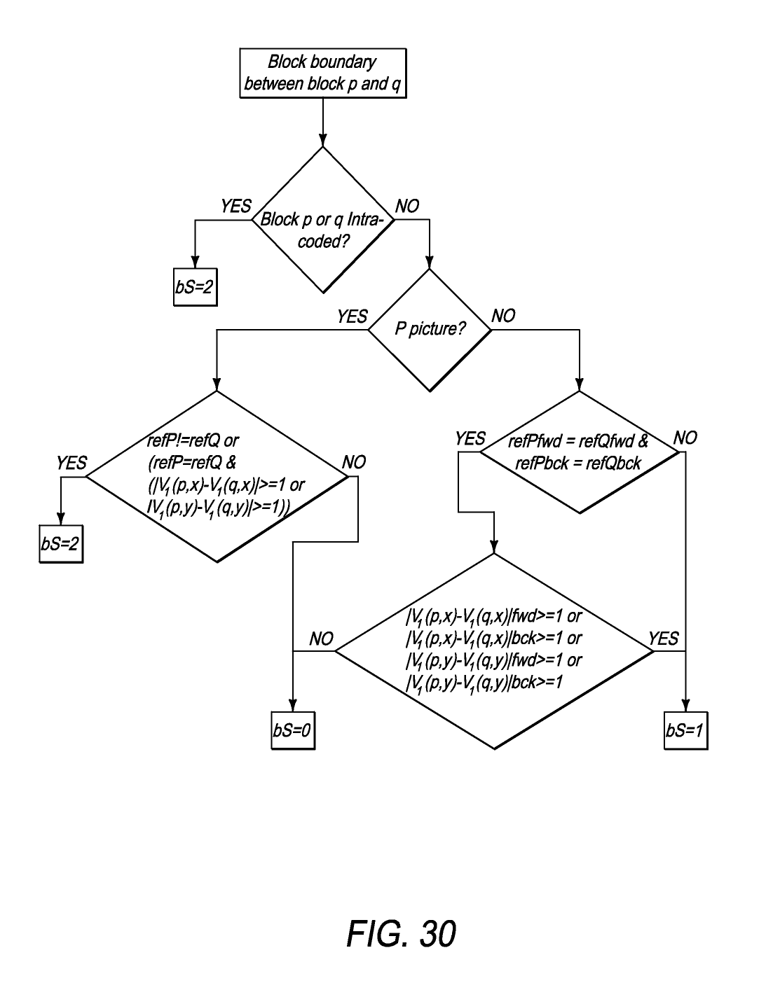

In H.264/AVC for each boundary between adjacent luma blocks a “Boundary Strength” parameter bS is assigned as shown on FIG. 29. bS=4 is the strongest filtering, while bS=0 means no filtering performed. The flow chart of FIG. 29 shows that the strongest blocking artifacts are mainly due to Intra and prediction error coding and the smaller artifacts are caused by block motion compensation. The bS values for chroma are the same as the corresponding luma bS. In AVS, bS is assigned values of 0, 1, or 2 as shown in FIG. 30. There is no boundary strength parameter in VC-1 codec.

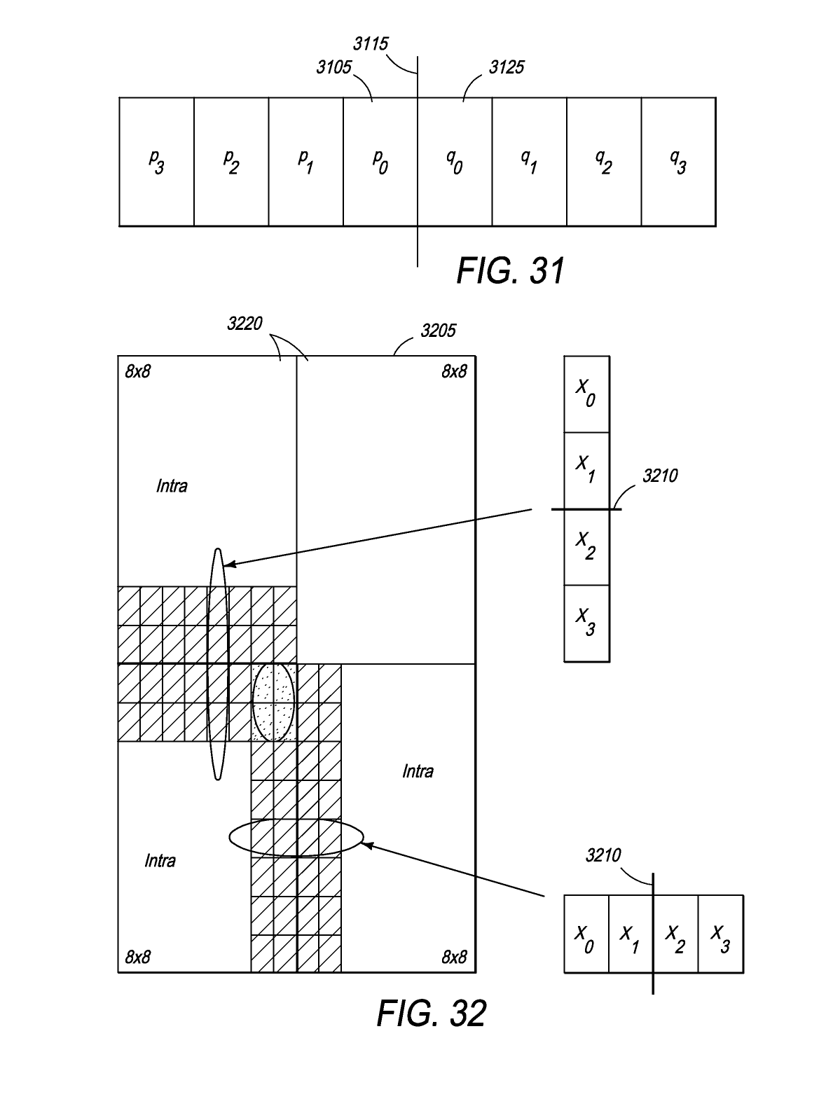

To preserve image sharpness, the true edges need to be left unfiltered as much as possible while filtering artificial edges to reduce their visibility. For that purpose the deblocking filtering is applied to a line of 8 samples (p3, p2, p1, p0, q0, q1, q2, q3) of two adjacent blocks in any direction, with the boundary line 3115 between p0 3105 and q0 3125 as shown in FIG. 31.

Filtering does not take place for edges with bS equal to zero (bS=0). For edges with nonzero bS value, a pair of quantization-dependent threshold parameters, referred to as α and β, are used in the content activity check that determines whether each set of 8 samples is filtered. In one embodiment, sets of samples across this edge are only filtered if the following condition is true:

filterFlag=(bS≠0 &&|p₀−q₀|<α &&|p₁−p₀|<β &&|q₁−q₀|<β) (1-1)

Up to 3 pixels on each side of the boundary can be filtered in H.264/AVC. The values of the thresholds a and 0 are dependent on the average value of quantization parameter (qPp and qPq) for the two blocks as well as on a pair of index offsets “FilterOffsetA” and “FilterOffsetB” that may be transmitted in the slice header for the purpose of modifying the characteristics of the filter.

### VC-1 Overlap Transform Process

Overlap transform or smoothing is performed across the edges of two neighboring Intra blocks for both luma and chroma channels. This process is performed subsequent to decoding the frame and prior to deblocking filter. Overlap transforms are modified block based transforms that exchange information across the block boundary. Overlap smoothing is performed on the edges of 8×8 blocks that separate two Intra blocks.

The overlap smoothing is performed on the un-clipped 10 bit/pel reconstructed data. This is important because the overlap function can result in range expansion beyond the 8 bit/pel range.

FIG. 32 shows portion of a P frame 3205 with Intra blocks 3220. The edge 3210 between the Intra blocks 3220 is filtered by applying the overlap transform function. Overlap smoothing is applied to two pixels on either side of the boundary.

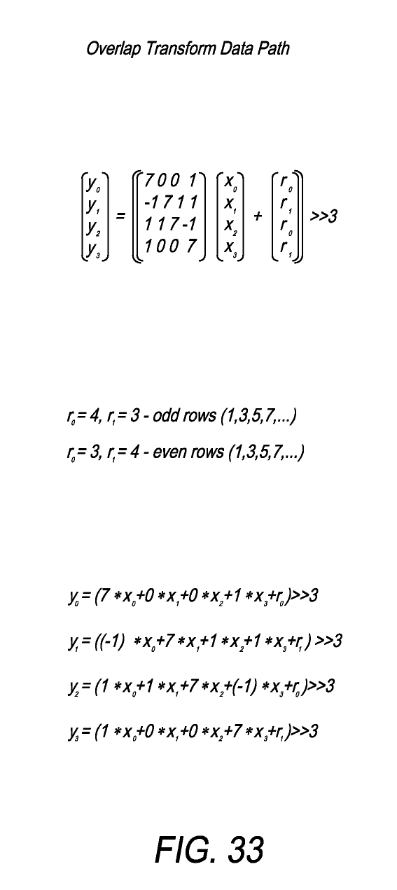

Vertical edges are filtered first followed by the horizontal edges. FIG. 33 shows the equations comprising the actual overlap filter function. The input pixels are (x₀, x₁, x₂, x₃), r₀ and r₁ are rounding parameters, and the filtered pixels are (y₀, y₁, y₂, y₃). The pixels in the 2×2 corner are filtered in both directions. First vertical edge filtering is performed, followed by horizontal edge filtering. For these pixels, the intermediate result after vertical filtering is retained to the full precision of 11 bits/pel.

### VC-1 Filtering Process

For I, B, and BI pictures the filtering is performed at all 8×8 block boundaries (luma, Cb or Cr plane). For P pictures the blocks may be Intra or Intra-coded. If the blocks are Intra-coded filtering is performed on 8×8 boundaries, and if the blocks are Inter-coded filtering is performed on 4×4, 4×8, 8×4, and 8×8 boundaries.

The pixels for filtering are divided into 4×4 segments. In each segment the 3rd row is always filtered first. The result of this filtering determines if the other 3 rows will be filtered or not. The Boolean value of ‘filter_other_{—}3_pixels’ defines whether the remaining 3 rows in the segment are also to be filtered. If ‘filter_other_{—}3_pixels’==TRUE, then they are filtered, otherwise they are not filtered and the filtering operation proceeds to the next 4×4 pixel segment.

In VC-1 up to one pixel on each side of the boundary can be filtered. The following four exceptions are described in the Main Profile deblocking for P picture:
1. If the first macro block in the frame is Intra-coded or if the upper left luma block of the first macro block in the frame is Intra-coded then the entire 8-sample top and left boundary are filtered.
2. The criteria used to decide whether to filter the left boundary of block 3 (the lower-right luma block) is derived from the motion vector status of blocks 2 and 3 as intended but the coded-block status and sub-block patterns of blocks 1 and 3 are used instead.
3. If the current block was coded using the 4×4 transform then both the 8 pixel top boundary and the 8 pixel left boundary is filtered regardless of the sub-block pattern of any of the blocks. If the current block was coded using the 8×8, 8×4 or 4×8 transform and the block above was coded using the 4×4 transform then the 8 pixel top boundary is filtered regardless of the sub-block pattern of any of the blocks. If the current block was coded using the 8×8, 8×4 or 4×8 transform and the block to the left was coded using the 4×4 transform then the 8 pixel left boundary is filtered regardless of the sub-block pattern of any of the blocks.
4. The decision criteria for filtering color-difference block boundaries uses the range-limited color-difference motion vectors (iCMvXComp and iCMvYComp).

### Motion Estimation

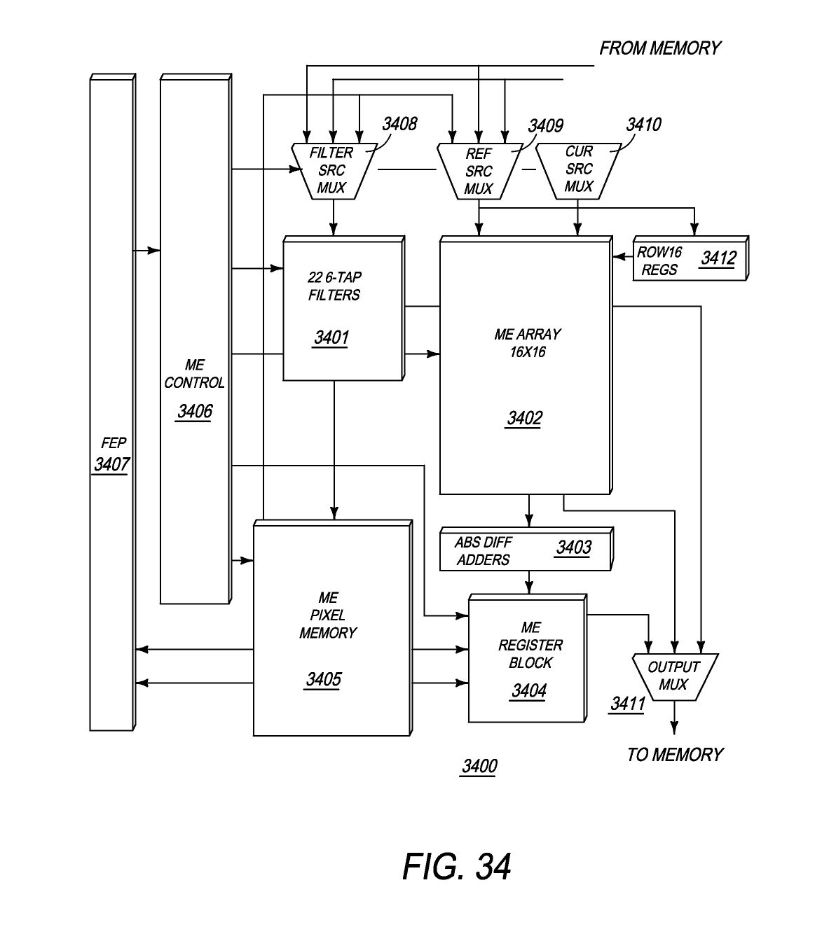

FIG. 34 shows an embodiment of a hardware structure of a motion estimation processor 2500 of the present invention. As discussed above with respect to motion compensation, quantization, scaler, deblocking, and DCT/IDCT processing, the hardware structure can be logically programmed to process any number of codecs, standards, or protocols, including H.264, H.263, AVS, VC-1, and/or MPEG, without changing the underlying physical circuitry. Here, the front end processor with extendable data path is shown and, in particular, the functional data path is represented by 22 6-tap filters 3401, ME array3402, ME register block 3404, and ME pixel memory 3405. In one embodiment, this motion estimation processor that can operate at 250 MHz, or less, and be programmed to encode and decode data in accordance with MPEG 2, MPEG 4, H.264, AVS, and/or VC-1.

Referring to FIG. 34, a block diagram of an exemplary overall architecture 3400 of the motion estimation engine of present invention is shown. The system 3400 comprises twenty two 6-tap filters 3401 that can be used to interpolate the image signal. The filters 3401 are designed to have a unified structure in order to implement all kinds of codecs in both vertical and horizontal directions. The system also comprises a motion estimation array (ME Array) 3402 that is 16×16 in size, and has a structural design such that it is capable of moving data in three directions instead of only two, as is the case with currently available ME arrays. Data from the ME Array 3402 is processed by a set of absolute difference adders 3403 and stored in the ME Register Block 3404.

The ME engine 3400 is provided with a dedicated pixel memory 3405, with different address mapping for different interfaces such as ME Filter 3401 and ME Array 3402 in the ME engine, as well as for related functional processing units of a media processing system, such as motion compensation (MC) and Debug. In one embodiment, the ME pixel memory 3405 comprises four vertical banks with the provision of multiple simultaneous writes across banks by means of address aliasing across the banks.

The ME Control block 3406 contains the circuitry and logic for controlling and coordinating the operation of various blocks in the ME engine 3400. It also interfaces with the Front End processor (FEP) 3407 which runs the firmware to control various functional processing units in a media processing system.

Data access and writes to the memory are facilitated through a set of four multiplexers (MUX) in the ME engine. While the Filter SRC MUX 3408 and REF SRC MUX 3409 interface with the pixel memory 3405 as well as external memory, the CUR SRC MUX 3410 is used to receive data from external memory and the Output Mux 3411 is used when data is to be written to the external memory.

During motion estimation processing, in order to progress through the frame, the selected window shifts down a pixel row for every clock cycle. Therefore, the ME Array 3402 is provided with a set of registers 3412 called Row 16 registers, which are used to store pixel data corresponding to the last row.

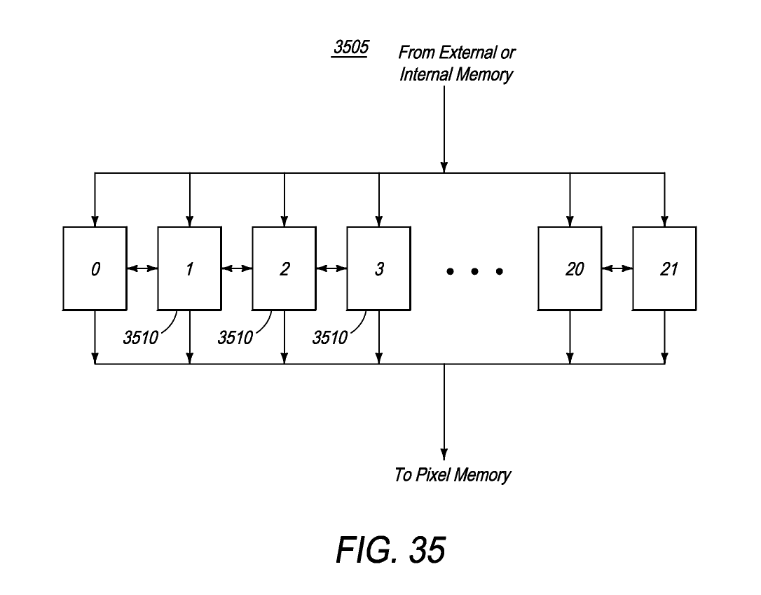

Referring to FIG. 35, the arrangement of the 6-tap filters 3510 is shown. As previously mentioned, the ME engine comprises twenty two 6-tap filters which have a unified structure that can process various kinds of codecs with out changes to the underlying circuitry. Further, the same filter structure can be used for processing in both horizontal and vertical directions. Moreover, the filters are designed such that the coefficients and rounding values are programmable, in order to support future codecs also. Because of this unique design, the filter structure enables novel applications for the motion estimation engine of the present invention. For example, it is not possible to efficiently implement a 250 MHz multiple codec with existing systems. A 3 GHz chip may be used for the purpose, but at the cost of a large amount of processing power. Further, older systems are not fully programmable to work with newer standards such as MPEG 2/4, H.264, AVS, and VC-1. The novel design of the filters used in the motion estimation engine of the present invention allows implementation of a 250 MHz, multi-codec system, which not only supports the old as well as new standards, but is also programmable to support future codec standards.

The filters 3510 are designed to support loads from both external memory and internal memory 3505, and are capable of the following filter operation sizes:
One 16-wide
One 8-wide
Two simultaneous 8-wide

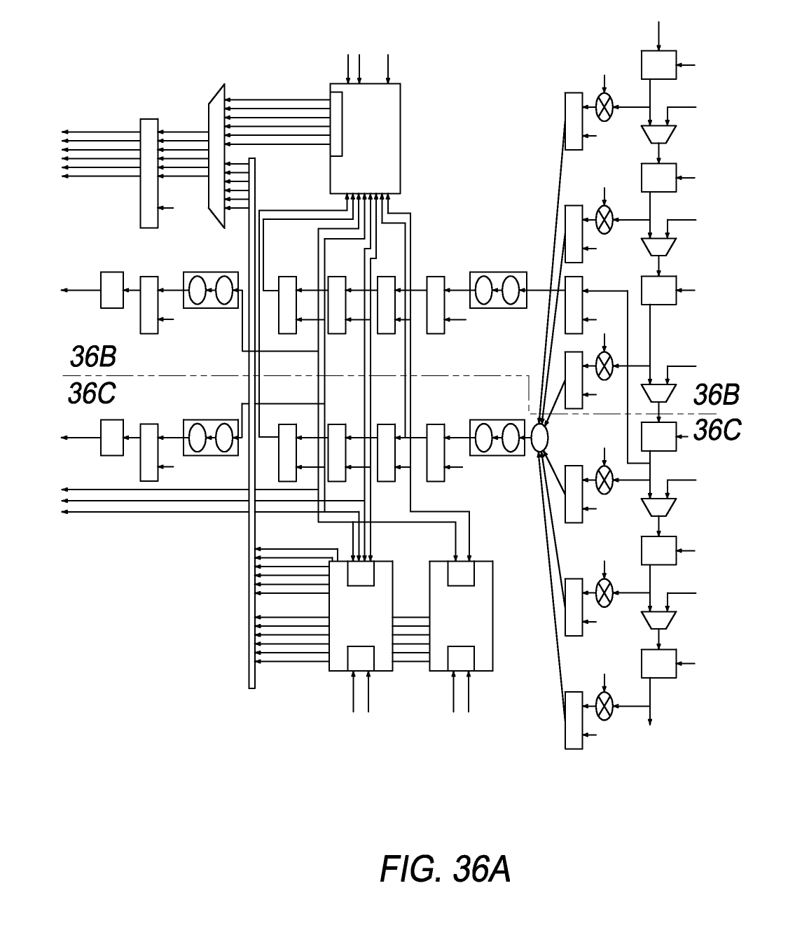

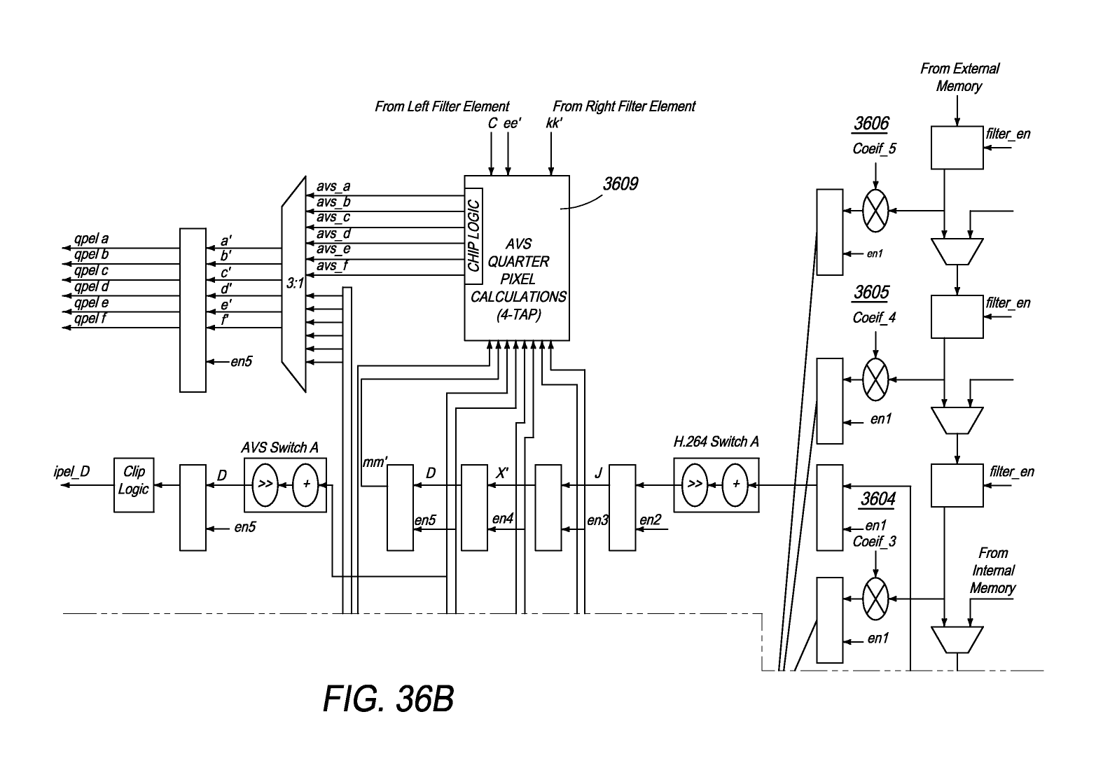

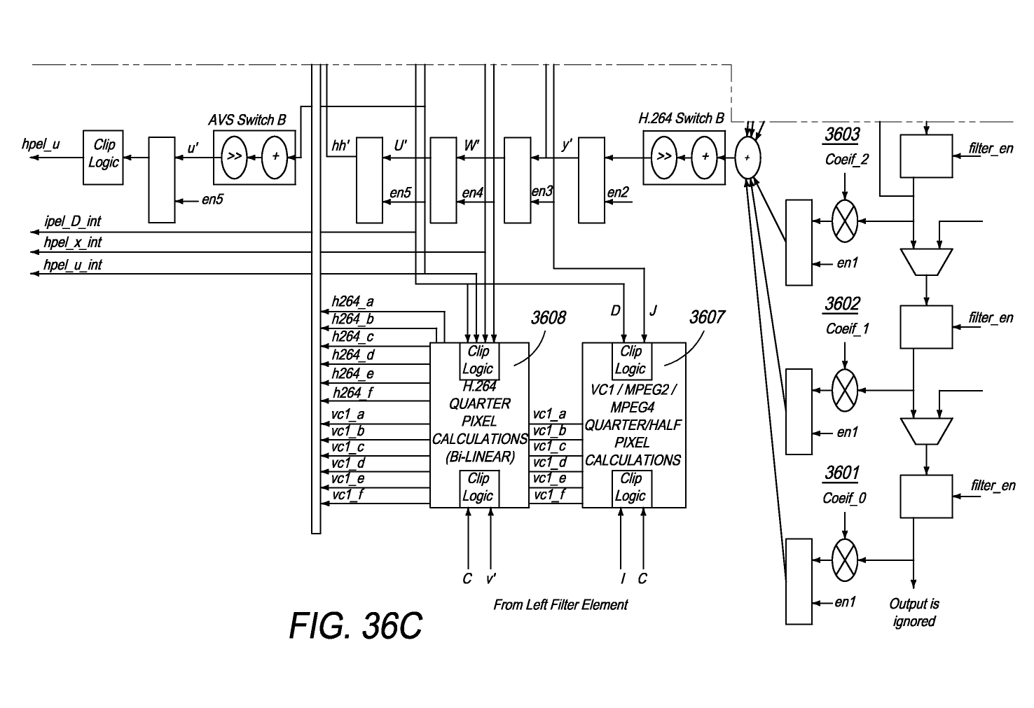

The integrated circuit details for the filter design are illustrated in FIG. 36. Referring to FIG. 36, each of the twenty 6-tap filters, 3601-3606, makes use of six coefficients—coeff_0 4701 through coeff_5 4706. These coefficient values are used for half and quarter pixel calculations, in accordance with various coding standards. The filter circuit comprises chip logic for quarter/half pixel calculations for VC1/MPEG2/MPEG4 standards 3607 and for bilinear quarter pixel calculations for H.264 standard 3608. Chip logic 3609 is also provided for quarter pixel calculations for AVS standard. These calculations are 4-tap, and hence make use of only four coefficients—coeff_0 4701 through coeff_3 4704.

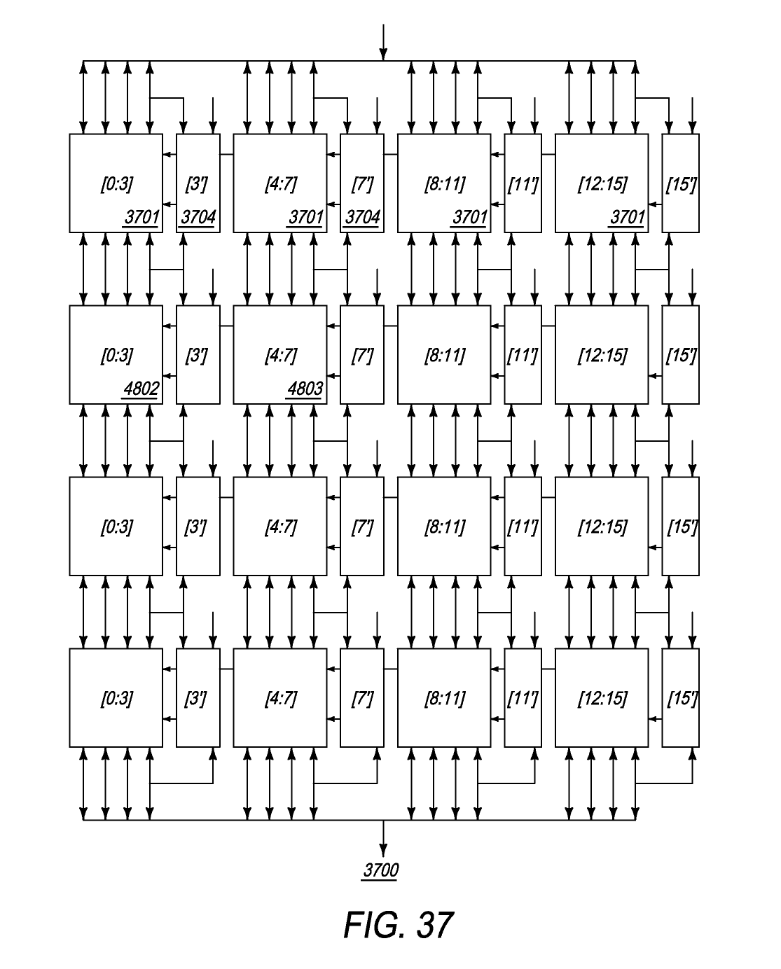

In existing motion estimation systems, the structure of the ME array is designed to move data in two directions, and it takes 16 cycles to load a 16×16 array. However, in the motion estimation system of the present invention, the 16×16 motion estimation array is designed such that it is moves data in 3 directions. An exemplary structure of such an ME Array is illustrated in FIG. 37. Referring to FIG. 37, the array 3700 is provided with a horizontal banking structure. The horizontal banks 3701 help inject data in between the rows of the array, to save firmware cycles during data loads. This reduces the number of cycles required for data loads from 16 cycles to 4 cycles and cuts down the array load time by 75%.

Further, the vertical intermediate columns of the array 3700, illustrated as [0:3] 4802, [4:7] 4803 and so on, help to save additional data by avoiding new loads for an adjacent coordinate. Another novel feature of the array structure of FIG. 37 is the provision of ‘ghost columns’ 3704 after every fourth array column, which support partial searches.

The novel array structure of the present invention allows for data movement in three directions—top, down and left. The array structure is capable of supporting loads from external memory as well as internal memory, and supports the following search sizes:
One 16×16
One 8×8
One 4×4
Two 8×8 or four simultaneous 8×8 searches

The array structure also permits optional data flipping on the byte boundary for write operations. The advantages and features of the ME array structure will become more clear when described with reference to the operation of motion estimation engine of the present invention in the forthcoming sections.

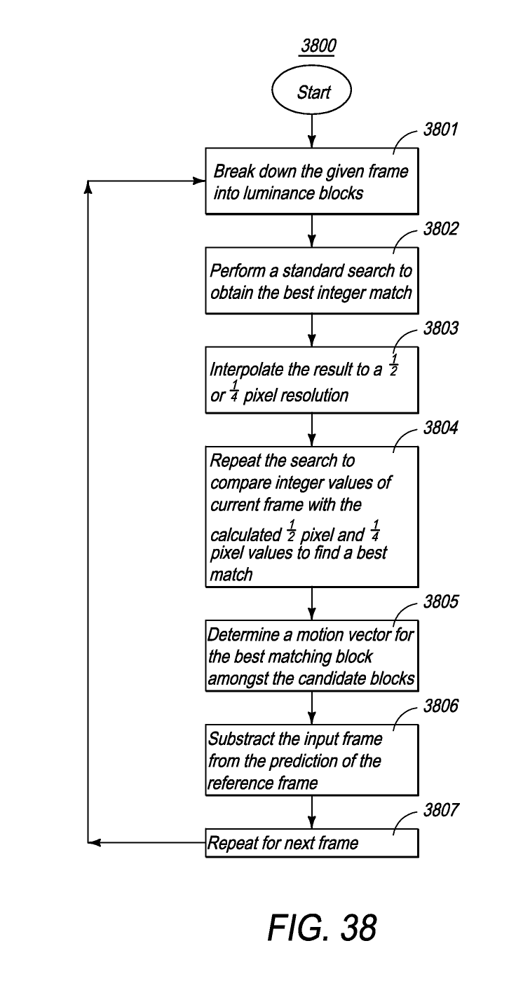

It is known in the art that each frame in an image signal is divided into two kinds of blocks, known as luminance and chrominance blocks, as discussed above. For coding efficiency, motion estimation is applied to the luminance block. FIG. 38 illustrates the steps in the process of motion estimation by means of a flow chart 3800. Referring to FIG. 38, a given frame is first broken down into luminance blocks, as shown in step 3801. In subsequent steps, each luminance block is matched against candidate blocks in a search area on the reference frame. This forms the core of motion estimation, and therefore, one of the major functions of a motion estimation engine is to efficiently conduct a search to match blocks in a present frame against the reference frame. In this, the challenge for any motion estimation algorithm is achieving a sufficiently good match. The motion estimation method as used with the present invention starts with the best integer match, which is obtained in a standard search. This is shown in step 3802. Then, in order to obtain as close a match as possible, the results of the best integer match are filtered or interpolated to a ½ or ¼ pixel resolution, as shown in step 3803. Thereafter, the search is repeated wherein the integer values of the current frame are compared with the calculated ½ pixel and ¼ pixel values, as shown in step 3804. This lends more granularity to the search for finding the best match.

After the best match is found amongst the candidate blocks, a motion vector for the best matching block is determined. This is shown in step 3805. The motion vector represents the displacement of the matched block to the present frame.

Thereafter, the input frame is subtracted from the prediction of the reference frame, as shown in step 3806. This allows just the motion vector and the resulting error to be transmitted instead of the original luminance block. This process of motion estimation is repeated for all the frames in the image signal, as illustrated in step 3807. As a result of using motion estimation, inter-frame redundancy is reduced, thereby achieving data compression.

On the decoder side, a given frame is rebuilt by adding the difference signal from the received data to the reference frames. The addition reproduces the present frame.

Functionally, motion estimation uses a specific window size, such as 8×8 or 16×16 pixels for example, and the current window is move around to obtain motion estimation for the entire block. Thus, a motion estimation algorithm needs to be exhaustive, covering all the pixels across the block. For this purpose, an algorithm can use a larger window size; however it comes at the cost of sacrificing clock cycles. The motion estimation engine of the present invention implements a unique method of efficiently moving the search window around, making use of the novel ME Array structure (as described previously). According to this method:

1. Using the reference frame, a set of pixels corresponding to the chosen window size is loaded in the ME Array. The beginning point is the upper left corner of the frame.

2. At the same time when a set of pixels corresponding to the window is loaded, a “ghost column” to the right of the window is also loaded. As previously mentioned, the ME Array contains a ghost column after every fourth array column. That ghost column includes pixels to the right of the window and keeps them ready for processing when the window moves one pixel to the right.

3. To move around the frame, the window moves down by one pixel row every clock cycle. Each time it moves down, pixels at the top of the window move out of the array and new pixels at the bottom move in. This continues until the bottom of the frame is reached. Once the bottom is reached, the window moves one column to the right, thereby including the pixels in the ghost column.

4. The process is repeated, except that this time the window moves from bottom to up, that is, the frame moves down. On reaching the top of the frame, the window shifts to the right again, and again makes use of the ghost column.

Thus, the ghost column acts to significantly minimize loads, regardless of what window size is chosen.

As previously disclosed, the motion estimation involves identifying the best match between a current frame and a reference frame. To do so, ME engine applies a window to the reference frame, extracts each pixel value into an array and, at each processing element in the array, performs a calculation to determine the sum of the differences. The processing element contains arithmetic units and two registers to hold the current pixel and reference pixel values. Since the window moves by a pixel row every clock cycle to progress through the frame, and shifts to the right on reaching the end of a column, therefore, to perform this integer search, only one clock cycle is needed to load the data required to perform an analysis for a search point.

When doing an integer search, a motion estimation method may stop on obtaining an initial match. However, in the motion estimation method of the present invention, when the best match is found in a frame, the corresponding window is captured and sent to a filter to calculate the ½ pixel (½ pel) and ¼ pixel (¼ pel) values. This is referred to as interpolation. Thus, on finding the best integer match, all the required data around the search location downloaded and interpolation is performed around it. At the same time reference information for carrying out the next search also needs to be downloaded. The architecture of the motion estimation system of the present invention enables performing in searches and interpolation concurrently. That is, data for search can be loaded at the same time when data for filtering is loaded. For implementing this parallel operation, the FEP executes two instructions—one to perform filtering and one for carrying out searching. The memory structure of the motion estimation engine of the present invention is also designed for allow simultaneous loading of data, thereby enabling parallel searching and interpolate/filtering.

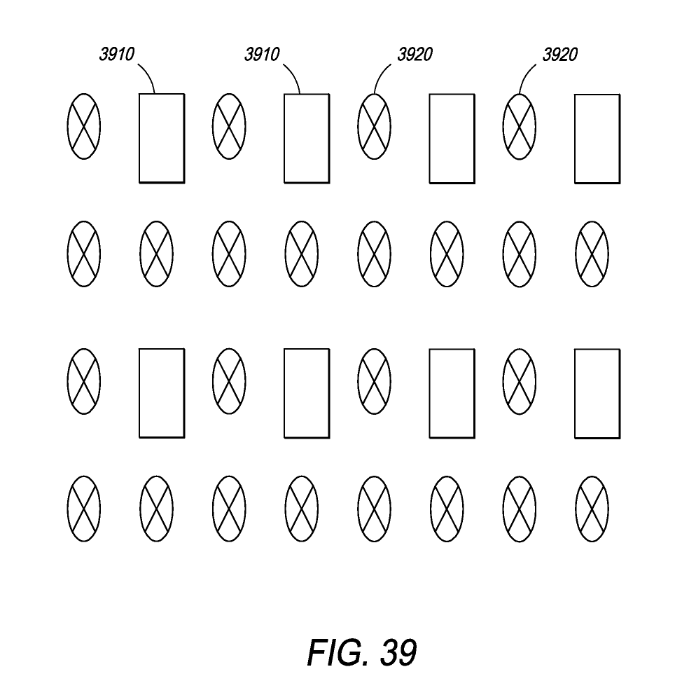

FIG. 39 is an illustration of ½ pixel values and integer pixel values in a given window. Referring to FIG. 39, the squares 3910 represent integer pixels, and the circles 3920 around the integer squares represent the half pixel values. Since the purpose of calculating the ½ and ¼ pixels is to achieve more granularity in the search for the best match, therefore the search process that was conducted on the integer pixel values needs to be repeated with the calculated ½ or ¼ pixel values. It may be however noted, that instead of comparing the integer values of the current frame with the integer values of the reference frame, the repeat search involves comparing the integer values of the current frame with the calculated ½ pixel and ¼ pixel values. This calculation process is different than the integer calculation and as a result, requires a different kind of memory structure to minimize the clock cycles used to load data.

Specifically, with the integer search, every time the window is moved by a row or a column, data for the new row or column is loaded in, while data from the other rows or columns is retained. This is because during integer search, a majority of the rows or columns are reused in new calculations in subsequent processing steps. This automatically lowers the number of clock cycles required per search point to just one. However, for ½ pixel or ¼ pixel search, the data being used for each search point is not reused from the immediately prior calculation. In fact, each time, the data is completely new.

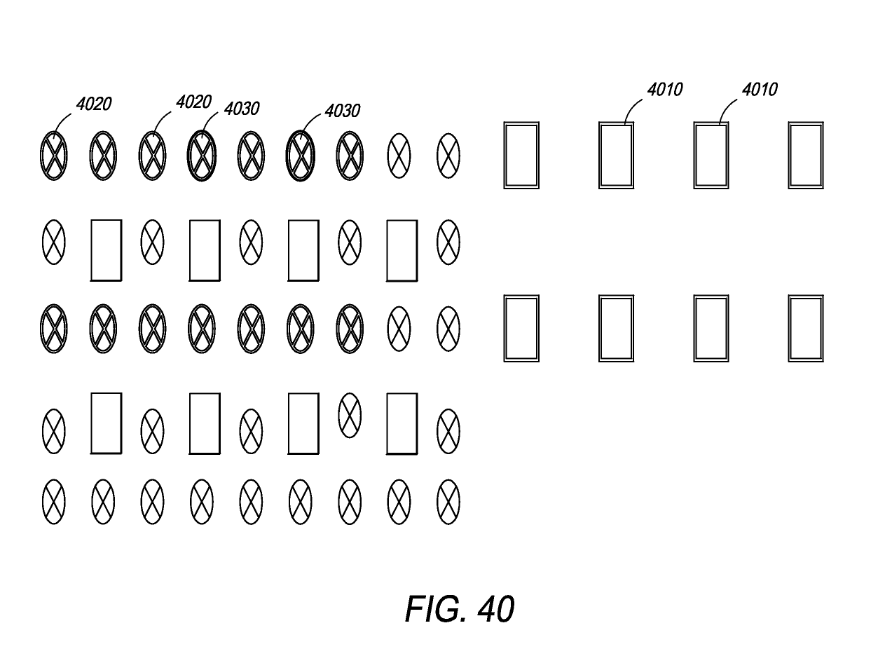

This fact is illustrated by means of FIG. 40, which helps to explain why the data is not reused in the ½ pixel and ¼ pixel searches. Referring to FIG. 40, the current integer values are represented by squares 4010 on the right side. These current integer values 4010 are compared to the red circles 4020, representing ½ pixel values, in the first step of the search. In the second step, the current values 4010 are compared to the blue circles 4030, which represent a different set of ½ pixel values. One of ordinary skill in the art will thus be able to appreciate that data is not the same in each search step. The same holds true for ¼ pel calculation as well.

This implies that the entire data needs to be reloaded for each search point. If each column or row were to be loaded in the conventional manner, it would require 16 clock cycles for a 16×16 window, which is very inefficient.

In order to address this problem of inefficient data loading, the system of present invention employs a novel design for the ME Array comprising horizontal banking The concept of horizontal banking has been mentioned previously. Specifically, horizontal banking in the ME Array of the present invention involves having four separate memory banks, which are responsible for loading a portion of the window data. They can be used either to load data horizontally or vertically. By using four separate memory banks to load data for each search point, a search point can be processed in just 4 clock cycles, instead of 16. One of ordinary skill in the art will appreciate that the number of separate, dedicated memory banks in the ME Array is not limited to four, and may be determined on the basis of the window size chosen for motion estimation processing. The registers of the ME Array are able to determine when data is required to be loaded from the memory banks, and are capable of automatically computing the address of the memory bank from where data is to be accessed.

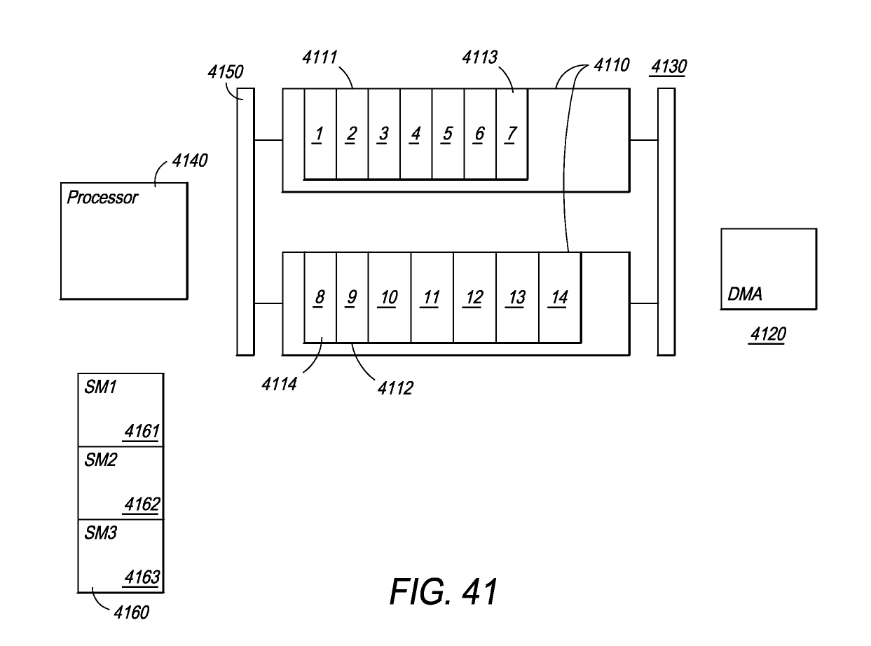

The ME Engine of the present invention employs another novel design feature to further speed up the processing. The novel design feature involves provision of a shadow memory that is used in between the external memory interface (EMIF) and internal memory interface (IMIF). This is illustrated in FIG. 41. Referring to FIG. 41, memory 4110 interfaces with the DMA 4120 at one end via the IMIF 4130, and with the processor 4140 at the other end via the EMIF 4150. Conventionally, data in row one 4111 of the memory is first filled by the DMA 4120, and then used by the processor 4140 while the DMA fills the data in row two 4112. This kind of “Ping-Pong” approach works well when the activities of the processor can be carried out on the data in row 1, with no dependency on the data in row 2 or vice-versa. However, this is not the case with a motion estimation engine. During motion estimation, data in macroblock 8 4113 may be needed to process the data in macroblock 7 4114 and data in macroblock 7 4114 may be required to process the data in macroblock 8 4113. Therefore, using conventional memory organization and access techniques, the entire data loading process would be stalled until the data in both rows are fully processed.

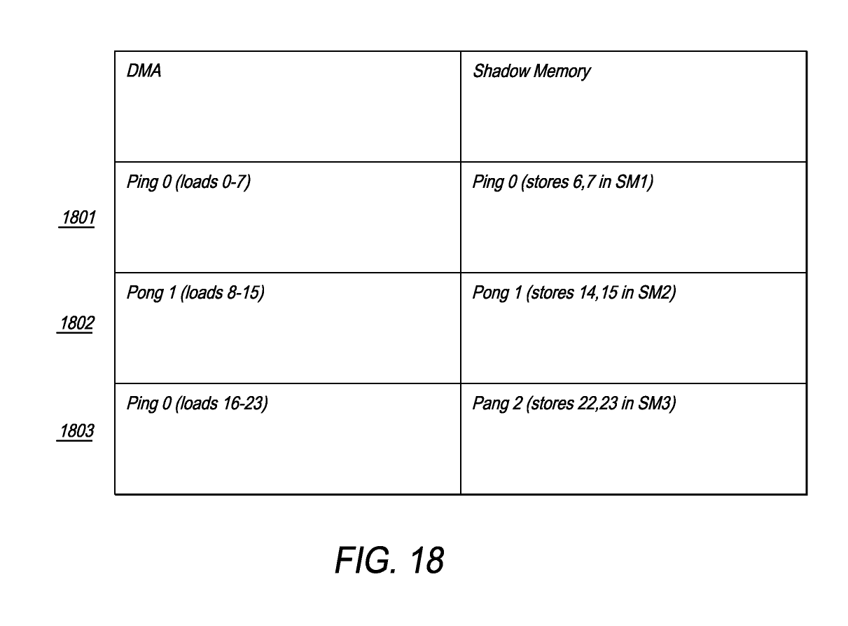

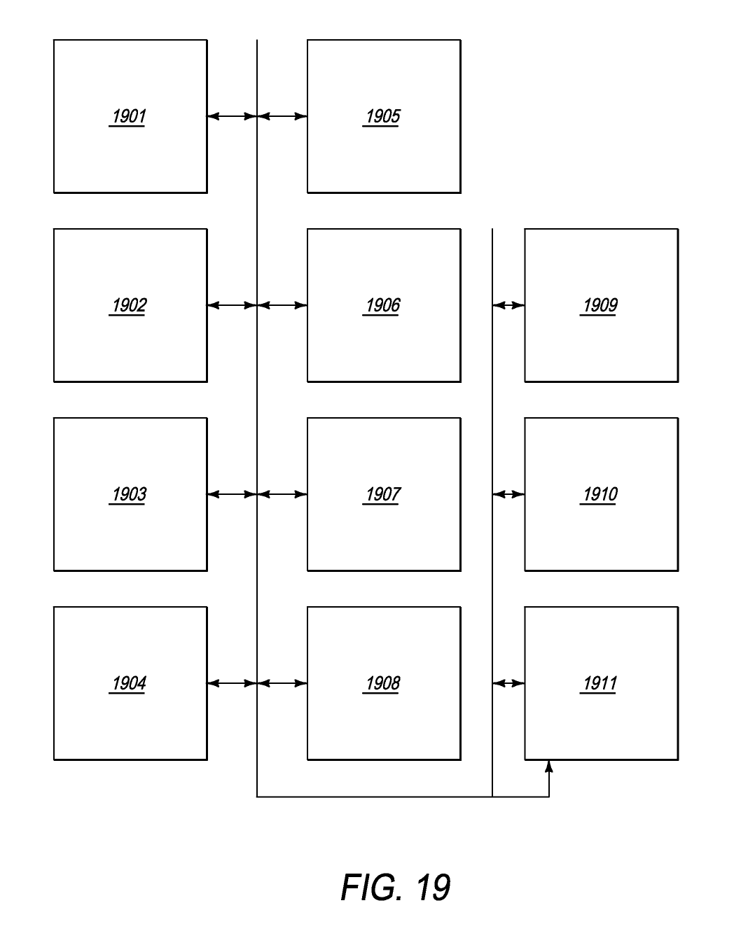

This problem is addressed in the system of present invention by making use of shadow memory 4160. The shadow memory comprises a set of three circular disks of memories—SM1 4161, SM2 4162, and SM3 4163. The shadow memories 4160 are used to load certain data blocks and store them for future use, permitting the DMA 4120 to keep filling the memory 4110. An exemplary operation of shadow memories is illustrated by means of a table in FIG. 18.

Referring to FIG. 18, in the first step Ping 0 1801, the DMA loads data into macroblocks 0-7 of the memory. In the same step, shadow memory SM1 loads and stores the data from macroblocks 6 and 7. In the next step Pong 0 1802, the DMA loads data into macroblocks 8-15 of the memory. At the same time, data from macroblocks 14 and 15 is loaded and stored in the shadow memory SM2. In the subsequent step Ping 0 1803, the DMA loads data into macroblocks 16-23 of the memory. In the same step, shadow memory SM3 loads and stores the data from macroblocks 22 and 23. The shadow memories, being circular disks of memories, then recirculate. The shadow memory disc rotation enables correct ping/pong/ping accesses from both IMIF and EMIF during each cycle. The system of the present invention employs a state machine for indicating to the motion estimation engine which shadow memory to take the data from. For this purpose, the state machine keeps track of the shadow memory cycles. In this manner, continued processing by the DSP without any stalling.

### Exemplary Instruction Sets

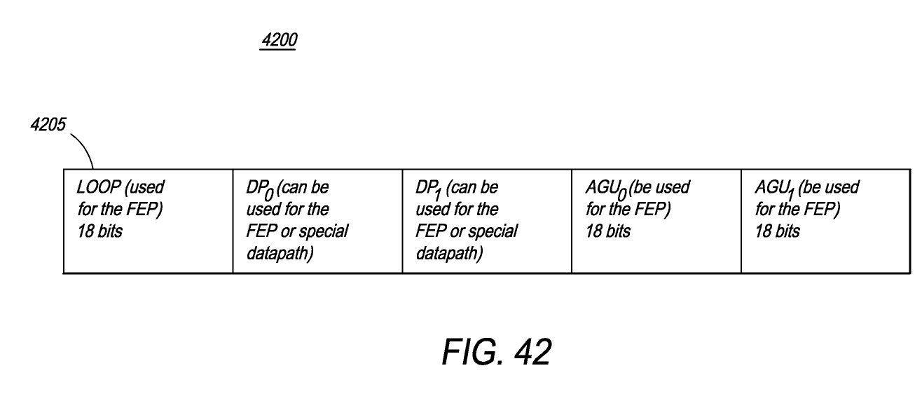

Referring now to the instruction format 4200 of FIG. 42, the Front-end Processor (FEP) fetches and executes an 80-bit instruction packet every cycle. The first 8 bits specify the loop information, whereas the remaining 72 bits of the instruction packet is split into two designated sub-packets, each of which is 36 bit wide. Each sub-packet can have either two 18 bit instructions or one 36 bit instruction, resulting in five distinct instruction slots.

The Loop slot 4205 provides a way to specify zero-overhead hardware loops of a single packet or multiple packets. DP₀ and DP₁ slots are used for engine-specific instructions and ALU instructions (Bit 17 differentiates the two). This is illustrated in the following table:

| Bit[71] | Bit[53] | Defintion |
|---|---|---|
| 0 | 0 | Loop\|\|Engine\|\|Engine\|\|AGU0\|\|AGU1 |
| 0 | 1 | Loop\|\|Engine\|\|ALU\|\|AGU0\|\|AGU1 |
| 1 | — | 36-bit ALU\|\|AGU0\|\|AGU1 |

The engine instruction set is not explicitly defined here as it is different for every media processing function engine. For example, Motion Estimation engine provides an instruction set, and the DCT engine provides its own instruction set. These engine instructions are not executed in the FEP. The FEP issues the instruction to the media processing function engines and the engines execute them.

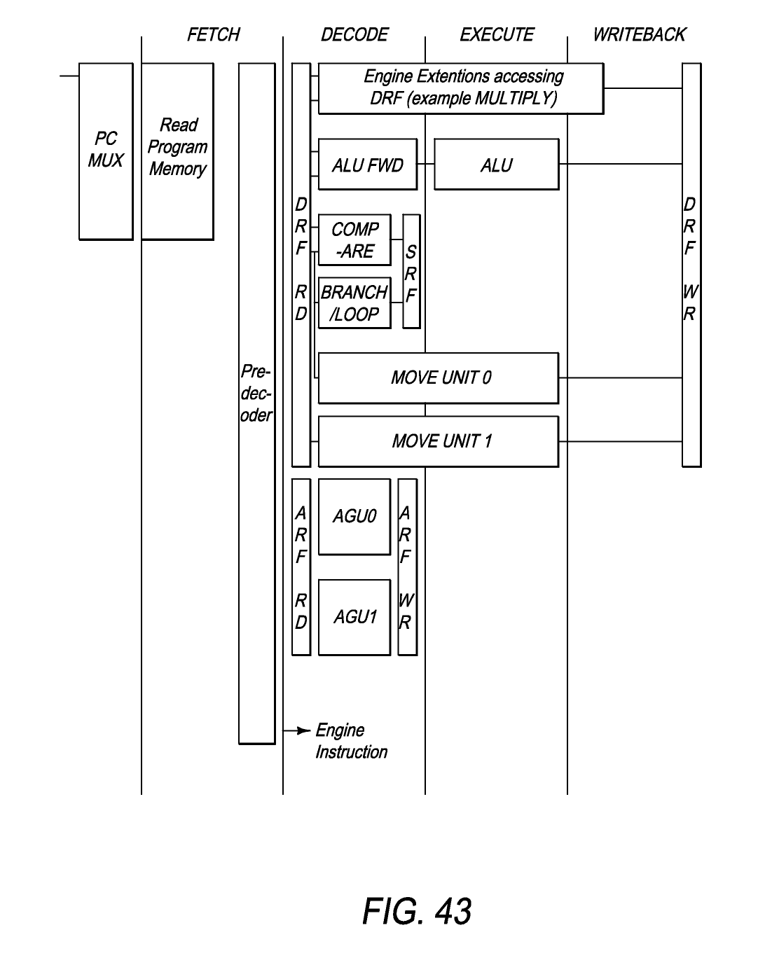

ALU instructions can be 18-bit or 36-bit. If the DP₀ slot has a 36-bit ALU instruction, then the DP₁ slot cannot have an instruction. AGU₀ and AGU₁ slots are used for AGU (Address Generation Units) instructions. If the AGU₀ slot has an instruction with an immediate operand, then the least significant 16-bits of the AGU₁ slot contains the 16-bit immediate operand and therefore the AGU₁ slot cannot have an instruction. Referring now to the pipeline diagram of the FEP of FIG. 43, in one embodiment, the FEP has 16 16-bit Data Registers (DR), 8 Address Registers (AR), and 4 Increment/Decrement Registers (IR). There are 8 Address Prefix Registers (AP) and they hold the memory ID portion of the corresponding AR. There are certain Special Registers (SR) defined like the FLAG register (which holds the results of the compare instruction), saved PC register, and loop count register. The media processing function engines can define their own registers (ER) and these can be accessed through the AGU instructions. The set containing DR, SR, and ER is referred to as composite data register set (CDR). The set containing AR, AP, and IR is referred to as composite address register set (CAR).

The FEP supports zero-overhead hardware loops. If the loop count (LC) is specified using the immediate value in the instruction, the maximum value allowed is 32. If the loop count is specified using the LC register, the maximum value allowed is 2048. An 8 entry loop counter stack is provided in the hardware to support up to 8 nested loops. The loop counter stack is pushed (popped) when the LC register is written (read). This allows the software to extend the stack by moving it to memory.

The DP₀ and DP₁ slots support ALU instructions and engine-specific instructions. The ALU instructions are executed in the FEP. The ALU instructions provide simple operations on the data registers (DR). The general format is DRₖ=DRᵢ op DRⱼ. The DP₀ slot and DP₁ slot instruction table has a list of instructions supported by the FEP ALU. The AGU instructions include load from memory, store to memory, and data movement between all kinds of registers (address registers, data registers, special registers, and engine-specific registers), compare data registers, branch instruction, and return instruction.

As mentioned earlier, the FEP has 8 address registers and 4 increment registers (also known as offset registers). The different processing units use a 24 bit address bus to address the different memories. Of these 24 bits, the top 8 bits coming from the bottom 8 bits of the Address Prefix register identify the memory that is to be addressed and the remaining 16-bits coming from the Address Register address the specific memory. Even though the data word size is 16-bits inside the FEP, the addresses it generates are byte-addresses. This may be useful for some media processing function engines that need to know where the data is coming from at a pixel (byte) level. The FEP also supports an indexed addressing mode. In this mode, the top 8 bits of the address come from the top 8 bits of the Address Prefix register. The next 10 bits come from the top 10 bits of the Array Pointer register. The next 5 bits come from the instructions. The last bit is always 0. In this mode, the data type is 16-bits or more. Load Byte, and Store Byte instructions are not supported. The FEP also supports another address increment scheme specially suited for the scaling function in the video post-processor. In this scheme, the address update is done according to the following equation: {Aₙ, AS_{n[7:0]}}={Aₙ, AS_{n[7:0]}}+Iₙ, where { } is the concatenation operation, Aₙ refers to the address register, ASₙ refers to the address suffix register, and Iₙ refers to the increment register.

Two data registers (DRᵢ, DRⱼ) can be compared using the Compare instructions. Thus, CMP_S assumes that the two data registers are signed numbers and CMP_U assumes that the two data registers are unsigned numbers. FLAG register contains the output of a comparison operation. For example, if DRᵢ was less than DRⱼ, LT bit will be set. For further information on the FLAG register please refer to the Register Definition section.

Conditional branch instructions allow two types of conditions. The conditional branch can check any bit in the FLAG register for a ‘1’ or a ‘0’. The second type of condition allows the programmer to check any bit in any Data Register for a ‘1’ or a ‘0’. Bit 7 and bit 6 of the FLAG register are read only and are set to 0 and 1 respectively. This can be used to implement unconditional branches.

The Branch instruction also has an option (‘U’ bit is set to ‘1’) to save the PC of the instruction following the delay slot (PC+2) into the SPC (saved PC) stack. This helps support subroutines along with a return instruction which uses SPC as the target address. The SPC stack is 16-deep and it is also used to implement DSL-DEL loops. The SPC stack is pushed (popped) whenever the SPC register is written (read) either implicit or explicit. This allows software to extend the stack by moving it to memory.

The Branch instruction has an always executed delay slot. There are “kill” options which may help the programmer to fill the delay slot flexibly. There is an option to kill the delay slot when the branch is taken (KT bit) and another option to kill when the branch is not taken (KF bit). The following table illustrates how these two bits can be used:

| KT | KF | Function | Notes |
|---|---|---|---|
| 0 | 0 | Delay Slot is executed | Fill the delay slot with some |
| | | | operation before the if ( ) |
| 0 | 1 | Delay Slot is executed if the | Fill the delay slot with some |
| | | branch is taken | operation from the “then” path |
| 1 | 0 | Delay Slot is executed if the | Fill the delay slot with some |
| | | branch is not taken | operation from the “else” path |
| 1 | 1 | Delay Slot is not executed | Do not use this combination |

### Register Definitions

### FLAG Register

| 15 | 14 | 13 | 12 | 11 | 10 | 9 | 8 | 7 | 6 | 5 | 4 | 3 | 2 | 1 | 0 |
|---|---|---|---|---|---|---|---|---|---|---|---|---|---|---|---|
| 0 | 1 | OVF | UNF | C | GZ | N | Z | 0 | 1 | LT | GT | EQ | LE | GE | NE |

The flag register is updated whenever the FEP executes either an ALU or a compare instruction. Bits [13:8] are updated by ALU instructions and bits [5:0] are updated by compare instructions. Bits 15 and 7 have a fixed value of 0 and bits 14 and 6 are fixed to a value of 1. Those fixed bits can be used to simulate unconditional branches.

### FEP Control Register

| 6 | 5 | 4 | 3 | 2 | 1 | 0 |
|---|---|---|---|---|---|---|
| 0 | 0 | 0 | SWI_EN | CCE | MDE | MIE |

Bit 0 is the master interrupt enable. At reset, it is set to ‘1’ which is enabled. When the FEP takes an interrupt it clears this bit and then goes into the Interrupt Service Routine. In the ISR, the programmer can decide whether the code can take further interrupts and set this bit again. The RTI instruction (return from ISR) will also set this bit.

Bit 1 is the master debug enable. At reset, it will be set to ‘1’ which is enabled. The programmer can shield some portion of the firmware from debug mode. In some media processing function engines, some of the optimized sections of code may not be stalled and debug mode is implemented using stalls.

Bit 2 is the cycle count enable. At reset, it will be cleared to ‘0’ which disables the cycle counters. The programmer can write “0” to CCL and CCH and then set this bit to ‘1 ’. This will enable the cycle counter. CCL is the least significant 16-bits of the counter and CCH is the most significant 16-bits of the counter.

Bit 3 is the software interrupt enable. At reset, it will be set to ‘0’ which means disabled, ‘1’ means enabled. If this bit is ‘0’, SWI instruction will be ignored and if this bit is ‘1’, SWI instruction will make the FEP take an interrupt and go to the vector address 0x2.

The deblocking filter utilizes the Front-End Processor (FEP), which is a 5-slot VLIW controller. The format of the FEP instructions is as follows:

| Loop Slot | DP Slot 0 | DP Slot 1 | AGU Slot 0 | AGU Slot 1 |
|---|---|---|---|---|
| 8 bits | 18 bits | 18 bits | 18 bits | 18 bits |

The Loop Slot is used to specify LOOP, DLOOP (Delayed LOOP) and NOOP instructions. Any instruction in the DP slots is passed onto the DBF data path for execution. These slots could be used to specify two 18-bit data path instructions, or a single 36-bit instruction. AGU slots are used to load data from internal memories to the DBF using the two Internal Memory Interfaces (IMIF0, IMIF1). To load the AGU Slot 0/1 LOAD instruction can be used. Essentially there are 89 DBF internal registers D32:D120.

Static hazards are hazards that occur between instructions in different execution slots but within the same instruction packet. The rules below are designed to minimize such hazards from occurring.
DST_collision_hazard: Multiple instructions with the same destination register are not allowed in the same packet.
CMP_hazard: Only one compare instructions (CMP_U, CMP_S) is allowed in the AGU slots of an instruction packet.
COF_hazard: A change of flow instruction (DEL, REPR, REPI, BRF, BRR, BRFI, BRRI, RTS, RTI) is not allowed with another change of flow instruction in the same packet.
DP₀_{_{—}}hazard: No 18 bit FEP ALU instruction is allowed in dp0 slot.
PCS_rr_hazard: Two instructions which read the PC stack are not allowed. DEL, RTS, RTI is not allowed with any instruction that reads (pops) the PC stack. (for example: NOP_LP # NOP_DP # NOP_DP # MVD2D_R0 R17 # RTS is not allowed)
PCS_rw_hazard: DSLI, DSLR and BRR, BRF, BRRI, BRFI with the U bit set is not allowed with any instruction that reads (pops) the PC stack (including DEL, RTS, RTI).
LCS_rr_hazard: Two instructions that read the LC stack are not allowed. DEL, REPR, DSLR is not allowed with any instruction that reads the LC stack. (for example: DEL # NOP_DP # NOP_DP # MVD2D_R0 R18 # NOP_AG is not allowed)
LCS_rw_hazard: MVD2LC, MVI2LC, DSLI, REPI is not allowed with any instruction that reads the LC stack.
LCS_ww_hazard: REPI, REPR, DSLI, DEL, MVI2LC, MVD2LC is not allowed with any instruction that writes to the LC stack.
FLAG_hazard: An explicit write to the FLAG register is not allowed in the same packet with any ALU instruction
AR_update_hazard: Two parallel agu instructions of the set [LD, LDB_U, LDB_S, LDI, LDBI_U, LDBI_S, ST, STB, STI, STBI] are only allowed if the ARi register is different, or the offset of LDI, LDBI_U, LDBI_S, STI, STBI is 0;
An instruction packet with an explicit and implicit write to the pc stack is allowed. However, it will cause the PCS to push twice with the top of stack (TOS) being the value of the explicit write. (for example: NOP_LP # NOP_DP # NOP_DP # MVD2D R17 R2 # BRF 6 1 R0 0 0 1. The value of the TOS will be the value of R2)
128-bit_register_hazard: 128-bit wide registers (TEMPO, TEMPI, R0_R7, R8_R15, A0_A6, {RP0_RP3, I0_I3}) are allowed ONLY in Load instructions and Store instructions.
SWB_hazard: An instruction packet with SWB instruction should not contain any other instruction.

The FEP handles all the pipeline hazards that are due to data dependencies. All the explicit dependencies are handled automatically by the FEP. In most cases, the data is forwarded (bypassed) to the execution unit that needs the data to increase performance. In some cases this forwarding is not possible and the FEP stalls the pipeline. A good understanding of these cases could help the programmer to minimize stall cycles. The following are the cases for which the FEP stalls automatically:
A register read from an AGU instruction following a write from an ALU instruction stalls for 1 cycle.
A register read from any instruction following a write from a load from memory instruction stalls for 1 cycle.

The FEP does not handle the implicit dependencies. Implicit dependencies are the cases in which the dependency is due to an implicit operand in the instruction (that is, the operand is not explicitly spelled out in the instruction). The following are the cases for which the FEP does not stall and so these implicit dependencies have to be handled in firmware:
LC_stack_hazard: REPR, REPI, DEL, DSLRI, MVI2LC, MVD2LC instruction following a write to LC from any AGU instruction except {MVI2LC, MVD2LC} needs 2 stall cycles.
PC_stack_push_push_hazard: A BRR, BRF, BRFI, BRFI with U field set or a DSLI, DSLR instruction (pc stack push) following a write to SPC from any AGU instruction needs 2 stall cycles.
PC_stack_push_pop_hazard: A RTS, RTI, DEL instruction (pc stack pop) following a write to SPC from any AGU instruction needs 2 stall cycles.
FLAG_read_hazard: An explicit FLAG register read following any ALU instruction except NOP_DP needs 2 stall cycles.
FLAG_BRANCH_hazard: A BRF, BRFI instruction that reads a bit in the set FLAG[13:8] following any ALU instructions needs 2 stall cycles.
FLAG_write_hazard: A BRF, BRFI instruction following an explicit write to FLAG register needs 2 stall cycles.
Combo_register_write_hazard: A register read following an AGU instruction that writes the corresponding combo register set needs 2 stall cycles. (For example, a read of R4 following a write to R0_R7 register.)
Combo_register_read_hazard: A register read of a combo register (for example, R0_R7) following any instruction that writes one of the corresponding registers in the set needs 2 stall cycles. (For example, a read of R0_R7 following a write to R4 register.)
Compare_flag_hazard: Any compare instruction following a write to FLAG from an AGU instruction needs 2 stall cycles. (Note: This is a Write-After-Write hazard.)
Delay_slot_hazard: A change of flow instruction with a delay slot (DEL/RTS/RTI/BRR/BRF/BRRI/BRFI) is not allowed in a delay slot of BRR/BRF/BRRI/BRFI when the KT bit is not set.

In addition to the above cases, there could be some stall cycles introduced when memory is accessed and depend on the external implementation.

### Interrupt Support

The FEP supports one interrupt input, INT_REQ. There is an interrupt controller outside the FEP which supports 16 different interrupts. A single-packet repeat instruction that uses the immediate value as the Loop Count is not interrupted. Similarly a branch delay slot is not interrupted. The FEP checks for these two conditions and if these are not present, it takes the interrupt and branch to the interrupt vector (INT_VECTOR). The return address is saved in the SPC stack. This is the only state information that is saved by hardware. The software is responsible for saving anything that is modified by the Interrupt Service Routine (ISR). The RTI instruction (Return from ISR) returns the code to the interrupted program address.

Bit 0 of the FEP control register (part of the special register set) is a master interrupt enable bit. At reset, this bit is set to ‘1’ which means interrupts are enabled. When an interrupt is taken, the FEP clears the interrupt enable bit. The RTI instruction sets the master interrupt enable bit. In the Interrupt Service Routine, the programmer can decide whether the code can take further interrupts and set this bit again if necessary. Before setting this bit, the programmer must clear the interrupt using the Interrupt Clear register inside the interrupt controller.

The interrupt controller has the following registers that are accessible to the FEP through special registers. The special register ICS corresponds to interrupt control register when writing and interrupt status register when reading. The special register IMR corresponds to the interrupt mask register.

| Register | | | |
|---|---|---|---|
| Name | Width | R/W | Function |
| Interrupt | 16 bits | Write | If a value of ‘1’ is written to a bit, the |
| Control | | Only | corresponding interrupt will be cleared |
| | | | in the interrupt status register. The |
| | | | programmer is expected to do this |
| | | | only after servicing the interrupting |
| | | | engine. |
| Interrupt | 16 bits | Read Only | If a bit is set to ‘1’, the corresponding |
| Status | | | interrupt has occurred. |
| Interrupt | 16 bits | Read/ | If a bit is set to ‘1’, the corresponding |
| Mask | | Write | interrupt will be masked and the FEP |
| | | | will not know about that interrupt. |

These 16 interrupts have interrupt vector address 0x4. The interrupt service routine can read the Interrupt Status Register to identify the specific interrupt source. In addition to these hardware interrupt bits, the SWI instruction can be used to interrupt the FEP. If SWI_EN bit in the FEP Control register is ‘1’, this instruction makes the FEP take an interrupt and branch to the interrupt vector address which is fixed at 0x2. This also clears the master interrupt enable bit in the FEP Control register. The RTI instruction can be used to return from the ISR. A 4-cycle gap is needed between the instruction clearing the interrupt (the write to ICS register) and the RTI instruction.

### Debug Support

The debug interface is designed to provide the following features:

1. Read and write the program memory
2. Stop the program based on the program address that FEP is executing
3. Stop the program based on any other event
4. Step through the program one instruction packet at a time
5. Read and write the FEP registers.
6. Read and write the memories that are accessible to the FEP.

The FEP supports these features with the help of a debug controller.

### FEP Ports

The FEP has the following ports:

| Port Name | Input/Output | Function |
|---|---|---|
| Dbg_bkpt | Input | The FEP tags the instruction packet coming from |
| | | the program memory with a breakpoint. Before this |
| | | packet is executed the FEP stalls and enters |
| | | break_mode. |
| Dbg_break | Input | This input is similar to dbg_bkpt but it is not |
| | | associated with any packet. The FEP stalls as soon |
| | | as possible and enters break_mode. If this input is |
| | | asserted during reset, the FEP enters break_mode |
| | | when reset is released. |
| Dbg_mode | Output | When FEP enters break_mode, it asserts this output signal. |
| Dbg_step | Input | In normal mode, this input is ignored. In |
| | | debug_mode, the FEP releases the stall for 1 cycle |
| | | and lets one instruction to execute. |
| Dbg_pkt[79:0] | Input | In normal mode, this input is ignored. In |
| | | debug_mode, if the dbg_inject signal is asserted, |
| | | the FEP takes this packet and inserts it into its |
| | | pipeline instead of the instruction packet from the |
| | | program memory. |
| Dbg_inject | Input | In normal mode, this input is ignored. In |
| | | debug_mode, the FEP takes the dgb_pkt and inserts |
| | | it into its pipeline. The FEP also releases the stall |
| | | for 1 cycle and lets one instruction to execute. |
| Dbg_cont | Input | In normal mode, this input is ignored. In |
| | | debug_mode, the FEP comes out of debug_mode |
| | | and enters normal run mode. |
| DBGO[15:0] | Output | The value of the DBGO register in the FEP. |
| DBGO_EN | Output | When a write happens to DBGO register in the |
| | | FEP, this signal is asserted. |

It should be appreciated that the present invention has been described with respect to specific embodiments, but is not limited thereto. In particular, the present invention is directed toward integrated chip architecture for a motion estimation engine, capable of processing multiple standard coded video, audio, and graphics data, and devices that use such architectures.

Although described above in connection with particular embodiments of the present invention, it should be understood the descriptions of the embodiments are illustrative of the invention and are not intended to be limiting. Various modifications and applications may occur to those skilled in the art without departing from the true spirit and scope of the invention as defined in the appended claims.

We claim:

1. A processor with a configurable functional data path, comprising:
a. A plurality of address generator units;
b. A program flow control unit;
c. A plurality of data and address registers;
d. An instruction controller;
e. A programmable functional data path; and
f. At least two memory data buses, wherein each of said two memory data buses are in data communication with said plurality of address generator units, program flow control unit; plurality of data and address registers; instruction controller; and programmable functional data path.

2. The processor of claim 1 wherein said programmable function data path comprises circuitry configured to perform DCT and IDCT processing on data input into said programmable function data path.

3. The processor of claim 2 wherein said circuitry configured to perform DCT and IDCT processing on data input into said programmable function data path can be logically programmed to perform DCT and IDCT processing in accordance with any of the H.264, MPEG-2, MPEG-4, VC-1, or AVS protocols without modifying the physical circuitry.

4. The processor of claim 3 wherein said DCT and IDCT processing on data input into said programmable function data path can be performed to enable a display of video at least 30 frames per second at a processor frequency of 500 MHz or below.

5. The processor of claim 1 wherein said programmable function data path comprises circuitry configured to perform motion estimation processing on data input into said programmable function data path.

6. The processor of claim 5 wherein said circuitry configured to perform motion estimation processing on data input into said programmable function data path can be logically programmed to perform motion estimation processing in accordance with any of the H.264, MPEG-2, MPEG-4, VC-1, or AVS protocols without modifying the physical circuitry.

7. The processor of claim 6 wherein said motion estimation processing on data input into said programmable function data path can be performed to enable a display of video at least 30 frames per second at a processor frequency of 500 MHz or below.

8. The processor of claim 1 wherein said programmable function data path comprises circuitry configured to perform deblocking filtration processing on data input into said programmable function data path.

9. The processor of claim 8 wherein said circuitry configured to perform deblocking filtration processing on data input into said programmable function data path can be logically programmed to perform deblocking filtration processing in accordance with any of the H.264, MPEG-2, MPEG-4, VC-1, or AVS protocols without modifying the physical circuitry.

10. The processor of claim 9 wherein said deblocking filtration processing on data input into said programmable function data path can be performed to enable a display of video at least 30 frames per second at a processor frequency of 500 MHz or below.

11. The processor of claim 1 wherein said programmable function data path comprises circuitry configured to perform motion compensation processing on data input into said programmable function data path.

12. The processor of claim 11 wherein said circuitry configured to perform motion compensation processing on data input into said programmable function data path can be logically programmed to perform motion compensation processing in accordance with any of the H.264, MPEG-2, MPEG-4, VC-1, or AVS protocols without modifying the physical circuitry.

13. The processor of claim 12 wherein said motion compensation processing on data input into said programmable function data path can be performed to enable a display of video at least 30 frames per second at a processor frequency of 500 MHz or below.

14. The processor of claim 1 wherein said programmable function data path comprises circuitry configured to perform scalar processing on data input into said programmable function data path.

15. The processor of claim 14 wherein said circuitry configured to perform scalar processing on data input into said programmable function data path can be logically programmed to perform scalar processing in accordance with any of the H.264, MPEG-2, MPEG-4, VC-1, or AVS protocols without modifying the physical circuitry.

16. The processor of claim 15 wherein said scalar processing on data input into said programmable function data path can be performed to enable a display of video at least 30 frames per second at a processor frequency of 500 MHz or below.

17. A processor, comprising:
a. A plurality of address generator units;
b. A program flow control unit;
c. A plurality of data and address registers;
d. An instruction controller; and
e. A programmable functional data path, wherein said programmable function data path comprises circuitry configured to perform any one of the following processing functions on data input into said programmable function data path: DCT processing, IDCT processing. Motion estimation, motion compensation, entropy encoding, de-interlacing, de-noising, quantization, or dequantization.

18. The processor of claim 17 wherein said circuitry can be logically programmed to perform said processing functions in accordance with any of the H.264, MPEG-2, MPEG-4, VC-1, or AVS protocols without modifying the physical circuitry.

19. The processor of claim 18 wherein said processing functions can be performed to enable a display of video at least 30 frames per second at a processor frequency of 500 MHz or below.

20. A system on chip comprising at least five processors of claim 1 and a task scheduler wherein a first processor comprises a programmable function data path configured to perform entropy encoding on data input into said programmable function data path; a second processor comprises a programmable function data path configured to perform discrete cosine transform processing on data input into said programmable function data path; a third processor comprises a programmable function data path configured to perform motion compensation on data input into said programmable function data path; a fourth processor comprises a programmable function data path configured to perform deblocking filtration on data input into said programmable function data path; and fifth processor comprises a programmable function data path configured to perform de-interlacing on data input into said programmable function data path.
